(19) United States
(12) Patent Application Publication
(10) Pub. No.: US 2014/0141127 A1
(43) Pub. Date: May 22, 2014

(54) BEVERAGE COMPOSITIONS COMPRISING SOY WHEY PROTEINS THAT HAVE BEEN ISOLATED FROM PROCESSING STREAMS

(71) Applicants: Michael A. Jincks, Pevely, MO (US); William C. Smith, Cahokia, IL (US); John A. Brown, Festus, MO (US)

(72) Inventors: Michael A. Jincks, Pevely, MO (US); William C. Smith, Cahokia, IL (US); John A. Brown, Festus, MO (US)

(73) Assignee: SOLAE LLC, St. Louis, MO (US)

(21) Appl. No.: 14/127,987

(22) PCT Filed: Jun. 29, 2011
(86) PCT No.: PCT/US11/42435

§ 371 Date: Dec. 20, 2013

(51) Int. Cl. A23L 2/66; A23L 2/52; A23C 9/123; A23L 2/80; A23C 13/12; A23L 2/56; A23L 2/70; A23L 2/74; A23L 2/44; A23L 1/29

(52) U.S. Cl. CPC A23L 2/66; A23L 2/44; A23L 2/52; A23C 9/123; A23L 1/296; A23C 13/12; A23C 13/125; A23L 2/56; A23L 2/70; A23L 2/74; A23L 2/80
USPC 426/72; 426/598; 426/532; 426/583; 426/490

(57) ABSTRACT

A beverage composition comprising soy whey proteins that have been isolated from processing streams, wherein the beverage composition is used to form a beverage product. A process for recovering and isolating soy whey proteins and other components from soy processing streams is also disclosed.

### FIELD OF THE INVENTION

The present disclosure provides compositions which comprise soy whey proteins recovered or isolated in accordance with the processes disclosed herein to form a beverage product. Specifically, the present disclosure provides a composition comprising soy whey proteins that have been recovered from soy processing streams, along with other ingredients to form a beverage food product. Specifically, the present soy recovery process utilizes one or more membrane or chromatographic separation operations for isolating and removing soy proteins, including novel soy whey proteins and purified target proteins, as well as sugars, minerals, and other constituents to form a purified waste water stream. Methods for making the beverage products are also disclosed.

### BACKGROUND OF THE INVENTION

Food scientists in the industry continually work to develop novel processes and the resulting products that deliver improved nutritional characteristics that consumers desire. The inclusion of soy protein is a cost-effective way to reduce fat, increase protein content and improve overall sensory characteristics of liquid nutritional supplements such as ready to drink (RTD) beverages, infant formula, sports drinks, and clinical nutrition drinks and the like. Soy protein is also a cost-effective way to enhance the nutritional profile of other liquid-based products such as, for example, yogurt smoothies, juice smoothies, and coffee creamers.

Soy proteins are typically in one of three forms when consumed by humans. These include soy protein flour (grits), soy protein concentrates, and soy protein isolates. All three types are made from defatted soybean flakes. Flours and grits contain at least 50% protein and are prepared by milling the flakes.

Soy protein concentrates contain 65 wt. % to 90 wt. % protein on a dry weight basis, with the major non-protein component being fiber. Soy protein concentrates are made by repeatedly washing the soy flakes with water, which may optionally contain low levels of food grade alcohols or buffers. The effluent from the repeated washings is discarded and the solid residue is dried, thereby producing the desired concentrate. The yield of concentrates from the starting material is approximately 60-70%.

The preparation of soy protein concentrate generally results in two streams: soy isolate and a soy molasses stream, which may contain up to 55 wt. % soy protein. On a commercial scale, significant volumes of this molasses are generated that must be discarded. The total protein content may contain up to 15 wt. % of the total protein content of the soybeans from which they are derived. Thus, a significant fraction of soy protein is discarded during processes typically used for soy protein concentrate preparation.

Soy protein isolates are the most highly refined soy protein products commercially available, as well as the most expensive to obtain. However, as with soy protein concentrates, current processing known in the industry results in many of the valuable minerals, vitamins, isoflavones, and phytoestrogens being drawn off to form a waste stream along with the low-molecular weight sugars in making the isolates.

Soy protein isolates contain a minimum of 90 wt. % protein on a dry weight basis and little or no soluble carbohydrates or fiber. Isolates are typically made by extracting defatted soy flakes or soy flour with a dilute alkali (pH<9) and centrifuging. The extract is adjusted to pH 4.5 with a food grade acid such as sulfuric, hydrochloric, phosphoric or acetic acid. At a pH of 4.5, the solubility of the proteins is at a minimum so they will precipitate out. The protein precipitate is then dried after being adjusted to a neutral pH or is dried without any pH adjustment to produce the soy protein isolate. The yield of the isolate is 30% to 50% of the original soy flour and 60% of the protein in the flour. This extremely low yield along with the many required processing steps contributes to the high costs involved in producing soy protein isolates.

Due at least in part to their relatively high protein content, soy protein isolates are desired for a variety of applications. In conventional soy protein isolate manufacture, the aqueous stream (i.e., soy whey stream) remaining after precipitation of the soy protein isolate fraction is typically discarded. On a commercial scale, considerable costs are incurred with the handling and disposing of this aqueous waste stream. For example, the soy whey stream is relatively dilute (e.g., less than about 5 wt. % solids, typically about 2 wt. % solids). Thus, on a commercial scale, significant volumes of the soy whey stream are generated that must be treated and/or discarded. In addition, it has been observed that the soy whey stream may contain a substantial proportion of the total protein content of the soybeans used in preparation of soy protein isolates. In fact, the soy whey stream may contain up to 45 wt. % of the total protein content of the soybeans from which soy protein isolates are derived. Thus, a significant fraction of soy protein is typically discarded during conventional soy protein isolate production.

Despite the high proportion of the soy whey protein that is typically lost in the processing stream, recovery of the proteins has not generally been considered to be economically feasible. At least in part, the loss of these potentially valuable proteins has been heretofore deemed acceptable because of the relatively low concentrations of total protein in the whey, and the consequently large volumes of aqueous waste that must be processed for each unit of mass of protein recovered, which generates a large amount of pollution. Recovery attempts have also been deterred by the complex mixture of proteins and other components present in the soy whey, and the absence of commercial applications for crude mixtures of the protein solids. While soy whey has been known to contain certain bioactive proteins, the commercial value of these has been limited for lack of processes to recover them in high purity form.

Methods for recovering products from soy whey are known in the art. For example, a process for separating specific isoflavone fractions from soy whey and soy molasses feed streams is described in U.S. Pat. Nos. 6,033,714; 5,792,503; and 5,702,752. In another method, soy molasses (also referred to as soy solubles) is obtained when vacuum distillation removes the ethanol from an aqueous ethanol extract of defatted soy meal. The feed stream is heated to a temperature chosen according to the specific solubility of the desired isoflavone fraction. The stream is then passed through an ultrafiltration membrane, which allows isoflavone molecules below a maximum molecular weight to permeate. The permeate may then be concentrated using a reverse osmosis membrane. The concentrated stream is then put through a resin adsorption process using at least one liquid chromatography column to further separate the fractions.

Methods for the removal of oligosaccharides from soybean wastes are also known in the art. For example, Matsubara et al [Biosci. Biotech. Biochem. 60:421 (1996)] describe a method for recovering soybean oligosaccharides from steamed soybean wastewater using reverse osmosis and nanofiltration membranes. JP 07-082,287 teaches the recovery of oligosaccharides from soybean oligosaccharide syrup using solvent extraction. That method comprises adding an organic solvent to the aqueous solution containing the oligosaccharides, heating the mixture to give a homogeneous solution, cooling the solution to form two liquid layers, and separating and recovering the bottom layer.

Canadian Patent Applications 2,006,957 and 2,013,190 describe ion-exchange processes carried out in aqueous ethanol to recover small quantities of high value by-products from cereal grain processing waste. According to CA 2,013,190, an alcoholic extract from a cereal grain is processed through either an anionic and/or cationic ion-exchange column to obtain minor but economically valuable products.

Soy whey and soy molasses also contain a significant amount of protease inhibitors. Protease inhibitors are known to at least inhibit trypsin, chymotrypsin and potentially a variety of other key transmembrane proteases that regulate a range of key metabolic functions. Topical administration of protease inhibitors finds use in such conditions as atopic dermatitis, a common form of inflammation of the skin, which may be localized to a few patches or involve large portions of the body. The depigmenting activity of protease inhibitors and their capability to prevent ultraviolet-induced pigmentation have been demonstrated both in vitro and in vivo (See e.g., Paine et al., J. Invest. Dermatol., 116: 587-595 [2001]). Protease inhibitors have also been reported to facilitate wound healing. For example, secretory leukocyte protease inhibitor was demonstrated to reverse the tissue destruction and speed the wound healing process when topically applied. In addition, serine protease inhibitors can also help to reduce pain in lupus erythematosus patients (See e.g., U.S. Pat. No. 6,537,968). Naturally occurring protease inhibitors can be found in a variety of foods such as cereal grains (oats, barley, and maize), brussels sprouts, onion, beetroot, wheat, finger millet, and peanuts. One source of interest is the soybean.

Two broad classes of protease inhibitor superfamilies have been identified from soybean and other legumes with each class having several isoinhibitors. Kunitz-trypsin inhibitor (KTI) is major member of the first class whose members have approximately 170-200 amino acids, molecular weights between 20-25 kDa, and act principally against trypsin. Kunitz-trypsin proteinase inhibitors are mostly single chain polypeptides with 4 cysteines linked in two disulfide bridges, and with one reactive site located in a loop defined by disulfide bridge. The second class of inhibitors contains 60-85 amino acids, has a range in molecular weight of 6-10 kDa, has a higher number of disulfide bonds, is relatively heat-stable, and inhibits both trypsin and chymotrypsin at independent binding sites. Bowman-Birk inhibitor (BBI) is an example of this class. The average level of protease inhibitors present in soybeans is around 1.4 percent and 0.6 percent for KTI and BBI, respectively. Notably, these low levels make it impractical to isolate the natural protease inhibitor for clinical applications.

Preparing pure BBI, however, involves costly techniques. Moreover, because the average level of BBI present in soybeans is only around 0.6 wt. %, this low level makes it impractical and cost prohibitive to isolate the natural protease inhibitor for clinical applications. Purification methods currently used in the art vary. Some methods use affinity purification with immobilized trypsin or chymotrypsin. Immobilized trypsin will bind both BBI and Kunitz trypsin inhibitor (KTI) so a particularly pure BBI product is not isolated. Alternatively, a process involving use of immobilized chymotrypsin, while it does not bind KTI, has several problems, such as not being cost effective for scale-up and the possibility of chymotrypsin leaching from the resin following numerous uses and cleaning steps. Many older BBI purification methods use anion exchange chromatography, which technique can result in subfractionation of BBI isomers, In addition, it has been difficult with anion exchange chromatography to obtain a KTI-free BBI fraction without significant loss of BBI yield. Accordingly, all of the methods currently known for isolating BBI are problematic due to slow processing, low yield, low purity, and/or the need for a number of different steps which results in an increase of time and cost requirements.

Methods of purification which only utilize filtration are not effective as sole methods due to membrane fouling, incomplete and/or imperfect separation of non-protein components from BBI proteins, and ineffective separation of BBI proteins from other proteins. Methods of purification which only utilize chromatography are also not effective as sole methods due to binding capacity and overloading issues, incomplete and/or imperfect separation issues (e.g. separation of BBI from KTI), irreversible binding of protein to resin issues, resin lifetime issues, and it is relatively expensive compared to other techniques. Methods of purification which involve only ammonium sulfate precipitation are not effective as sole methods due to the possibility of irreversible precipitation of BBI proteins, potential loss of activity of BBI proteins, incomplete precipitation of BBI proteins (i.e. loss of yield), and the need to remove the ammonium sulfate from the final product, which adds an additional step and cost.

Current methods known in the art for obtaining purified BBI proteins suffer from lower purity levels due to the contamination of the BBI with Kunitz Trypsin Inhibitor (KTI) proteins. Depending on the isolation method used, endotoxin levels can also be an issue. Current methods use whole soybean as the starting material, which is then defatted by various means. In contrast, the processes of the present invention use defatted soy white flake as the starting material. As a result, the prior art has not described a BBI product having high purity levels that is obtained from a soy protein source, without acid or alcohol extraction, or acetone precipitation. Thus, there is a need for methods and compositions suitable for the production of high purity BBI and variants.

Thus, there is a need in the art for food products which incorporate as an ingredient the soy whey proteins recovered from soy processing streams pursuant to the methods disclosed herein. Accordingly, the present invention describes compositions which comprise soy whey proteins that have been recovered in accordance with the methods described herein. Along with the recovered soy whey proteins, the compositions may additionally comprise at least one other ingredient and are formed into a beverage product. The beverage products that contain recovered soy whey protein as an ingredient have been found to have an increased amount of protein and overall nutritional profile that a consumer desires, while retaining the same taste, structure, aroma and mouthfeel of typical beverage products currently on the market.

### SUMMARY OF THE INVENTION

The present disclosure relates to compositions which comprise soy whey proteins that have been recovered in accordance with the novel methods for purifying soy processing streams disclosed herein. The compositions disclosed herein are then used to form beverage products such as, for example, ready to drink (RTD) beverages, infant formula, sports drinks, clinical nutrition drinks, yogurt smoothies, juice smoothies, coffee creamers, and the like. Specifically, the present disclosure provides beverage products that contain recovered soy whey protein, which products have been found to have an improved nutritional profile including increased amount of protein, while retaining the same taste, structure, aroma and mouthfeel of typical beverage products currently on the market and desired by consumers. The compositions which comprise the soy whey proteins of the present disclosure may be combined with at least one other ingredient to form the beverage product.

The beverage products of the present disclosure incorporate soy whey protein that has been recovered from processing streams in accordance with novel processing methods. To recover the soy whey protein, a sequence of membrane or chromatographic separation operations steps, which are described below in further detail, are combined in varying order to comprise the overall process for recovering soy whey protein and other constituents from a processing stream. The present processing method results in the isolation and removal of one or more soy whey proteins, sugars, and minerals from a soy processing stream, the soy processing stream comprising the soy whey proteins, one or more soy storage proteins, one or more sugars, and one or more minerals. The removal of the soy whey proteins from the processing streams in accordance with the novel processing methods allows the soy whey protein to be used in compositions to produce beverage products.

### BRIEF DESCRIPTION OF THE DRAWINGS

FIG. 1 is a chart setting forth the proteins found in whey streams and their characteristics.

FIG. 2 graphically depicts the solubility of the soy whey proteins over a pH range of 3-7 as compared to that of soy protein isolates.

FIG. 3 graphically depicts the rheological properties of the soy whey proteins compared to soy protein isolate.

FIG. 4A is a schematic flow sheet depicting Steps 0 through 4 in a process for recovery of a purified soy whey protein from processing stream.

FIG. 4B is a schematic flow sheet depicting Steps 5, 6, 14, 15, 16, and 17 in a process for recovery of a purified soy whey protein from processing stream.

FIG. 4C is a schematic flow sheet depicting Steps 7 through 13 in a process for recovery of a purified soy whey protein from processing stream.

FIG. 5 graphically illustrates the breakthrough curve when loading soy whey at 10, 15, 20 and 30 mL/min (5.7, 8.5, 11.3, 17.0 cm/min linear flow rate, respectively) through a SP Gibco cation exchange resin bed plotted against empty column volumes loaded.

FIG. 6 graphically illustrates protein adsorption on SP Gibco cation exchange resin when passing soy whey at 10, 15, 20 and 30 mL/min (5.7, 8.5, 11.3, 17.0 cm/min linear flow rate, respectively) plotted against empty column volumes loaded.

FIG. 7 graphically illustrates the breakthrough curve when loading soy whey at 15 mL/min and soy whey concentrated by a factor of 3 and 5 through SP Gibco cation exchange resin bed plotted against empty column volumes loaded.

FIG. 8 graphically illustrates protein adsorption on SP Gibco cation exchange resin when passing soy whey and soy whey concentrated by a factor of 3 and 5 at 15 mL/min through SP Gibco cation exchange resin bed plotted against empty column volumes loaded.

FIG. 9 graphically depicts equilibrium protein adsorption on SP Gibco cation exchange resin when passing soy whey and soy whey concentrated by a factor of 3 and 5 at 15 mL/min through SP Gibco cation exchange resin bed plotted against equilibrium protein concentration in the flow through.

FIG. 10 graphically illustrates the elution profiles of soy whey proteins desorbed with varying linear velocities over time.

FIG. 11 graphically illustrates the elution profiles of soy whey proteins desorbed with varying linear velocities with column volumes.

FIG. 12 depicts a sodium dodecyl sulfate polyacrylamide gel electrophoresis (SDS-PAGE) analysis of Mimo6ME fractions.

FIG. 13 depicts a SDS-PAGE analysis of Mimo4SE fractions.

FIG. 14 depicts a SDS-PAGE analysis of Mimo6HE fractions.

FIG. 15 depicts a SDS-PAGE analysis of Mimo6ZE fractions.

FIG. 16 graphically illustrates the sensory profiling of liquid coffee creamer in coffee, depicting the flavor differences between the control (Sodium Caseinate) and Soy Whey Protein.

FIG. 17 graphically illustrates the sensory profiling of apple flavored RTD-A beverage at Time 0, flavor, texture, and aftertaste differences between the control (Whey Protein Isolate) and Soy Whey Protein.

FIG. 18 graphically illustrates the sensory profiling of apple flavored RTD-A beverage at 6 Weeks, flavor, texture, and aftertaste differences between the control (Whey Protein Isolate) and Soy Whey Protein.

FIG. 19 graphically illustrates the sensory profiling of Unflavored 50 gram Protein RTD-N Beverage, flavor, texture, and aftertaste differences between the control (Sodium Caseinate) and Soy Whey Protein.

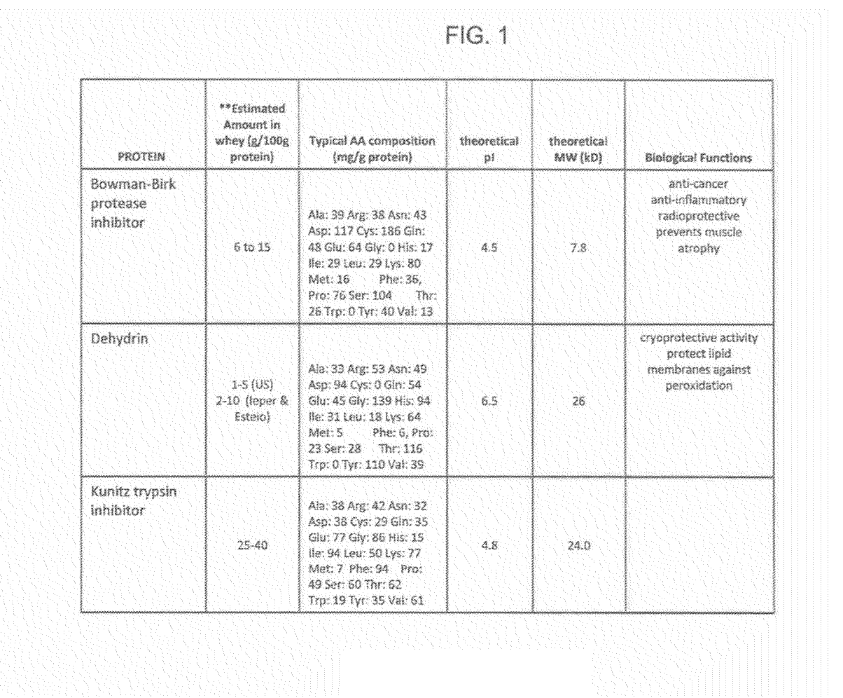

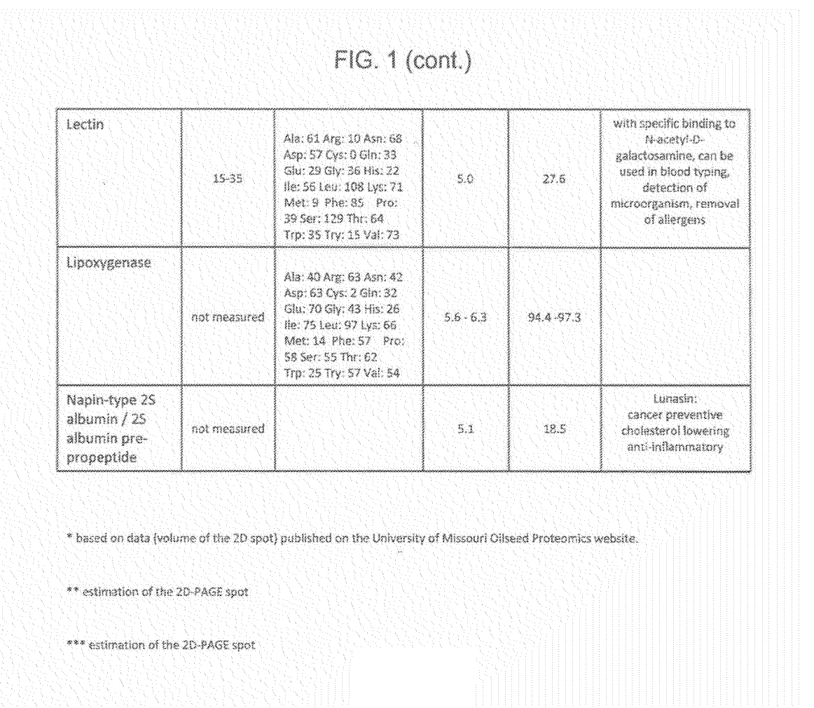

### DETAILED DESCRIPTION OF THE PREFERRED ASPECTS

The present invention provides compositions comprising soy whey proteins recovered from a variety of leguminous plant processing streams (including soy whey streams and soy molasses streams) generated in the manufacture of soy protein isolates. The recovered soy whey proteins are useful as an ingredient in compositions which are may then be used to form beverage products. The resultant beverage products have been shown to exhibit improved nutritional characteristics, including an increased amount of protein, while retaining the same taste, structure, aroma, and mouthfeel of typical beverage products currently on the market.

Generally, the purification of the soy processing stream comprises one or more operations (e.g. membrane separation operations) selected and designed to provide recovery of the desired proteins or other products, or separation of various components of the soy whey stream, or both. Recovery of soy whey proteins (e.g. Bowman-Birk inhibitor (BBI) and Kunitz trypsin inhibitor (KTI) proteins) and one or more other components of the soy whey stream (e.g. various sugars, including oligosaccharides) may utilize a plurality of separation techniques, (e.g. membrane, chromatographic, centrifugation, or filtration). The specific separation technique will depend upon the desired component to be recovered by separating it from other components of the processing stream.

For example, a purified fraction is typically prepared by removal of one or more impurities (e.g. microorganisms or minerals), followed by removal of additional impurities including one or more soy storage proteins (i.e. glycinin and β-conglycinin), followed by removal of one or more soy whey proteins (including, for example, KTI and other non-BBI proteins or peptides), and/or followed by removal of one or more additional impurities including sugars from the soy whey. Recovery of various target components in high purity form is improved by removal of other major components of the whey stream (e.g. storage proteins, minerals, and sugars) that detract from purity by diluents, while likewise improving purity by purifying the protein fraction through removal of components that are antagonists to the proteins and/or have deleterious effects (e.g. endotoxins). Removal of the various components of the soy whey typically comprises concentration of the soy whey prior to and/or during removal of the components of the soy whey. The methods of the present invention also will reduce pollution generated from processing large quantities of aqueous waste.

Removal of storage proteins, sugars, minerals, and impurities yields fractions that are enriched in the individual, targeted proteins and free of impurities that may be antagonists or toxins, or may otherwise have a deleterious effect. For example, typically a soy storage protein-enriched fraction may be recovered, along with a fraction enriched in one or more soy whey proteins. A fraction enriched in one more sugars (e.g. oligosaccharides and/or polysaccharides) is also typically prepared. Thus, the present methods provide a fraction that is suitable as a substrate for recovery of individual, targeted proteins, and also provide other fractions that can be used as substrates for economical recovery of other useful products from aqueous soy whey. For example, removal of sugars and/or minerals from the soy whey stream produces a useful fraction from which the sugars can be further separated, thus yielding additional useful fractions: a concentrated sugar and a mineral fraction (that may include citric acid), and a relatively pure aqueous fraction that may be disposed of with minimal, if any, treatment or recycled as process water. Process water thus produced may be especially useful in practicing the present methods. Thus, a further advantage of the present methods may be reduced process water requirements as compared to conventional isolate preparation processes.

Methods of the present disclosure provide advantages over conventional methods for manufacture of soy protein isolates and concentrates in at least two ways. As noted, conventional methods for manufacturing soy protein materials typically dispose of the soy whey stream (e.g. aqueous soy whey or soy molasses). Thus, the products recovered by the methods of the present disclosure represent an additional product, and a revenue source not currently realized in connection with conventional soy protein isolate and soy protein concentrate manufacture. Furthermore, treatment of the soy whey stream or soy molasses to recover saleable products preferably reduces the costs associated with treatment and disposal of the soy whey stream or soy molasses. For example, as detailed elsewhere herein, various methods of the present invention provide a relatively pure soy processing stream that may be readily utilized in various other processes or disposed of with minimal, if any, treatment, thereby reducing the environmental impact of the process. Certain costs exist in association with the methods of the present disclosure, but the benefits of the additional product(s) isolated and minimization of waste disposal are believed to compensate for any added costs.

### A. Soy Whey Proteins

The soy whey proteins recovered in accordance with the processes of the present disclosure represent a significant advance in the art over other soy proteins and isolates. As noted herein, the soy whey proteins of the present disclosure, which are recovered from a processing stream, possess unique characteristics as compared to other soy proteins found in the art.

Soy protein isolates are typically precipitated from an aqueous extract of defatted soy flakes or soy flour at the isoelectric point of soy storage proteins (e.g. a pH of about 4.1). Thus, soy protein isolates generally include proteins that are not soluble in acidic liquid media. Similarly, the proteins of soy protein concentrates, the second-most refined soy protein material, are likewise generally not soluble in acidic liquid media. However, soy whey proteins recovered by the processes of the present disclosure differ in that they are generally acid-soluble, meaning they are soluble in acidic liquid media.

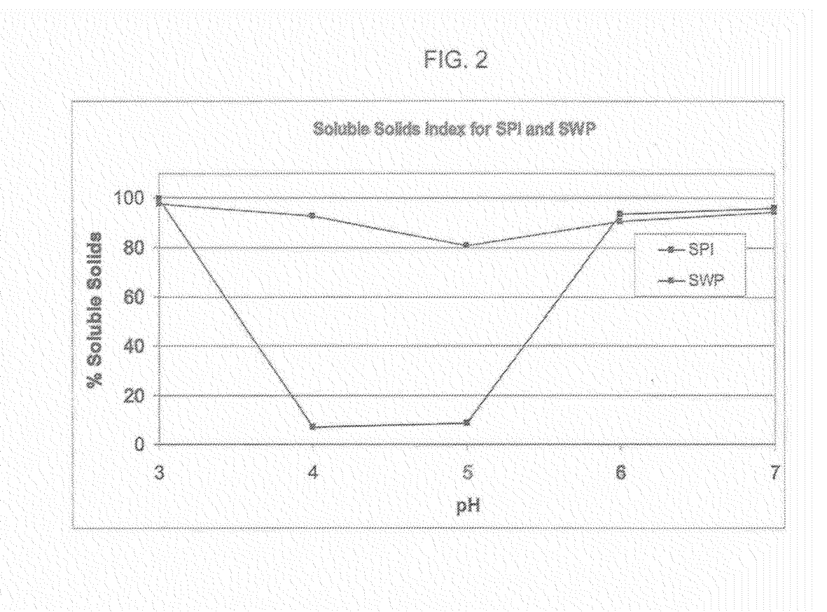

The present disclosure provides soy whey protein compositions derived from an aqueous soy whey that exhibit advantageous characteristics over soy proteins found in the prior art. For example, the soy whey proteins isolated according to the methods of the present invention possess high solubility (i.e. SSI % greater than 80) across a relatively wide pH range of the aqueous (typically acidic) medium (e.g. an aqueous medium having a pH of from about 2 to about 10, from about 2 to about 7, or from about 2 to about 6) at ambient conditions (e.g. a temperature of about 25° C.). As shown in Table 1 and graphically illustrated in FIG. 2, the solubility of the soy whey proteins isolated in accordance with the methods of the present disclosure, at all pH values tested, was at least 80%, and in all but one instance (i.e. pH 4) was at least about 90%. These findings were compared with soy protein isolate, which was shown to display poor solubility characteristics at the same acid pH values. This unique characteristic enables the soy whey proteins of the present invention to be used in applications having acidic pH levels, which represents a significant advantage over soy isolate.

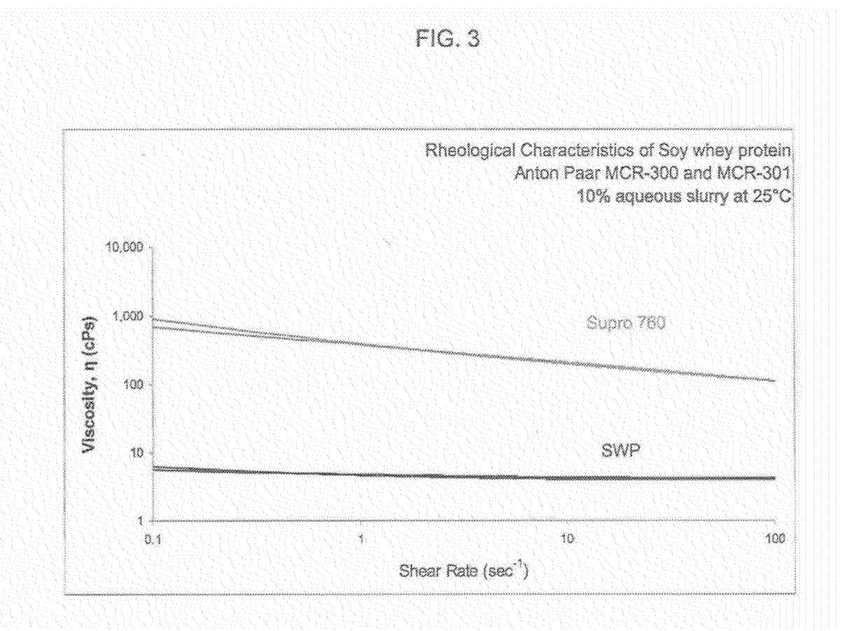

In addition to solubility, the soy whey proteins of the present disclosure also possess much lower viscosity than other soy whey proteins. As shown in Table 1 and as graphically illustrated in FIG. 3, the soy whey proteins of the present invention displayed viscoelastic properties (i.e. rheological properties) more similar to that of water than shown by soy protein isolate. The viscosity of water is about 1 centipoise (cP) at 20° C. The soy whey proteins of the present disclosure were found to exhibit viscosity within the range of from about 2.0 to 10.0 cP, and preferably from about 3.6 to 7.5 cP. This low viscosity, in addition to its high solubility at acidic pH levels, makes the soy whey protein of the present disclosure available and better suited for use in certain applications that regularly involve the use of other soy proteins (e.g., in beverages), because it has much better flow characteristics than that of soy isolate.

TABLE 1
Solubility and Viscoelastic Properties of
Soy Whey Compared to Other Soy Proteins

| | SWP | Supro 500E | Supro 670 | Supro 760 |
|---|---|---|---|---|
| SSI %, pH 3.0 | 99 | 100 | | |
| SSI %, pH 4.0 | 82.3 | 7 | | |
| SSI %, pH 5.0 | 89.4 | 9 | | |
| SSI %, pH 6.0 | 99.3 | 94 | | |
| SSI %, pH 7.0 | 99.4 | 96 | | |
| viscosity, cPs | 4.3 | | | 385 |

As Table 2 illustrates, the other physical characteristics, with the exception of the viscoelastic properties and solubility, of the soy whey protein recovered in accordance with the methods of the present disclosure were found to be very similar to that of soy isolate.

TABLE 2
Physical Characteristic Ranges of Soy
Whey Compared to Other Soy Proteins

| | ranges, | ranges, | combined |
|---|---|---|---|
| | leper | St. Louis | SWP range |
| moisture | 2.94-9.34 | 3.91-8.29 | 2.9-9.4 |
| protein_db | 71.0-89.3 | 62.48-85.17 | 62.4-89.3 |
| ash_db | 1.19-6.23 | 1.19-13.57 | 1.19-13.57 |
| fat_db | 0.201-1.11 | 0.14-1.57 | 0.14-1.57 |
| carbohydrate by diff_db | 7.2-23.7 | 5.4-30.5 | 5.4-30.5 |
| | (10 & 20 kDa | | |
| | membrane) | | |

| | | | combined |
|---|---|---|---|
| | leper SWP | St. Louis SWP | range |
| SSI %, pH 3.0 | 79-99 | 71.6-100 | 71-100 |
| SSI %, pH 4.0 | 68.7-97.3 | 67.4-94.7 | 67-98 |
| SSI %, pH 5.0 | 70.4-88.9 | 69.4-91.5 | 69-92 |
| SSI %, pH 6.0 | 79.1-93.49 | 75.1-100 | 75-100 |
| SSI %, pH 7.0 | 77.6-97.2 | 79.6-100 | 77-100 |
| viscosity, cPs | 3.6-7.5 | 3.3 (1 | 3.3-7.5 |
| | | sample only) | |

### B. Aqueous Whey Streams

Aqueous whey streams and molasses streams, which are types of soy processing streams, are generated from the process of refining a whole legume or oilseed. The whole legume or oilseed may be derived from a variety of suitable plants. By way of non-limiting example, suitable plants include leguminous plants, including for example, soybeans, corn, peas, canola, sunflowers, sorghum, rice, amaranth, potato, tapioca, arrowroot, canna, lupin, rape, wheat, oats, rye, barley, and mixtures thereof. In one embodiment, the leguminous plant is soybean and the aqueous whey stream generated from the process of refining the soybean is an aqueous soy whey stream.

Aqueous soy whey streams generated in the manufacture of soy protein isolates are generally relatively dilute and are typically discarded as waste. More particularly, the aqueous soy whey stream typically has a total solids content of less than about 10 wt. %, typically less than about 7.5 wt. % and, still more typically, less than about 5 wt. %. For example, in various aspects, the solids content of the aqueous soy whey stream is from about 0.5 to about 10 wt. %, from about 1 wt. % to about 4 wt. %, or from about 1 to about 3 wt. % (e.g. about 2 wt. %). Thus, during commercial soy protein isolate production, a significant volume of waste water that must be treated or disposed is generated.

Soy whey streams typically contain a significant portion of the initial soy protein content of the starting material soybeans. As used herein the term “soy protein” generally refers to any and all of the proteins native to soybeans. Naturally occurring soy proteins are generally globular proteins having a hydrophobic core surrounded by a hydrophilic shell. Numerous soy proteins have been identified including, for example, storage proteins such as glycinin and β-conglycinin. Soy proteins likewise include protease inhibitors, such as the above-noted BBI proteins. Soy proteins also include hemagglutinins such as lectin, lipoxygenases, β-amylase, and lunasin. It is to be noted that the soy plant may be transformed to produce other proteins not normally expressed by soy plants. It is to be understood that reference herein to “soy proteins” likewise contemplates proteins thus produced.

On a dry weight basis, soy proteins constitute at least about 10 wt. %, at least about 15 wt. %, or at least about 20 wt. % of the soy whey stream (dry weight basis). Typically, soy proteins constitute from about 10 to about 40 wt. %, or from about 25 to about 30 wt. % of the soy whey stream (dry weight basis). Soy protein isolates typically contain a significant portion of the storage proteins of the soybean. However, the soy whey stream remaining after isolate precipitation likewise contains one or more soy storage proteins.

In addition to the various soy proteins, the aqueous soy whey stream likewise comprises one or more carbohydrates (i.e. sugars). Generally, sugars constitute at least about 25%, at least about 35%, or at least about 45% by weight of the soy whey stream (dry weight basis). Typically, sugars constitute from about 25% to about 75%, more typically from about 35% to about 65% and, still more typically, from about 40% to about 60% by weight of the soy whey stream (dry weight basis).

The sugars of the soy whey stream generally include one or more monosaccharides, and/or one or more oligosaccharides or polysaccharides. For example, in various aspects, the soy whey stream comprises monosaccharides selected from the group consisting of glucose, fructose, and combinations thereof. Typically, monosaccharides constitute from about 0.5% to about 10 wt. % and, more typically from about 1% to about 5 wt. % of the soy whey stream (dry weight basis). Further in accordance with these and various other aspects, the soy whey stream comprises oligosaccharides selected from the group consisting of sucrose, raffinose, stachyose, and combinations thereof. Typically, oligosaccharides constitute from about 30% to about 60% and, more typically, from about 40% to about 50% by weight of the soy whey stream (dry weight basis).

The aqueous soy whey stream also typically comprises an ash fraction that includes a variety of components including, for example, various minerals, isoflavones, phytic acid, citric acid, saponins, and vitamins. Minerals typically present in the soy whey stream include sodium, potassium, calcium, phosphorus, magnesium, chloride, iron, manganese, zinc, copper, and combinations thereof. Vitamins present in the soy whey stream include, for example, thiamine and riboflavin. Regardless of its precise composition, the ash fraction typically constitutes from about 5% to about 30% and, more typically, from about 10% to about 25% by weight of the soy whey stream (dry weight basis).

The aqueous soy whey stream also typically comprises a fat fraction that generally constitutes from about 0.1% to about 5% by weight of the soy whey stream (dry weight basis). In certain aspects of the invention, the fat content is measured by acid hydrolysis and is about 3% by weight of the soy whey stream (dry weight basis).

In addition to the above components, the aqueous soy whey stream also typically comprises one or more microorganisms including, for example, various bacteria, molds, and yeasts. The proportions of these components typically vary from about 100 to about 1×10⁹ colony forming units (CFU) per milliliter. As detailed elsewhere herein, in various aspects, the aqueous soy whey stream is treated to remove these component(s) prior to protein recovery and/or isolation.

As noted, conventional production of soy protein isolates typically includes disposal of the aqueous soy whey stream remaining following isolation of the soy protein isolate. In accordance with the present disclosure, recovery of one or more proteins and various other components (e.g. sugars and minerals) results in a relatively pure aqueous whey stream. Conventional soy whey streams from which the protein and one or more components have not been removed generally require treatment prior to disposal and/or reuse. In accordance with various aspects of the present disclosure the aqueous whey stream may be disposed of or utilized as process water with minimal, if any, treatment. For example, the aqueous whey stream may be used in one or more filtration (e.g. diafiltration) operations of the present disclosure.

In addition to recovery of BBI proteins from aqueous soy whey streams generated in the manufacture of soy protein isolates, it is to be understood that the processes described herein are likewise suitable for recovery of one or more components of soy molasses streams generated in the manufacture of a soy protein concentrate, as soy molasses streams are an additional type of soy processing stream.

### C. General Description of Process for Soy Whey Protein Recovery

The following is a general description of the various steps that make up the overall process. A key to the process is to start with the whey protein pretreatment step, which uniquely changes the soy whey and protein properties. From there, the other steps may be performed using the raw material sources as listed in each step, as will be shown in the discussion of the various embodiments to follow.

It is understood by those skilled in the art of separation technology that there can be residual components in each permeate or retentate stream since separation is never 100%. Further, one skilled in the art realizes that separation technology can vary depending on the starting raw material.

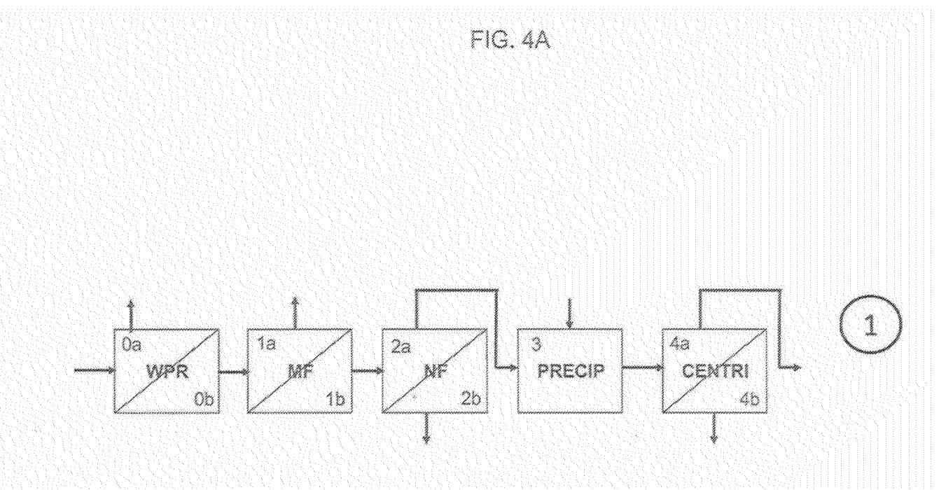

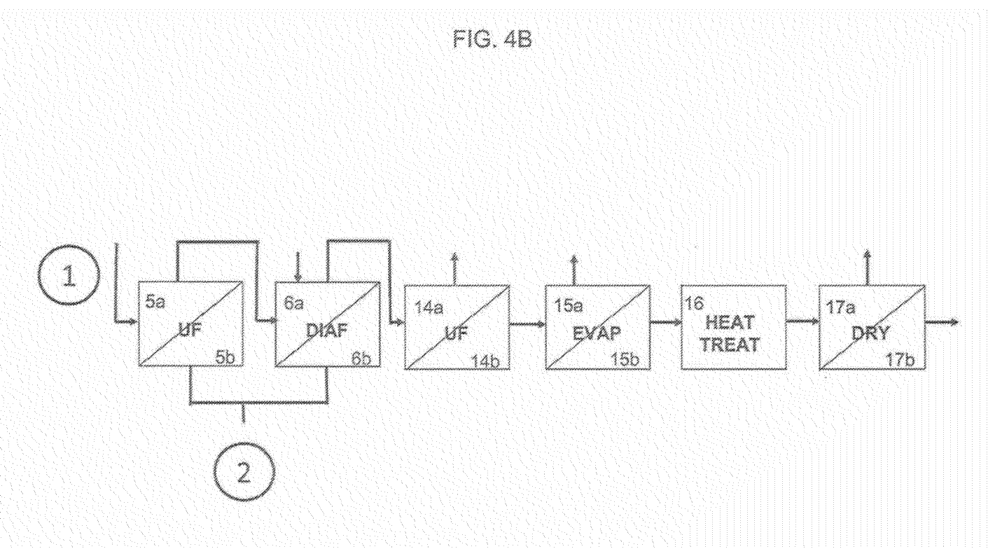

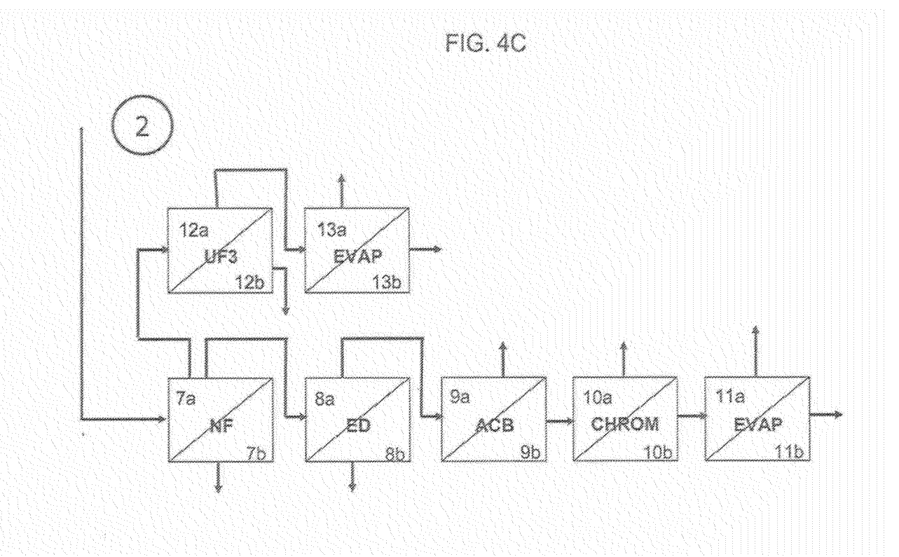

Step 0 (as shown in FIG. 4A)—Whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof.

Step 1 (as shown in FIG. 4A)—Microbiology reduction can start with the product of the whey protein pretreatment step, including but not limited to pre-treated soy whey. This step involves microfiltration of the pre-treated soy whey. Process variables and alternatives in this step include but are not limited to, centrifugation, dead-end filtration, heat sterilization, ultraviolet sterilization, microfiltration, crossflow membrane filtration, and combinations thereof. Crossflow membrane filtration includes but is not limited to: spiral-wound, plate and frame, hollow fiber, ceramic, dynamic or rotating disk, nanofiber, and combinations thereof. The pH of step 1 can be between about 2.0 and about 12.0, preferably about 5.3. The temperature can be between about 5° C. and about 90° C., preferably about 50° C. Products from step 1 include but are not limited to storage proteins, microorganisms, silicon, and combinations thereof in stream 1a (retentate) and purified pre-treated soy whey in stream 1b (permeate).

Step 2 (as shown in FIG. 4A)—A water and mineral removal can start with the purified pre-treated soy whey from stream 1b or 4a, or pre-treated soy whey from stream 0b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 3 (as shown in FIG. 4A)—the mineral precipitation step can start with purified pre-treated soy whey from stream 2a or pretreated soy whey from streams 0a or 1b. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (as shown in FIG. 4A)—the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 5 (as shown in FIG. 4B)—the protein separation and concentration step can start with purified pre-treated whey from stream 4a or the whey from streams 0a, 1b, or 2a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Step 6 (as shown in FIG. 4B)—the protein washing and purification step can start with soy whey protein, BBI, KTI, storage proteins, other proteins or purified pre-treated whey from stream 4a or 5a, or whey from streams 0a, 1b, or 2a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Step 7 (as shown in FIG. 4C)—a water removal step can start with peptides, soy oligosaccharides, water, minerals, and combinations thereof from stream 5b and/or stream 6b. Soy oligosaccharides include but are not limited to sucrose, raffinose, stachyose, verbascose, monosaccharides, and combinations thereof. It includes a nanofiltration step. Process variables and alternatives in this step include but are not limited to, reverse osmosis, evaporation, nanofiltration, water diafiltration, buffer diafiltration, and combinations thereof. The pH of step 7 can be between about 2.0 and about 12.0, preferably about 7.0. The temperature can be between about 5° C. and about 90° C., preferably about 50° C. Products from stream 7a (retentate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Products from stream 7b (permeate) include but are not limited to, water, minerals, and combinations thereof.

Step 8 (as shown in FIG. 4C)—a mineral removal step can start with peptides, soy oligosaccharides, water, minerals, and combinations thereof from streams 5b, 6b, 7a, and/or 12a. Soy oligosaccharides include but are not limited to sucrose, raffinose, stachyose, verbascose, monosaccharides, and combinations thereof. It includes an electrodialysis membrane step. Process variables and alternatives in this step include but are not limited to, ion exchange columns, chromatography, and combinations thereof. Processing aids that can be used in this mineral removal step include but are not limited to, water, enzymes, and combinations thereof. Enzymes include but are not limited to protease, phytase, and combinations thereof. The pH of step 8 can be between about 2.0 and about 12.0, preferably about 7.0. The temperature can be between about 5° C. and about 90° C., preferably about 40° C. Products from stream 8a (retentate) include but are not limited to, de-mineralized soy oligosaccharides with conductivity between about 10 milli Siemens (mS) and about 0.5 mS, preferably about 2 mS, and combinations thereof. Soy oligosaccharides include but are not limited to sucrose, raffinose, stachyose, verbascose, monosaccharides, and combinations thereof. Products from stream 8b include but are not limited to, minerals, water, and combinations thereof.

Step 9 (as shown in FIG. 4C)—a color removal step can start with de-mineralized soy oligosaccharides from streams 8a, 5b, 6b, and/or 7a). It utilizes an active carbon bed. Process variables and alternatives in this step include but are not limited to, ion exchange. Processing aids that can be used in this color removal step include but are not limited to, active carbon, ion exchange resins, and combinations thereof. The temperature can be between about 5° C. and about 90° C., preferably about 40° C. Products from stream 9a (retentate) include but are not limited to, color compounds. Stream 9b is decolored. Products from stream 9b (permeate) include but are not limited to, soy oligosaccharides, and combinations thereof. Soy oligosaccharides include but are not limited to sucrose, raffinose, stachyose, verbascose, monosaccharides, and combinations thereof.

Step 10 (as shown in FIG. 4C)—a soy oligosaccharide fractionation step can start with soy oligosaccharides, and combinations thereof from streams 9b, 5b, 6b, 7a, and/or 8a. Soy oligosaccharides include but are not limited to sucrose, raffinose, stachyose, verbascose, monosaccharides, and combinations thereof. It includes a chromatography step. Process variables and alternatives in this step include but are not limited to, chromatography, nanofiltration, and combinations thereof. Processing aids that can be used in this soy oligosaccharide fractionation step include but are not limited to acid and base to adjust the pH as one know in the art and related to the resin used. Products from stream 10a (retentate) include but are not limited to, soy oligosaccharides such as sucrose, monosaccharides, and combinations thereof. Products from stream 10b (permeate) include but are not limited to soy oligosaccharides such as, raffinose, stachyose, verbascose, and combinations thereof.

Step 11 (as shown in FIG. 4C)—a water removal step can start with soy oligosaccharides such as, raffinose, stachyose, verbascose, and combinations thereof from streams 9b, 5b, 6b, 7a, 8a, and/or 10a. It includes an evaporation step. Process variables and alternatives in this step include but are not limited to, evaporation, reverse osmosis, nanofiltration, and combinations thereof. Processing aids that can be used in this water removal step include but are not limited to, defoamer, steam, vacuum, and combinations thereof. The temperature can be between about 5° C. and about 90° C., preferably about 60° C. Products from stream 11a (retentate) include but are not limited to, water. Products from stream 11b (permeate) include but are not limited to, soy oligosaccharides, such as, raffinose, stachyose, verbascose, and combinations thereof.

Step 12 (as shown in FIG. 4C)—an additional protein separation from soy oligosaccharides step can start with peptides, soy oligosaccharides, water, minerals, and combinations thereof from stream 7b. Soy oligosaccharides include but are not limited to sucrose, raffinose, stachyose, verbascose, monosaccharides, and combinations thereof. It includes an ultrafiltration step. Process variables and alternatives in this step include but are not limited to, crossflow membrane filtration, ultrafiltration with pore sizes between about 50 kD and about 1 kD, and combinations thereof. Crossflow membrane filtration includes but is not limited to: spiral-wound, plate and frame, hollow fiber, ceramic, dynamic or rotating disk, nanofiber, and combinations thereof. Processing aids that can be used in this protein separation from sugars step include but are not limited to, acids, bases, protease, phytase, and combinations thereof. The pH of step 12 can be between about 2.0 and about 12.0, preferably about 7.0. The temperature can be between about 5° C. and about 90° C., preferably about 75° C. Products from stream 12a (retentate) include but are not limited to, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate. This stream 12a stream can be fed to stream 8. Products from stream 12b (permeate) include but are not limited to, peptides, and other proteins. Other proteins include but are not limited to lunasin, lectins, dehydrins, lipoxygenase, and combinations thereof.

Step 13 (as shown in FIG. 4C)—a water removal step can start with, peptides, and other proteins. Other proteins include but are not limited to lunasin, lectins, dehydrins, lipoxygenase, and combinations thereof. It includes an evaporation step. Process variables and alternatives in this step include but are not limited to, reverse osmosis, nanofiltration, spray drying and combinations thereof. Products from stream 13a (retentate) include but are not limited to, water. Products from stream 13b (permeate) include but are not limited to, peptides, other proteins, and combinations thereof. Other proteins include but are not limited to lunasin, lectins, dehydrins, lipoxygenase, and combinations thereof.

Step 14 (as shown in FIG. 4B)—a protein fractionation step may be done by starting with soy whey protein, BBI, KTI, storage proteins, other proteins, and combinations thereof from streams 6a and/or 5a. Other proteins include but are not limited to lunasin, lectins, dehydrins, lipoxygenase, and combinations thereof. It includes an ultrafiltration (with pore sizes from 100 kD to 10 kD) step. Process variables and alternatives in this step include but are not limited to, crossflow membrane filtration, ultrafiltration, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 14 can be between about 2.0 and about 12.0, preferably about 7.0. The temperature can be between about 5° C. and about 90° C., preferably about 75° C. Products from stream 14a (retentate) include but are not limited to, storage proteins. Products from stream 14b (permeate) include but are not limited to, soy whey protein, BBI, KTI and, other proteins. Other proteins include but are not limited to lunasin, lectins, dehydrins, lipoxygenase, and combinations thereof.

Step 15 (as shown in FIG. 4B)—a water removal step can start with soy whey protein, BBI, KTI and, other proteins from streams 6a, 5a, and/or 14b. Other proteins include but are not limited to lunasin, lectins, dehydrins, lipoxygenase, and combinations thereof. It includes an evaporation step. Process variables and alternatives in this step include but are not limited to, evaporation, nanofiltration, RO, and combinations thereof. Products from stream 15a (retentate) include but are not limited to, water. Stream 15b (permeate) products include but are not limited to soy whey protein, BBI, KTI and, other proteins. Other proteins include but are not limited to lunasin, lectins, dehydrins, lipoxygenase, and combinations thereof.

Step 16 (as shown in FIG. 4B)—a heat treatment and flash cooling step can start with soy whey protein, BBI, KTI and, other proteins from streams 6a, 5a, 14b, and/or 15b. Other proteins include but are not limited to lunasin, lectins, dehydrins, lipoxygenase, and combinations thereof. It includes an ultra high temperature step. Process variables and alternatives in this step include but are not limited to, heat sterilization, evaporation, and combinations thereof. Processing aids that can be used in this heat treatment and flash cooling step include but are not limited to, water, steam, and combinations thereof. The temperature can be between about 129° C. and about 160° C., preferably about 152° C. Temperature hold time can be between about 8 seconds and about 15 seconds, preferably about 9 seconds. Products from stream 16 include but are not limited to, soy whey protein.

Step 17 (as shown in FIG. 4B)—a drying step can start with soy whey protein, BBI, KTI and, other proteins from streams 6a, 5a, 14b, 15b, and/or 16. It includes a drying step. The liquid feed temperature can be between about 50° C. and about 95° C., preferably about 82° C. The inlet temperature can be between about 175° C. and about 370° C., preferably about 290° C. The exhaust temperature can be between about 65° C. and about 98° C., preferably about 88° C. Products from stream 17a (retentate) include but are not limited to, water. Products from stream 17b (permeate) include but are not limited to, soy whey protein which includes, BBI, KTI and, other proteins. Other proteins include but are not limited to lunasin, lectins, dehydrins, lipoxygenase, and combinations thereof.

The soy whey protein products of the current application include raw whey, a soy whey protein precursor after the ultrafiltration step of Step 17, a dry soy whey protein that can be dried by any means known in the art, and combinations thereof. All of these products can be used as is as soy whey protein or can be further processed to purify specific components of interest, such as, but not limited to BBI, KTI, and combinations thereof.

### D. Preferred Embodiments of the Process for the Recovery of Soy Whey Protein

Embodiment 1 starts with Step 0 (See FIG. 4A) as follows: Whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof. Next

Step 5 (See FIG. 4B) is done. Thus, the protein separation and concentration step in this embodiment starts with the whey from stream 0a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Embodiment 2—starts with Step 0 (See FIG. 4A) as follows:

Whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof.

Next Step 5 (See FIG. 4B) is done. Thus, the protein separation and concentration step in this embodiment starts with the whey from stream 0a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Finally Step 6 (See FIG. 4B), the protein washing and purification step starts with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Embodiment 3 starts with Step 0 (See FIG. 4A) which is a whey protein pretreatment that can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof.

Step 3 (See FIG. 4A) the mineral precipitation step can start with purified pre-treated soy whey from stream 0a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Finally, Step 5 (See FIG. 4B) the protein separation and concentration step can start with purified pre-treated whey from stream 4a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Embodiment 4 starts with Step 0 (See FIG. 4A) whey protein pretreatment that can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof.

Step 3 (See FIG. 4A) the mineral precipitation step can start with purified pre-treated soy whey from stream 0a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A)—the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 5 (See FIG. 4B)—the protein separation and concentration step can start with purified pre-treated whey from stream 4a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Finally, Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Embodiment 5 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof.

Step 3 (See FIG. 4A) the mineral precipitation step can start with pre-treated soy whey from stream 0a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A)—the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 5 (See FIG. 4B) the protein separation and concentration step can start with purified pre-treated whey from stream 4a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Step 6 (See FIG. 4B)—the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Step 16 (See FIG. 4B) a heat treatment and flash cooling step can start with soy whey protein, BBI, KTI and, other proteins from streams 6a. Other proteins include but are not limited to lunasin, lectins, dehydrins, lipoxygenase, and combinations thereof. It includes an ultra high temperature step. Process variables and alternatives in this step include but are not limited to, heat sterilization, evaporation, and combinations thereof. Processing aids that can be used in this heat treatment and flash cooling step include but are not limited to, water, steam, and combinations thereof. The temperature can be between about 129° C. and about 160° C., preferably about 152° C. Temperature hold time can be between about 8 seconds and about 15 seconds, preferably about 9 seconds. Products from stream 16 include but are not limited to, soy whey protein.

Finally, Step 17 (See FIG. 4B)—a drying step can start with soy whey protein, BBI, KTI and, other proteins from stream 16. It includes a drying step. The liquid feed temperature can be between about 50° C. and about 95° C., preferably about 82° C. The inlet temperature can be between about 175° C. and about 370° C., preferably about 290° C. The exhaust temperature can be between about 65° C. and about 98° C., preferably about 88° C. Products from stream 17a (retentate) include but are not limited to, water. Products from stream 17b (permeate) include but are not limited to, soy whey protein which includes, BBI, KTI and, other proteins. Other proteins include but are not limited to lunasin, lectins, dehydrins, lipoxygenase, and combinations thereof.

Embodiment 6 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof.

Step 3 (See FIG. 4A) the mineral precipitation step can start with pre-treated soy whey from stream 0a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 5 (See FIG. 4B) the protein separation and concentration step can start with purified pre-treated whey from stream 4a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Step 15 (See FIG. 4B) a water removal step can start with soy whey protein, BBI, KTI and, other proteins from stream 6a. Other proteins include but are not limited to lunasin, lectins, dehydrins, lipoxygenase, and combinations thereof. It includes an evaporation step. Process variables and alternatives in this step include but are not limited to, evaporation, nanofiltration, RO, and combinations thereof. Products from stream 15a (retentate) include but are not limited to, water. Stream 15b (permeate) products include but are not limited to soy whey protein, BBI, KTI and, other proteins. Other proteins include but are not limited to lunasin, lectins, dehydrins, lipoxygenase, and combinations thereof.

Step 16 (See FIG. 4B) a heat treatment and flash cooling step can start with soy whey protein, BBI, KTI and, other proteins from stream 15b. Other proteins include but are not limited to lunasin, lectins, dehydrins, lipoxygenase, and combinations thereof. It includes an ultra high temperature step. Process variables and alternatives in this step include but are not limited to, heat sterilization, evaporation, and combinations thereof. Processing aids that can be used in this heat treatment and flash cooling step include but are not limited to, water, steam, and combinations thereof. The temperature can be between about 129° C. and about 160° C., preferably about 152° C. Temperature hold time can be between about 8 seconds and about 15 seconds, preferably about 9 seconds. Products from stream 16 include but are not limited to, soy whey protein.

Finally, Step 17 (See FIG. 4B)—a drying step can start with soy whey protein, BBI, KTI and, other proteins from stream 16. It includes a drying step. The liquid feed temperature can be between about 50° C. and about 95° C., preferably about 82° C. The inlet temperature can be between about 175° C. and about 370° C., preferably about 290° C. The exhaust temperature can be between about 65° C. and about 98° C., preferably about 88° C. Products from stream 17a (retentate) include but are not limited to, water. Products from stream 17b (permeate) include but are not limited to, soy whey protein which includes, BBI, KTI and, other proteins. Other proteins include but are not limited to lunasin, lectins, dehydrins, lipoxygenase, and combinations thereof.

Embodiment 7 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof.

Step 2 (See FIG. 4A) a water and mineral removal can start with the pre-treated soy whey from stream 0b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Finally, Step 5 (See FIG. 4B) the protein separation and concentration step can start with the whey from stream 2a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Embodiment 8 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof.

Step 2 (See FIG. 4A) a water and mineral removal can start with the pre-treated soy whey from stream 0b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 5 (See FIG. 4B) the protein separation and concentration step can start with the whey from stream 2a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Finally, Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Embodiment 9 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof.

Step 2 (See FIG. 4A) a water and mineral removal can start with the pre-treated soy whey from stream 0b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 3 (See FIG. 4A) the mineral precipitation step can start with purified pre-treated soy whey from stream 2a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 5 (See FIG. 4B) the protein separation and concentration step can start with purified pre-treated whey from stream 4a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Embodiment 10 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof.

Step 2 (See FIG. 4A) a water and mineral removal can start with the pre-treated soy whey from stream 0b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 3 (See FIG. 4A) the mineral precipitation step can start with purified pre-treated soy whey from stream 2a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 5 (See FIG. 4B) the protein separation and concentration step can start with purified pre-treated whey from stream 4a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Finally, Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Embodiment 11 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof.

Step 2 (See FIG. 4A) a water and mineral removal can start with the pre-treated soy whey from stream 0b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 3 (See FIG. 4A) the mineral precipitation step can start with purified pre-treated soy whey from stream 2a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A)—the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 5 (See FIG. 4B)—the protein separation and concentration step can start with purified pre-treated whey from stream 4a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Step 16 (See FIG. 4B) a heat treatment and flash cooling step can start with soy whey protein, BBI, KTI and, other proteins from stream 6a. Other proteins include but are not limited to lunasin, lectins, dehydrins, lipoxygenase, and combinations thereof. It includes an ultra high temperature step. Process variables and alternatives in this step include but are not limited to, heat sterilization, evaporation, and combinations thereof. Processing aids that can be used in this heat treatment and flash cooling step include but are not limited to, water, steam, and combinations thereof. The temperature can be between about 129° C. and about 160° C., preferably about 152° C. Temperature hold time can be between about 8 seconds and about 15 seconds, preferably about 9 seconds. Products from stream 16 include but are not limited to, soy whey protein.

Finally, Step 17 (See FIG. 4B)—a drying step can start with soy whey protein, BBI, KTI and, other proteins from stream 16. It includes a drying step. The liquid feed temperature can be between about 50° C. and about 95° C., preferably about 82° C. The inlet temperature can be between about 175° C. and about 370° C., preferably about 290° C. The exhaust temperature can be between about 65° C. and about 98° C., preferably about 88° C. Products from stream 17a (retentate) include but are not limited to, water. Products from stream 17b (permeate) include but are not limited to, soy whey protein which includes, BBI, KTI and, other proteins. Other proteins include but are not limited to lunasin, lectins, dehydrins, lipoxygenase, and combinations thereof.

Embodiment 12 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof.

Step 2 (See FIG. 4A) a water and mineral removal can start with the purified pre-treated soy whey from stream 1b or pre-treated soy whey from stream 0b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 3 (See FIG. 4A) the mineral precipitation step can start with purified pre-treated soy whey from stream 2a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 5 (See FIG. 4B) the protein separation and concentration step can start with purified pre-treated whey from stream 4a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Step 15 (See FIG. 4B) a water removal step can start with soy whey protein, BBI, KTI and, other proteins from stream 6a. Other proteins include but are not limited to lunasin, lectins, dehydrins, lipoxygenase, and combinations thereof. It includes an evaporation step. Process variables and alternatives in this step include but are not limited to, evaporation, nanofiltration, RO, and combinations thereof. Products from stream 15a (retentate) include but are not limited to, water. Stream 15b (permeate) products include but are not limited to soy whey protein, BBI, KTI and, other proteins. Other proteins include but are not limited to lunasin, lectins, dehydrins, lipoxygenase, and combinations thereof.

Step 16 (See FIG. 4B) a heat treatment and flash cooling step can start with soy whey protein, BBI, KTI and, other proteins from stream 15b. Other proteins include but are not limited to lunasin, lectins, dehydrins, lipoxygenase, and combinations thereof. It includes an ultra high temperature step. Process variables and alternatives in this step include but are not limited to, heat sterilization, evaporation, and combinations thereof. Processing aids that can be used in this heat treatment and flash cooling step include but are not limited to, water, steam, and combinations thereof. The temperature can be between about 129° C. and about 160° C., preferably about 152° C. Temperature hold time can be between about 8 seconds and about 15 seconds, preferably about 9 seconds. Products from stream 16 include but are not limited to, soy whey protein.

Finally, Step 17 (See FIG. 4B) a drying step can start with soy whey protein, BBI, KTI and, other proteins from stream 16. It includes a drying step. The liquid feed temperature can be between about 50° C. and about 95° C., preferably about 82° C. The inlet temperature can be between about 175° C. and about 370° C., preferably about 290° C. The exhaust temperature can be between about 65° C. and about 98° C., preferably about 88° C. Products from stream 17a (retentate) include but are not limited to, water. Products from stream 17b (permeate) include but are not limited to, soy whey protein which includes, BBI, KTI and, other proteins. Other proteins include but are not limited to lunasin, lectins, dehydrins, lipoxygenase, and combinations thereof.

Embodiment 13 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof.

Step 3 (See FIG. 4A) the mineral precipitation step can start with pre-treated soy whey from stream 0a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 2 (See FIG. 4A) a water and mineral removal can start with the purified pre-treated soy whey from stream 1b or pre-treated soy whey from stream 0b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Finally, Step 5 (See FIG. 4B) the protein separation and concentration step can start with the whey from stream 2a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Embodiment 14 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof.

Step 3 (See FIG. 4A) the mineral precipitation step can start with pretreated soy whey from stream 0a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 2 (See FIG. 4A) a water and mineral removal can start with the purified pre-treated soy whey from stream 4a. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 5 (See FIG. 4B) the protein separation and concentration step can start with the whey from stream 2a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Finally, Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Embodiment 15 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof.

Step 3 (See FIG. 4A) the mineral precipitation step can start with pretreated soy whey from stream 0a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 2 (See FIG. 4A) a water and mineral removal can start with the purified pre-treated soy whey from stream 1b or pre-treated soy whey from stream 0b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 5 (See FIG. 4B) the protein separation and concentration step can start with the whey from stream 2a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Step 16 (See FIG. 4B) a heat treatment and flash cooling step can start with soy whey protein, BBI, KTI and, other proteins from stream 6a. Other proteins include but are not limited to lunasin, lectins, dehydrins, lipoxygenase, and combinations thereof. It includes an ultra high temperature step. Process variables and alternatives in this step include but are not limited to, heat sterilization, evaporation, and combinations thereof. Processing aids that can be used in this heat treatment and flash cooling step include but are not limited to, water, steam, and combinations thereof. The temperature can be between about 129° C. and about 160° C., preferably about 152° C. Temperature hold time can be between about 8 seconds and about 15 seconds, preferably about 9 seconds. Products from stream 16 include but are not limited to, soy whey protein.

Finally, Step 17 (See FIG. 4B) a drying step can start with soy whey protein, BBI, KTI and, other proteins from stream 16. It includes a drying step. The liquid feed temperature can be between about 50° C. and about 95° C., preferably about 82° C. The inlet temperature can be between about 175° C. and about 370° C., preferably about 290° C. The exhaust temperature can be between about 65° C. and about 98° C., preferably about 88° C. Products from stream 17a (retentate) include but are not limited to, water. Products from stream 17b (permeate) include but are not limited to, soy whey protein which includes, BBI, KTI and, other proteins. Other proteins include but are not limited to lunasin, lectins, dehydrins, lipoxygenase, and combinations thereof.

Embodiment 16 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof.

Step 3 (See FIG. 4A) the mineral precipitation step can start with pretreated soy whey from stream 0a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 2 (See FIG. 4A) a water and mineral removal can start with the purified pre-treated soy whey from stream 4a. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 5 (See FIG. 4B) the protein separation and concentration step can start with the whey from stream 2a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Step 15 (See FIG. 4B) a water removal step can start with soy whey protein, BBI, KTI and, other proteins from stream 6a. Other proteins include but are not limited to lunasin, lectins, dehydrins, lipoxygenase, and combinations thereof. It includes an evaporation step. Process variables and alternatives in this step include but are not limited to, evaporation, nanofiltration, RO, and combinations thereof. Products from stream 15a (retentate) include but are not limited to, water. Stream 15b (permeate) products include but are not limited to soy whey protein, BBI, KTI and, other proteins. Other proteins include but are not limited to lunasin, lectins, dehydrins, lipoxygenase, and combinations thereof.

Step 16 (See FIG. 4B) a heat treatment and flash cooling step can start with soy whey protein, BBI, KTI and, other proteins from stream 15b. Other proteins include but are not limited to lunasin, lectins, dehydrins, lipoxygenase, and combinations thereof. It includes an ultra high temperature step. Process variables and alternatives in this step include but are not limited to, heat sterilization, evaporation, and combinations thereof. Processing aids that can be used in this heat treatment and flash cooling step include but are not limited to, water, steam, and combinations thereof. The temperature can be between about 129° C. and about 160° C., preferably about 152° C. Temperature hold time can be between about 8 seconds and about 15 seconds, preferably about 9 seconds. Products from stream 16 include but are not limited to, soy whey protein.

Finally, Step 17 (See FIG. 4B) a drying step can start with soy whey protein, BBI, KTI and, other proteins from stream 16. It includes a drying step. The liquid feed temperature can be between about 50° C. and about 95° C., preferably about 82° C. The inlet temperature can be between about 175° C. and about 370° C., preferably about 290° C. The exhaust temperature can be between about 65° C. and about 98° C., preferably about 88° C. Products from stream 17a (retentate) include but are not limited to, water. Products from stream 17b (permeate) include but are not limited to, soy whey protein which includes, BBI, KTI and, other proteins. Other proteins include but are not limited to lunasin, lectins, dehydrins, lipoxygenase, and combinations thereof.

Embodiment 17 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof.

Step 1 (See FIG. 4A) Microbiology reduction can start with the product of the whey protein pretreatment step, including but not limited to pre-treated soy whey. This step involves microfiltration of the pre-treated soy whey. Process variables and alternatives in this step include but are not limited to, centrifugation, dead-end filtration, heat sterilization, ultraviolet sterilization, microfiltration, crossflow membrane filtration, and combinations thereof. Crossflow membrane filtration includes but is not limited to: spiral-wound, plate and frame, hollow fiber, ceramic, dynamic or rotating disk, nanofiber, and combinations thereof. The pH of step 1 can be between about 2.0 and about 12.0, preferably about 5.3. The temperature can be between about 5° C. and about 90° C., preferably about 50° C. Products from step 1 include but are not limited to storage proteins, microorganisms, silicon, and combinations thereof in stream 1a (retentate) and purified pre-treated soy whey in stream 1b (permeate).

Step 3 (See FIG. 4A) the mineral precipitation step can start with pretreated soy whey from stream 1b. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 2 (See FIG. 4A)—A water and mineral removal can start with the purified pre-treated soy whey from stream 4a. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 5 (See FIG. 4B) the protein separation and concentration step can start with the whey from stream 2a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Step 15 (See FIG. 4B) a water removal step can start with soy whey protein, BBI, KTI and, other proteins from stream 6a. Other proteins include but are not limited to lunasin, lectins, dehydrins, lipoxygenase, and combinations thereof. It includes an evaporation step. Process variables and alternatives in this step include but are not limited to, evaporation, nanofiltration, reverse osmosis, and combinations thereof. Products from stream 15a (retentate) include but are not limited to, water. Stream 15b (permeate) products include but are not limited to soy whey protein, BBI, KTI and, other proteins. Other proteins include but are not limited to lunasin, lectins, dehydrins, lipoxygenase, and combinations thereof.

Step 16 (See FIG. 4B) a heat treatment and flash cooling step can start with soy whey protein, BBI, KTI and, other proteins from stream 15b. Other proteins include but are not limited to lunasin, lectins, dehydrins, lipoxygenase, and combinations thereof. It includes an ultra high temperature step. Process variables and alternatives in this step include but are not limited to, heat sterilization, evaporation, and combinations thereof. Processing aids that can be used in this heat treatment and flash cooling step include but are not limited to, water, steam, and combinations thereof. The temperature can be between about 129° C. and about 160° C., preferably about 152° C. Temperature hold time can be between about 8 seconds and about 15 seconds, preferably about 9 seconds. Products from stream 16 include but are not limited to, soy whey protein.

Finally, Step 17 (See FIG. 4B) a drying step can start with soy whey protein, BBI, KTI and, other proteins from stream 16. It includes a drying step. The liquid feed temperature can be between about 50° C. and about 95° C., preferably about 82° C. The inlet temperature can be between about 175° C. and about 370° C., preferably about 290° C. The exhaust temperature can be between about 65° C. and about 98° C., preferably about 88° C. Products from stream 17a (retentate) include but are not limited to, water. Products from stream 17b (permeate) include but are not limited to, soy whey protein which includes, BBI, KTI and, other proteins. Other proteins include but are not limited to lunasin, lectins, dehydrins, lipoxygenase, and combinations thereof.

Embodiment 18 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof.

Step 1 (See FIG. 4A) Microbiology reduction can start with the product of the whey protein pretreatment step, including but not limited to pre-treated soy whey. This step involves microfiltration of the pre-treated soy whey. Process variables and alternatives in this step include but are not limited to, centrifugation, dead-end filtration, heat sterilization, ultraviolet sterilization, microfiltration, crossflow membrane filtration, and combinations thereof. Crossflow membrane filtration includes but is not limited to: spiral-wound, plate and frame, hollow fiber, ceramic, dynamic or rotating disk, nanofiber, and combinations thereof. The pH of step 1 can be between about 2.0 and about 12.0, preferably about 5.3. The temperature can be between about 5° C. and about 90° C., preferably about 50° C. Products from step 1 include but are not limited to storage proteins, microorganisms, silicon, and combinations thereof in stream 1a (retentate) and purified pre-treated soy whey in stream 1b (permeate).

Step 2 (See FIG. 4A) a water and mineral removal can start with the purified pre-treated soy whey from stream 1b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 3 (See FIG. 4A) the mineral precipitation step can start with purified pre-treated soy whey from stream 2a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A)—the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 5 (See FIG. 4B) the protein separation and concentration step can start with purified pre-treated whey from stream 4a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Step 15 (See FIG. 4B) a water removal step can start with soy whey protein, BBI, KTI and, other proteins from stream 6a. Other proteins include but are not limited to lunasin, lectins, dehydrins, lipoxygenase, and combinations thereof. It includes an evaporation step. Process variables and alternatives in this step include but are not limited to, evaporation, nanofiltration, reverse osmosis, and combinations thereof. Products from stream 15a (retentate) include but are not limited to, water. Stream 15b (permeate) products include but are not limited to soy whey protein, BBI, KTI and, other proteins. Other proteins include but are not limited to lunasin, lectins, dehydrins, lipoxygenase, and combinations thereof.

Step 16 (See FIG. 4B) a heat treatment and flash cooling step can start with soy whey protein, BBI, KTI and, other proteins from stream 15b. Other proteins include but are not limited to lunasin, lectins, dehydrins, lipoxygenase, and combinations thereof. It includes an ultra high temperature step. Process variables and alternatives in this step include but are not limited to, heat sterilization, evaporation, and combinations thereof. Processing aids that can be used in this heat treatment and flash cooling step include but are not limited to, water, steam, and combinations thereof. The temperature can be between about 129° C. and about 160° C., preferably about 152° C. Temperature hold time can be between about 8 seconds and about 15 seconds, preferably about 9 seconds. Products from stream 16 include but are not limited to, soy whey protein.

Finally, Step 17 (See FIG. 4B) a drying step can start with soy whey protein, BBI, KTI and, other proteins from stream 16. It includes a drying step. The liquid feed temperature can be between about 50° C. and about 95° C., preferably about 82° C. The inlet temperature can be between about 175° C. and about 370° C., preferably about 290° C. The exhaust temperature can be between about 65° C. and about 98° C., preferably about 88° C. Products from stream 17a (retentate) include but are not limited to, water. Products from stream 17b (permeate) include but are not limited to, soy whey protein which includes, BBI, KTI and, other proteins. Other proteins include but are not limited to lunasin, lectins, dehydrins, lipoxygenase, and combinations thereof.

### E. Embodiments Directed to Recovery of Sugars

Embodiment 19 encompasses Step 7 (See FIG. 4C) a water removal step can start with peptides, soy oligosaccharides, water, minerals, and combinations thereof from stream 5b and/or stream 6b. Soy oligosaccharides include but are not limited to sucrose, raffinose, stachyose, verbascose, monosaccharides, and combinations thereof. It includes a nanofiltration step. Process variables and alternatives in this step include but are not limited to, reverse osmosis, evaporation, nanofiltration, water diafiltration, buffer diafiltration, and combinations thereof. The pH of step 7 can be between about 2.0 and about 12.0, preferably about 7.0. The temperature can be between about 5° C. and about 90° C., preferably about 50° C. Products from stream 7a (retentate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Products from stream 7b (permeate) include but are not limited to, water, minerals, and combinations thereof.

Embodiment 20 starts with Step 7 (See FIG. 4C) a water removal step can start with peptides, soy oligosaccharides, water, minerals, and combinations thereof from stream 5b and/or stream 6b. Soy oligosaccharides include but are not limited to sucrose, raffinose, stachyose, verbascose, monosaccharides, and combinations thereof. It includes a nanofiltration step. Process variables and alternatives in this step include but are not limited to, reverse osmosis, evaporation, nanofiltration, water diafiltration, buffer diafiltration, and combinations thereof. The pH of step 7 can be between about 2.0 and about 12.0, preferably about 7.0. The temperature can be between about 5° C. and about 90° C., preferably about 50° C. Products from stream 7a (retentate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Products from stream 7b (permeate) include but are not limited to, water, minerals, and combinations thereof.

Finally, Step 11 (See FIG. 4C) a water removal step can start with soy oligosaccharides such as, raffinose, stachyose, verbascose, and combinations thereof from stream 7a. It includes an evaporation step. Process variables and alternatives in this step include but are not limited to, evaporation, reverse osmosis, nanofiltration, and combinations thereof. Processing aids that can be used in this water removal step include but are not limited to, defoamer, steam, vacuum, and combinations thereof. The temperature can be between about 5° C. and about 90° C., preferably about 60° C. Products from stream 11a (retentate) include but are not limited to, water. Products from stream 11b (permeate) include but are not limited to, soy oligosaccharides, such as, raffinose, stachyose, verbascose, and combinations thereof.

Embodiment 21 starts with Step 7 (See FIG. 4C) a water removal step can start with peptides, soy oligosaccharides, water, minerals, and combinations thereof from stream 5b and/or stream 6b. Soy oligosaccharides include but are not limited to sucrose, raffinose, stachyose, verbascose, monosaccharides, and combinations thereof. It includes a nanofiltration step. Process variables and alternatives in this step include but are not limited to, reverse osmosis, evaporation, nanofiltration, water diafiltration, buffer diafiltration, and combinations thereof. The pH of step 7 can be between about 2.0 and about 12.0, preferably about 7.0. The temperature can be between about 5° C. and about 90° C., preferably about 50° C. Products from stream 7a (retentate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Products from stream 7b (permeate) include but are not limited to, water, minerals, and combinations thereof.

Finally, Step 8 (See FIG. 4C) a mineral removal step can start with peptides, soy oligosaccharides, water, minerals, and combinations thereof from stream 7a. Soy oligosaccharides include but are not limited to sucrose, raffinose, stachyose, verbascose, monosaccharides, and combinations thereof. It includes an electrodialysis membrane step. Process variables and alternatives in this step include but are not limited to, ion exchange columns, chromatography, and combinations thereof. Processing aids that can be used in this mineral removal step include but are not limited to, water, enzymes, and combinations thereof. Enzymes include but are not limited to protease, phytase, and combinations thereof. The pH of step 8 can be between about 2.0 and about 12.0, preferably about 7.0. The temperature can be between about 5° C. and about 90° C., preferably about 40° C. Products from stream 8a (retentate) include but are not limited to, de-mineralized soy oligosaccharides with conductivity between about 10 milli Siemens (mS) and about 0.5 mS, preferably about 2 mS, and combinations thereof. Soy oligosaccharides include but are not limited to sucrose, raffinose, stachyose, verbascose, monosaccharides, and combinations thereof. Products from stream 8b include but are not limited to, minerals, water, and combinations thereof.

Embodiment 22 starts with Step 7 (See FIG. 4C) a water removal step can start with peptides, soy oligosaccharides, water, minerals, and combinations thereof from stream 5b and/or stream 6b. Soy oligosaccharides include but are not limited to sucrose, raffinose, stachyose, verbascose, monosaccharides, and combinations thereof. It includes a nanofiltration step. Process variables and alternatives in this step include but are not limited to, reverse osmosis, evaporation, nanofiltration, water diafiltration, buffer diafiltration, and combinations thereof. The pH of step 7 can be between about 2.0 and about 12.0, preferably about 7.0. The temperature can be between about 5° C. and about 90° C., preferably about 50° C. Products from stream 7a (retentate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Products from stream 7b (permeate) include but are not limited to, water, minerals, and combinations thereof.

Step 8 (See FIG. 4C) a mineral removal step can start with peptides, soy oligosaccharides, water, minerals, and combinations thereof from stream 7a. Soy oligosaccharides include but are not limited to sucrose, raffinose, stachyose, verbascose, monosaccharides, and combinations thereof. It includes an electrodialysis membrane step. Process variables and alternatives in this step include but are not limited to, ion exchange columns, chromatography, and combinations thereof. Processing aids that can be used in this mineral removal step include but are not limited to, water, enzymes, and combinations thereof. Enzymes include but are not limited to protease, phytase, and combinations thereof. The pH of step 8 can be between about 2.0 and about 12.0, preferably about 7.0. The temperature can be between about 5° C. and about 90° C., preferably about 40° C. Products from stream 8a (retentate) include but are not limited to, de-mineralized soy oligosaccharides with conductivity between about 10 milli Siemens (mS) and about 0.5 mS, preferably about 2 mS, and combinations thereof. Soy oligosaccharides include but are not limited to sucrose, raffinose, stachyose, verbascose, monosaccharides, and combinations thereof. Products from stream 8b include but are not limited to, minerals, water, and combinations thereof.

Finally, Step 11 (See FIG. 4C) a water removal step can start with soy oligosaccharides such as, raffinose, stachyose, verbascose, and combinations thereof from stream 8a. It includes an evaporation step. Process variables and alternatives in this step include but are not limited to, evaporation, reverse osmosis, nanofiltration, and combinations thereof. Processing aids that can be used in this water removal step include but are not limited to, defoamer, steam, vacuum, and combinations thereof. The temperature can be between about 5° C. and about 90° C., preferably about 60° C. Products from stream 11a (retentate) include but are not limited to, water. Products from stream 11b (permeate) include but are not limited to, soy oligosaccharides, such as, raffinose, stachyose, verbascose, and combinations thereof.

Embodiment 23 starts with Step 7 (See FIG. 4C) a water removal step can start with peptides, soy oligosaccharides, water, minerals, and combinations thereof from stream 5b and/or stream 6b. Soy oligosaccharides include but are not limited to sucrose, raffinose, stachyose, verbascose, monosaccharides, and combinations thereof. It includes a nanofiltration step. Process variables and alternatives in this step include but are not limited to, reverse osmosis, evaporation, nanofiltration, water diafiltration, buffer diafiltration, and combinations thereof. The pH of step 7 can be between about 2.0 and about 12.0, preferably about 7.0. The temperature can be between about 5° C. and about 90° C., preferably about 50° C. Products from stream 7a (retentate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Products from stream 7b (permeate) include but are not limited to, water, minerals, and combinations thereof.

Step 8 (See FIG. 4C) a mineral removal step can start with peptides, soy oligosaccharides, water, minerals, and combinations thereof from stream 7a. Soy oligosaccharides include but are not limited to sucrose, raffinose, stachyose, verbascose, monosaccharides, and combinations thereof. It includes an electrodialysis membrane step. Process variables and alternatives in this step include but are not limited to, ion exchange columns, chromatography, and combinations thereof. Processing aids that can be used in this mineral removal step include but are not limited to, water, enzymes, and combinations thereof. Enzymes include but are not limited to protease, phytase, and combinations thereof. The pH of step 8 can be between about 2.0 and about 12.0, preferably about 7.0. The temperature can be between about 5° C. and about 90° C., preferably about 40° C. Products from stream 8a (retentate) include but are not limited to, de-mineralized soy oligosaccharides with conductivity between about 10 milli Siemens (mS) and about 0.5 mS, preferably about 2 mS, and combinations thereof. Soy oligosaccharides include but are not limited to sucrose, raffinose, stachyose, verbascose, monosaccharides, and combinations thereof. Products from stream 8b include but are not limited to, minerals, water, and combinations thereof.

Step 9 (See FIG. 4C) a color removal step can start with de-mineralized soy oligosaccharides from stream 8a. It utilizes an active carbon bed. Process variables and alternatives in this step include but are not limited to, ion exchange. Processing aids that can be used in this color removal step include but are not limited to, active carbon, ion exchange resins, and combinations thereof. The temperature can be between about 5° C. and about 90° C., preferably about 40° C. Products from stream 9a (retentate) include but are not limited to, color compounds. Stream 9b is decolored. Products from stream 9b (permeate) include but are not limited to, soy oligosaccharides, and combinations thereof. Soy oligosaccharides include but are not limited to sucrose, raffinose, stachyose, verbascose, monosaccharides, and combinations thereof.

Step 10 (See FIG. 4C) a soy oligosaccharide fractionation step can start with soy oligosaccharides, and combinations thereof from stream 9b. Soy oligosaccharides include but are not limited to sucrose, raffinose, stachyose, verbascose, monosaccharides, and combinations thereof. It includes a chromatography step. Process variables and alternatives in this step include but are not limited to, chromatography, nanofiltration, and combinations thereof. Processing aids that can be used in this soy oligosaccharide fractionation step include but are not limited to acid and base to adjust the pH as one know in the art and related to the resin used. Products from stream 10a (retentate) include but are not limited to, soy oligosaccharides such as sucrose, monosaccharides, and combinations thereof. Products from stream 10b (permeate) include but are not limited to soy oligosaccharides such as, raffinose, stachyose, verbascose, and combinations thereof.

Finally, Step 11 (See FIG. 4C) a water removal step can start with soy oligosaccharides such as, raffinose, stachyose, verbascose, and combinations thereof from stream 10a. It includes an evaporation step. Process variables and alternatives in this step include but are not limited to, evaporation, reverse osmosis, nanofiltration, and combinations thereof. Processing aids that can be used in this water removal step include but are not limited to, defoamer, steam, vacuum, and combinations thereof. The temperature can be between about 5° C. and about 90° C., preferably about 60° C. Products from stream 11a (retentate) include but are not limited to, water. Products from stream 11b (permeate) include but are not limited to, soy oligosaccharides, such as, raffinose, stachyose, verbascose, and combinations thereof.

### F. Beverage Compositions Comprising Soy Whey Proteins

The soy whey proteins that have been recovered from soy processing streams in accordance with the methods of the present disclosure and that possess the novel characteristics described in more detail in A., above, may further be used in food compositions. Specifically, the compositions of the present invention comprise the soy whey proteins described herein combined with at least one additional ingredient to form a beverage product. The beverage compositions will vary depending on the desired end product but can include and is not limited to dairy, fruit, soy, or other vegetable juice based products. The beverage can be a cloudy beverage, clear beverage, or substantially clear beverage.

In one embodiment, the beverage may be a substantially cloudy beverage such as a meal replacement drink, a protein shake, a chai drink, a dairy based drink, a drinkable yogurt, soy creamers, a smoothie, a coffee-based beverage, non-dairy based carbonated beverages, a nutritional supplement beverage, a medical nutrition beverage, a pediatric nutritional drink, a clinical nutrition liquid, or a weight management beverage.

In another embodiment, the beverage may be a ready-to-drink (RTD) beverage. Non-limiting examples of the beverage can include a substantially clear beverage such as a juice beverage, bottled water, a fruit flavored beverage, a carbonated beverage (such as soda pop and carbonated water), isotonic beverages, energy beverages, a sports drink, a nutritional supplement beverage, a weight management beverage, RTD acidic (RTD-A) beverages, RTD neutral (RTD-N) beverages, or an alcohol-based fruit beverage. In another embodiment the beverage can be a combination of a soy and juice based product.

In another embodiment the product may be a dry blended beverage (DBB) or powder.

In another embodiment, the beverage composition can be a liquid refrigerated or liquid shelf stable beverage. Including but not limited to soy milk beverages, soy juice refresher beverages, soy milk shake beverages or soy smoothie beverages. The beverage may also include any additional ingredients typically used in the industry.

### (a) Soy Whey Protein

The beverage products of the present invention will comprise, as one of the ingredients, soy whey protein which has been recovered from soy processing streams in accordance with the methods of the current invention. Typically, the amount of soy whey protein present in the beverage composition can and will vary depending on the desired beverage product. By way of example, the concentration of soy whey protein in the beverage composition may be about 60%, 55%, 50%, 45%, 40%, 35%, 30%, 25%, 20%, 15%, 10%, 5%, 2%, 1% or 0.05% by weight. In one embodiment, the amount of soy whey protein present in the beverage composition may range from about 0.5% to about 60% by weight. In another embodiment, the amount of soy whey protein present in the beverage composition may range from about 5% to about 30% by weight. In an additional embodiment, the amount of soy whey protein present in the beverage composition may range from about 10% to about 25% by weight.

The soy whey protein may be added at the initial hydration step or to the pre-mix or at a subsequent processing step in the preparation of the beverage composition. In one embodiment, the soy whey protein is added in water as part of the initial hydration of the protein followed by the addition of other formula ingredients. In an alternative embodiment, the soy whey protein is added to the dry ingredients in a dry form as part of the dry blend pre-mix before adding to the liquid ingredients.

### (b) Protein-Containing Material

In addition to the soy whey protein obtained through the methods of the present disclosure, other optional protein-containing material may also be present in the beverage composition. While ingredients comprising proteins derived from plants are typically used, it is also envisioned that proteins derived from other sources, such as animal sources, may be utilized without departing from the scope of the invention. For example, a dairy protein selected from the group consisting of casein, caseinates, whey protein, and mixtures thereof, may be utilized. By way of further example, an egg protein selected from the group consisting of ovalbumin, ovoglobulin, ovomucin, ovomucoid, ovotransferrin, ovovitella, ovovitellin, albumin globulin, and vitellin may be used.

In an exemplary embodiment, at least one ingredient derived from a variety of suitable plants will be present in the beverage composition. By way of non-limiting example, suitable plants include legumes, corn, peas, canola, sunflower, sorghum, rice, amaranth, potato, tapioca, arrowroot, canna, lupin, rape, wheat, oats, rye, barley, and mixtures thereof. In a preferred embodiment, the additional protein-containing material is isolated from soybeans.

Suitable soybean derived protein-containing ingredients (“soy protein material”) which may be present in the ingredient(s) used to form the beverage products include soybean protein isolate, soy protein concentrate, soy protein flour, soy protein hydrolysate, and mixtures thereof. Generally speaking, when soy isolate is used, an isolate is preferably selected that is not a highly hydrolyzed soy protein isolate. In certain embodiments, highly hydrolyzed soy protein isolates may be used in combination with other soy protein isolates. Examples of commercially available soy protein material that may be utilized in the invention include, for example and among them include SUPRO® 120, SUPRO® 313, SUPRO® 320, SUPRO® 430, SUPRO® 500E, SUPRO® 545, SUPRO® 620, SUPRO® 670, SUPRO® EX 33, SUPRO® 1751, SUPRO® 1610, SUPRO® 1651, SUPRO® XT 219, SUPRO® XT40, ALPHA® 5800, SUPRO® XT 220, SUPRO® XF 8020, SUPRO® XF8021, and combinations thereof, all of which are available from Solae, LLC (St. Louis, Mo.). The amount of protein present in the beverage composition can and will vary depending upon the desired beverage product.

The amount of additional protein-containing material that may optionally be present in the beverage composition may range from about 0% to about 30% by weight. In another embodiment, the amount of additional protein-containing material present in the beverage composition may range from about 2% to about 20% by weight. In an additional embodiment, the amount of additional protein-containing material that may be present in the beverage composition may range from about 3% to about 10% by weight. In another embodiment, no additional protein-containing material except for the soy whey protein is included in the beverage composition.

### (c) Carbohydrate Source

The soy whey protein detailed above may be combined with at least one carbohydrate source. Generally, the carbohydrate source is starch (pre-gelatinized starch or a modified food starch), sugar, or flour (for example wheat, rice, corn, peanut, or konjac). Suitable starches are known in the art and may include starches derived from vegetables (including legumes) or grains. Non-limiting examples of suitable starches may include starch derived from corn, potato, rice, wheat, arrowroot, guar gum, locust bean, tapioca, arracacha, buckwheat, banana, barley, cassaya, konjac, kudzu, oca, sago, sorghum, sweet potato, taro, yams, and mixtures thereof. Edible legumes, such as favas, lentils and peas are also rich in suitable starches. Non-limiting examples of suitable sugars may include sucrose, dextrose, lactose, and fructose.

Regardless of the specific carbohydrate source used, the percentage of starch and or type of carbohydrate (e.g., maltodextrin low DE (dextrose equivalent) vs. high DE corn syrup solids) utilized in the beverage product typically determines, in part, its texture when it is expanded. As such, the amount of carbohydrates present in the beverage composition can and will vary depending on the desired texture of the resultant beverage product. For example, the amount of carbohydrates present in the beverage composition may range from about 1% to about 30% by weight. In another embodiment, the amount of carbohydrates present in the beverage composition may range from about 3% to about 20% by weight. In an additional embodiment, the amount of carbohydrates that may be present in the beverage composition may range from about 5% to about 10% by weight.

### (d) Additional Ingredients

In addition to the ingredients detailed in (a)-(c) above, a variety of other ingredients may be added to the pre-blend or at a subsequent processing step without departing from the scope of the invention. For example, dietary fiber, antioxidants, antimicrobial agents, thickening agents, stabilizers, vegetable oils, animal derived fats, emulsifiers, pH-adjusting agents, preservatives, dairy products, flavoring agents, sweetening agents, coloring agents, other nutrients, and combinations thereof may be included in the pre-blend for the beverage composition.

In one embodiment, the pre-blend may comprise a vegetable oil. Non-limiting examples of suitable vegetable oils include palm oil, rapeseed oil, soybean oil, sunflower oil, canola oil, corn oil, coconut oil, lecithin, soy lecithin,. The percent of the pre-blend comprised of a vegetable oil will depend, in part, on the vegetable oil used and desired product. Generally, a vegetable oil may comprise between about 0.1% and 45% by weight of the pre-blend. Preferably, a vegetable oil may comprise between about 1% and 30% by weight of the pre-blend.

In one embodiment, the pre-blend may comprise an emulsifier. Non-limiting examples of suitable emulsifiers include distilled mono and diglycerides, propylene glycol monoesters, sodium stearoyl-2-lactylate, polysorbate 60, lecithin, hydroxylated lecithin, and combinations thereof. The percent of the pre-blend comprised of an emulsifier will depend, in part, on the emulsifier used and desired product. Generally, an emulsifier may comprise between about 0.01% and 10% by weight of the pre-blend. Preferably, an emulsifier may comprise between about 0.05% and 5% by weight of the pre-blend. More preferably, an emulsifier may comprise between about 0.5% to 2% by weight of the pre-blend.

The beverage composition may optionally comprise a stabilizer to inhibit the separation of the beverage product. Non-limiting examples of suitable stabilizers used in the art include pectin, agar agar, food gums such as locust bean gum, xanthan gum and guar gum, alginic acid, carrageenan, gelatin, calcium chloride, lecithin, mono- and diglycerides, and combinations thereof. The stabilizer may be present in the beverage composition at a level from about 0.01% to about 10%, preferably from about 0.05% to about 5%, and more preferably from about 0.1% to about 2% by weight of the composition. As will be appreciated by a skilled artisan, the amount of stabilizer, if any, added to the beverage composition can and will depend upon the type of beverage product desired.

Antioxidant additives include ascorbic acid, BHA, BHT, TBHQ, vitamins A, C, and E and derivatives, and various plant extracts such as those containing cartenoids, tocopherols or flavonoids having antioxidant properties, may be included to increase the shelf-life or nutritionally enhance the food product. The antioxidants may have a presence at levels from about 0.01% to about 10%, preferably from about 0.05% to about 5%, and more preferably from about 0.1% to about 2% by weight of the composition.

The beverage composition may optionally include a thickening agent or stabilizer depending on the desired beverage product to be produced. Suitable thickening agents may include carrageenan, cellulose gum, cellulose gel, starch, low DE maltidextrin, gum arabic, xanthan gum, and any other thickening agent known and used in the industry. The thickening agent may be present in the beverage composition at levels from about 0.01% to about 10%, preferably fro about 0.05% to about 5%, and more preferably from about 0.1% to about 2% by weight of the ingredients. As will be appreciated by a skilled artisan, the amount of thickening agent, if any, added to the beverage composition can and will depend upon the type of beverage product desired.

In some embodiments, it may be desirable to lower or raise the pH of the beverage composition depending on the type of beverage end product desired. Thus, the beverage composition may be contacted with a pH-adjusting agent. In one embodiment, the pH of the beverage composition may range from about 3.0 to about 7.5. In another embodiment, the pH of the beverage composition may be higher than about 7.2. In yet another embodiment, the pH of the beverage composition may be lower than about 4.0. Several pH-adjusting agents are suitable for use in the invention. The pH-adjusting agent may be organic or alternatively, it may be inorganic. In exemplary embodiments, the pH-adjusting agent is a food grade edible acid. Non-limiting acids suitable for use in the invention include acetic, lactic, hydrochloric, phosphoric, citric, tartaric, malic, glucono, deltalactone, gluconic, and combinations thereof. In an exemplary embodiment, the pH-adjusting agent is citric acid. In an alternative embodiment, the pH-adjusting agent may be a pH-raising agent, such as but not limited to disodium diphosphate and potassium hydroxide. As will be appreciated by a skilled artisan, the amount of pH-adjusting agent contacted with the beverage composition can and will vary depending on several parameters, including, the agent selected and the desired pH.

The beverage composition may optionally include a variety of flavorings, spices, or other ingredients to naturally enhance the taste of the final beverage product. As will be appreciated by a skilled artisan, the selection of ingredients added to the beverage composition can and will depend upon the type of beverage product desired.

The beverage composition may optionally include an ingredient that is a dairy product. Suitable non-limiting examples of dairy products that may additionally be added to the beverage composition are skim milk, reduced fat milk, 2% milk, whole milk, cream, ice cream, evaporated milk, yogurt, buttermilk, dry milk powder, non-fat dry milk powder, milk proteins, acid casein, caseinate (e.g., sodium caseinate, calcium caseinate, etc.), whey protein concentrate, and combinations thereof.

In one embodiment, the beverage composition may further comprise a flavoring agent. The flavoring agent may include any suitable edible flavoring agent known in the art including, but not limited to, salt, any flower flavor, any spice flavor, vanilla, any fruit flavor, caramel, nut flavor, beef, poultry (e.g. chicken or turkey), pork or seafood flavors, dairy flavors such as butter and cheese, any vegetable flavor and combinations thereof.

The flavoring may also be sweet. Sugar, sweet dairy whey, soy molasses, corn syrup solids, honey, glucose, sucrose, fructose, maltodextrin, sucralose, corn syrup (liquid or solids), acesulfame potassium, stevia, monk fruit extract, honey, maple syrup, etc. may be used for sweet flavors. Additionally, other sweet flavors may be used (e.g., chocolate, chocolate mint, caramel, toffee, butterscotch, mint, and peppermint flavorings). Sugar alcohols may also be used as sweeteners.

A wide variety of fruit or citrus flavors may also be used in the beverage composition. Non-limiting examples of fruit or citrus flavors include strawberry, banana, pineapple, coconut, cherry, orange, and lemon flavors.

In an additional embodiment, the beverage composition may further comprise a coloring agent. The coloring agent may be any suitable food coloring, additive, dye or lake known to those skilled in the art. Suitable food colorants may include, but are not limited to, for example, Food, Drug and Cosmetic (FD&C) Blue No. 1, FD&C Blue No. 2, FD&C Green No. 3, FD&C Red No. 3, FD&C Red No. 40, FD&C Yellow No. 5, FD&C Yellow No. 6, Orange B, Citrus Red No. 2 and combinations thereof. Other coloring agents may include annatto extract, b-apo-8′-carotenal, beta-carotene, beet powder, canthanxantin, caramel color, carrot oil, cochineal extract, cottonseed flour, ferrous gluconate, fruit juice, grape color extract, paprika, riboflavin, saffron, titanium dioxide, turmeric, and vegetable juice. These coloring agents may be combined or mixed as is common to those skilled in the art to produce a final coloring agent.

In a further embodiment, the beverage composition may further comprise a nutrient such as a vitamin, a mineral, an antioxidant, an omega-3 fatty acid, or an herb. Suitable vitamins include Vitamins A, C and E, which are also antioxidants, and Vitamins B and D. Examples of minerals that may be added include the salts of aluminum, ammonium, calcium, magnesium, and potassium. Suitable omega-3 fatty acids include docosahexanenoic acid (DHA). Herbs that may be added include basil, celery leaves, chervil, chives, cilantro, parsley, oregano, tarragon, and thyme.

### (e) Processing into Beverage Products

As referenced herein, the beverage compositions comprising soy whey proteins recovered from processing streams may undergo typical processing known in the industry to produce the desired beverage end product. Generally speaking, any method of processing known in the industry can be used to produce the desired beverage product.

For example, in one embodiment, the beverage compositions comprising soy whey proteins recovered from processing streams may undergo processing involving ingredient blending and a heat treatment step. In another embodiment, the compositions may additionally undergo pasteurization either prior or subsequent to any initial heat treatment. In a further embodiment, the compositions may additionally undergo homogenization prior to, subsequent to or in lieu of pasteurization. In yet another embodiment, the compositions comprising soy whey proteins recovered from processing streams may additionally be cooled in accordance with typical industry standards following the heat treatment, pasteurization and/or homogenization, prior to forming a beverage product. The cooling of the beverage composition may include refrigeration, freezing, or a combination of both.

### DEFINITIONS

To facilitate understanding of the invention, several terms are defined below.

The term “acid soluble” as used herein refers to a substance having a solubility of at least about 80% with a concentration of 10 grams per liter (g/L) in an aqueous medium having a pH of from about 2 to about 7.

The terms “soy protein isolate” or “isolated soy protein,” as used herein, refer to a soy material having a protein content of at least about 90% soy protein on a moisture free basis.

The term “other proteins” as used herein referred to throughout the application are defined as including but not limited to: lunasin, lectins, dehydrins, lipoxygenase, and combinations thereof.

The term “soy whey protein” as used herein is defined as including protein soluble at those pHs where soy storage proteins are typically insoluble, including but not limited to BBI, KTI, lunasin, lipoxygenase, dehydrins, lectins, and combinations thereof. Soy whey protein may further include storage proteins.

The term “subject” or “subjects” as used herein refers to a mammal (preferably a human), bird, fish, reptile, or amphibian, in need of treatment for a pathological state, which pathological state includes, but is not limited to, diseases associated with muscle, uncontrolled cell growth, autoimmune diseases, and cancer.

The term “processing stream” as used herein refers to the secondary or incidental product derived from the process of refining a whole legume or oilseed, including an aqueous or solvent stream, which includes, for example, an aqueous soy extract stream, an aqueous soymilk extract stream, an aqueous soy whey stream, an aqueous soy molasses stream, an aqueous soy protein concentrate soy molasses stream, an aqueous soy permeate stream, and an aqueous tofu whey stream, and additionally includes soy whey protein, for example, in both liquid and dry powder form, that can be recovered as an intermediate product in accordance with the methods disclosed herein.

The term “beverage food products” as used herein broadly refers to a liquid mixture of a combination of safe and suitable ingredients including, but not limited to, soy whey protein, carbohydrates, stabilizers, and emulsifiers. Other ingredients such as dairy products, sweeteners, antioxidants, vitamins, minerals, coloring, and flavoring and may also be included. Specific beverage food products include, for example, ready to drink (RTD) beverages, infant formula, sports drinks, clinical nutrition drinks, yogurt smoothies, juice smoothies, coffee creamers and the like.

When introducing elements of the present invention or the preferred embodiments(s) thereof, the articles “a,” “an,” “the” and “said” are intended to mean that there are one or more of the elements. The terms “comprising,” “including” and “having” are intended to be inclusive and mean that there may be additional elements other than the listed elements.

As various changes could be made in the above compounds, products and methods without departing from the scope of the invention, it is intended that all matter contained in the above description and in the examples given below, shall be interpreted as illustrative and not in a limiting sense.

### EXAMPLES

### Example 1

### Recovery and Fractionation of Soy Whey Protein from Aqueous Soy Whey Using Novel Membrane Process

145 liters of aqueous raw soy whey (not pre-treated) with a total solids content of 3.7% and dry basis protein content of 19.8% was microfiltered using two different membranes in an OPTISEP® 7000 module, manufactured by SmartFlow Technologies. The first membrane, BTS-25, was a polysulfone construction with 0.5 um pore size manufactured by Pall. Aqueous soy whey was concentrated to a 1.6× factor, at an average flux of 30 liters/meter²/hr (LMH). The concentrated aqueous soy whey was then passed through a modified polysulfone microfiltration membrane, MPS 0.45, manufactured by Pall. The aqueous soy whey was concentrated from 1.6× to 11× at an average flux of 28 LMH.

Permeate from the microfiltration process, 132 liters total, was then introduced into an OPTISEP® 7000 module with ultrafiltration membranes, RC100, which are 100 kDa regenerated cellulose membranes manufactured by Microdyn-Nadir. The microfiltered aqueous soy whey was concentrated to about 20× using a 20 L tank setup at an average flux of 30LMH before being transferred to a 5 L tank setup in order to minimize the hold-up volume of the system. In the smaller tank, the aqueous soy whey was concentrated from 20× to 66× at an average flux rate of 9LMH, reaching a final retentate volume of 2 liters. The final retentate was 24.0% total solids, and 83.0% dry basis protein content.

128 liters of sugar and mineral enriched RC100 permeate was then introduced into an OPTISEP® 7000 module with polysulfone thin film nanofiltration membranes with a 35% NaCl rejection rate, NF20, manufactured by Sepro. The feed was concentrated 18× at an average flux rate of 4.7LMH. The retentate from this process step, 9 liters, was enriched in the various sugar species. The permeate stream from the NF20 separation process, 121 liters, contained the minerals and water.

The permeate of the NF20 process was then introduced into an OPTISEP® 3000 module with thin film reverse osmosis membranes with a 98.2% NaCl rejection rate, SG, manufactured by GE. The feed was concentrated 12× at an average flux rate of 8LMH. The permeate of the SG membrane, 9.2 liters, consisted primarily of water, suitable for re-use in a process with minimal further treatment. The retentate of the SG process, 0.8 liters, consisted predominantly of a concentrated mineral fraction.

### Example 2

### Recovery and Fractionation of Soy Whey Protein from Soy Molasses Using Novel Membrane Process

61.7 liters of soy molasses with a total solids content of 62.7% and dry basis protein content of 18.5% was diluted with 61.7 liters of water prior to microfiltration. The diluted soy molasses was then microfiltered using an OPTISEP® 7000 module, manufactured by SmartFlow Technologies. The diluted soy molasses passed through a modified polysulfone microfiltration membrane, MPS 0.45, manufactured by Pall. The diluted soy molasses was concentrated to a 1.3× factor, at an average flux of 6 liters/meter²/hr (LMH).

Permeate from the microfiltration process, 25 liters total, was then introduced into an OPTISEP® 7000 module with ultrafiltration membranes, RC100, which are 100 kDa regenerated cellulose membranes manufactured by Microdyn-Nadir. The microfiltered diluted soy molasses was diafiltered with 2 volumes of water prior to being concentrated to 7.6× at an average flux of 20LMH, reaching a final retentate volume of 2 liters. The final retentate was 17.5% total solids, and 22.0% dry basis protein content.

72 liters of sugar and mineral enriched RC100 permeate was then introduced into an OPTISEP® 7000 module with polysulfone thin film nanofiltration membranes with a 35% NaCl rejection rate, NF20, manufactured by Sepro. The feed was concentrated 3× at an average flux rate of 4.0LMH. The retentate from this process step, 23 liters, was enriched in the various sugar species. The permeate stream from the NF20 separation process, 48 liters, contained the minerals and water.

A portion of the permeate of the NF20 process, 10 liters, was then introduced into an OPTISEP® 3000 module with thin film reverse osmosis membranes with a 98.2% NaCl rejection rate, SG, manufactured by GE. The feed was concentrated 6.7× at an average flux rate of 7.9LMH. The permeate of the SG membrane, 8.5 liters, consisted primarily of water, suitable for re-use in a process with minimal further treatment. The retentate of the SG process, 1.5 liters, consisted predominantly of a concentrated mineral fraction.

### Example 3

### Capture of Bulk Soy Whey Protein from Defatted Soy Flour Extract

Defatted soy flour (DSF) was extracted by adding a 15:1 ratio of water to DSF at a pH of 7.8 and stirring for 20 minutes prior to filtration. The extract was microfiltered using an OPTISEP® 800 module, manufactured by SmartFlow Technologies. The microfiltration membrane, MMM-0.8, was a polysulfone and polyvinylpropylene construction with 0.8 um pore size manufactured by Pall. Aqueous soy extract was concentrated to a 2.0× factor, at an average flux of 29 liters/meter²/hr (LMH). Permeate from the microfiltration process was then introduced into an OPTISEP® 800 module with ultrafiltration membranes, RC100, which are 100 kDa regenerated cellulose membranes manufactured by Microdyn-Nadir. The microfiltered aqueous soy extract was concentrated to about 6.3× at an average flux rate of 50LMH. The final retentate measured 84.7% dry basis protein content.

### Example 4

### Capture of Bulk Soy Whey Protein Using Continuous Separation Technology CSEP (Simulated Moving Bed Chromatography)

CSEP experiments were performed by passing feed material (soy whey) through a column (ID 1.55 cm, length 9.5 cm, volume 18 mL) packed with SP GibcoCel resin. The column was connected to a positive displacement pump and samples of flow through and eluates were collected at the outlet of the column. Different experimental conditions were used to determine the effect of feed concentration, feed flow rate and elution flow rate on the binding capacity of the resin.

Feed Concentration

Soy whey was prepared from the defatted soy flake. Briefly, one part of defatted flake was mixed with 15 parts of water at 32° C. The pH of the solution was adjusted to 7.0 using 2 M NaOH and proteins were extracted into the aqueous phase by stirring the solution for 15 min. The protein extract was separated from the insoluble material by centrifugation at 3000×g for 10 min. The pH of the collected supernatant was adjusted to 4.5 using 1 M HCl and the solution was stirred for 15 min followed by heating to a temperature of 57° C. This treatment resulted in precipitation of the storage proteins while the whey proteins remained soluble. The precipitated proteins were separated from the whey by centrifugation at 3000×g for 10 min.

In some cases, the soy whey was concentrated using a Lab-Scale Amicon DC-10LA ultrafiltration unit and Amicon 3K membrane. Prior to ultrafiltration, pH of soy whey was adjusted to 5.5 with 2 M NaOH to avoid membrane fouling at acidic conditions. 10 L of whey was processed with the flux at ˜100 mL/min. Once the concentration factor of 5 in the retentate was reached, both retentate and permeate streams were collected. Soy whey concentrates 2.5×, 3×, and 4× were prepared by mixing a known amount of permeate and 5× whey concentrate. The pH of all soy concentrates was readjusted if necessary to 4.5.

Feed Flow Rate

During dynamic adsorption, as fluid flows through the resin bed, the proteins are adsorbed by the resin and reach equilibrium with the liquid phase. As the whey is loaded onto the column, the bound protein band extends down the column and reaches equilibrium with the liquid phase. When the resin is saturated with adsorbed proteins, the concentration of the proteins in the liquid phase exiting the column will be similar to the protein concentration in the feed. The curve describing the change in the flow through concentration compared to the feed concentration with the passage of fluid is the breakthrough curve. The concentration of protein in the solid phase increases as the breakthrough curve is developed, and the adsorption wave moves through the bed. As more fluid is passed through the bed, the flow through concentration increases asymptotically to the incoming fluid stream and at the same time a similar phenomena is achieved with the solid phase.

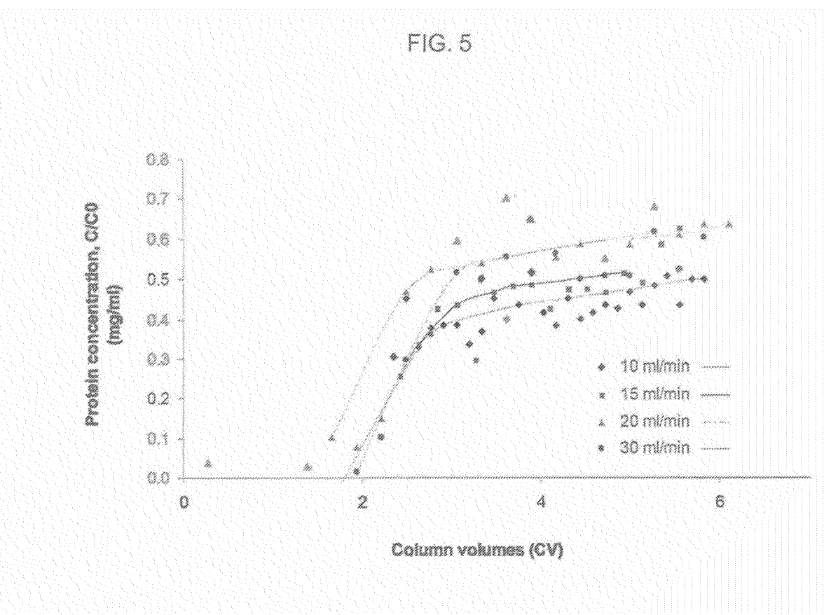

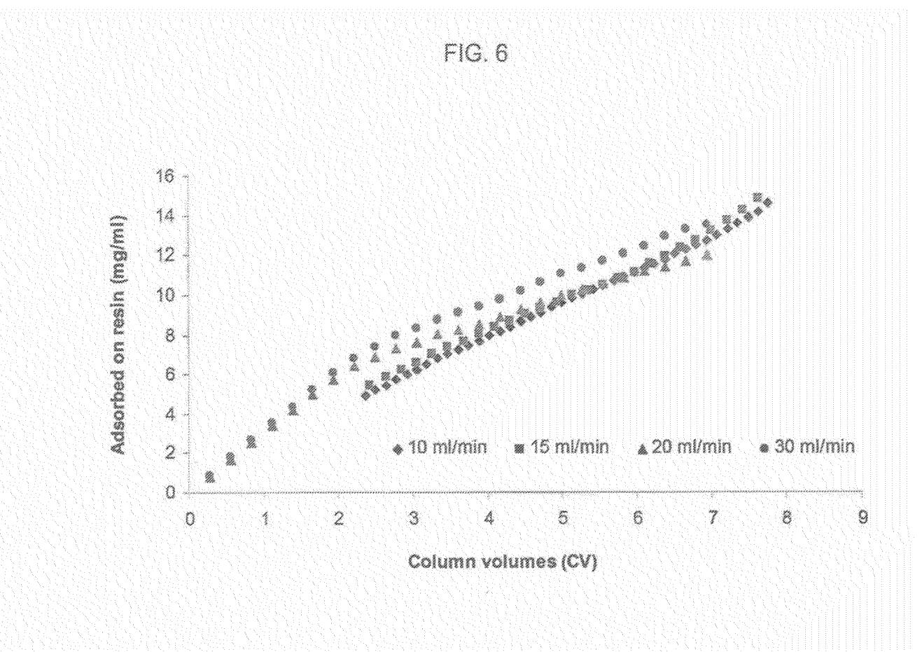

The flow through protein concentration data at three different linear velocity rates were plotted against the column volumes of soy whey loaded (see FIG. 5). These data indicated that increasing the linear flow rate of loading by a factor of 3 resulted in about 10% increase in the unabsorbed proteins in the flow through after loading 6 column volumes of soy whey. Therefore the linear flow rate does not significantly impact the adsorption characteristics of the soy whey proteins with the SP Gibco resin. The equilibrium adsorption data (see FIG. 6) showed that the soy whey protein adsorbed on the resin (calculated using mass balance of protein feed to the system and the protein concentration in the flow through, in equilibrium with the protein in the liquid stream, and plotted against the column volumes passed through the resin bed) varied little with flow rate of the feed at the fluxes tested.

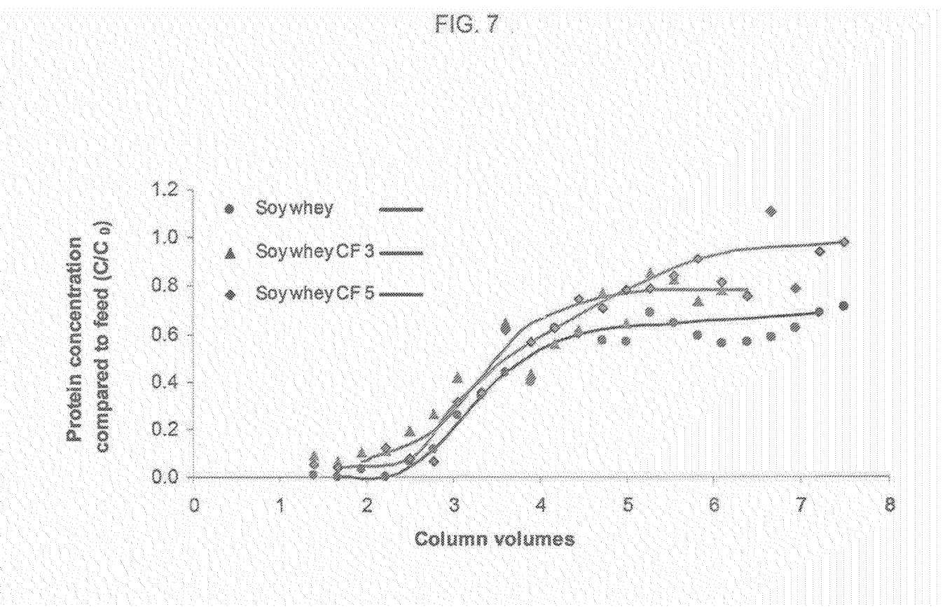

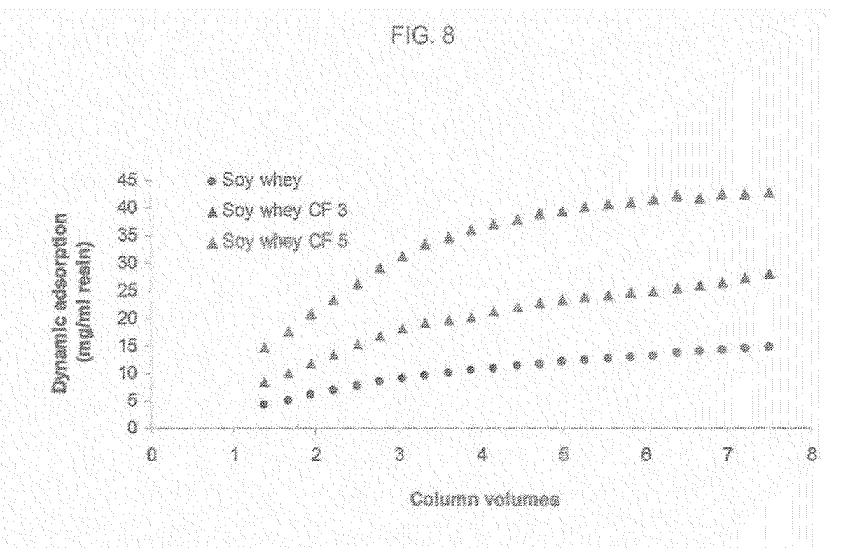

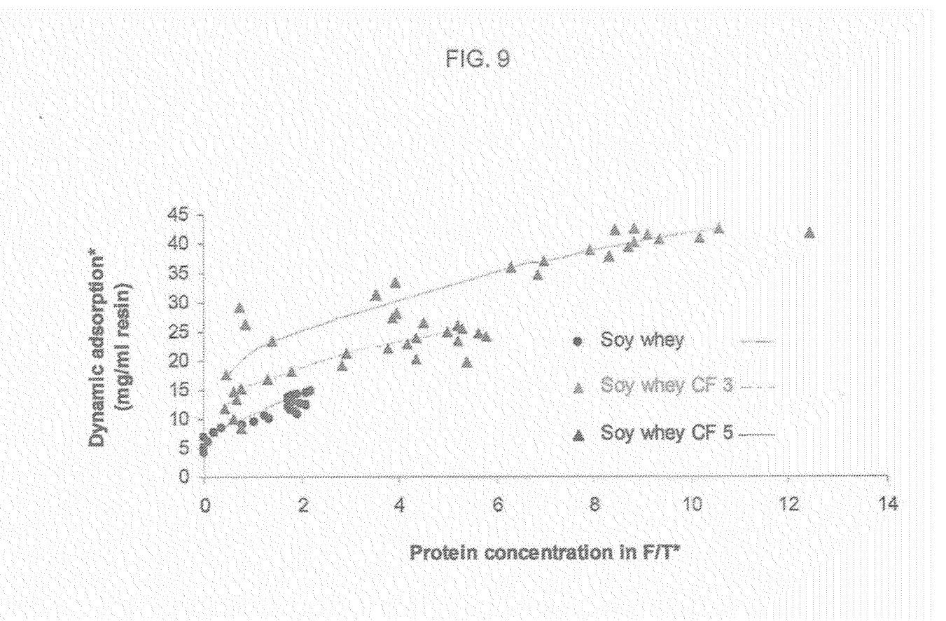

The profile of the breakthrough curve, where soy whey and soy whey concentrated by a factor of 3 and 5 was applied to an SP Gibco resin bed at 15 mL/min (8.5 cm/min linear flow rate), was similar with all three concentrations (see FIG. 7). This result indicated that as the feed protein concentration was increased the resin reached equilibrium with the protein concentration in the liquid stream by striving to reach maximum capacity. This increased adsorption is depicted in FIG. 8 where the protein concentration in the solid phase in equilibrium with the liquid phase has been plotted against the column volumes of soy whey passed through the bed. These data show that the protein adsorbed by the resin significantly increased with soy whey concentration factor, and hence the protein concentration in the soy whey (see FIG. 8). FIG. 9 shows the equilibrium characteristics of the resin and the flow through. This chart shows that as the number of column volumes were passed through the bed, the adsorption of proteins in the resin phase increased asymptotically but the protein content in the flow through also increased. Adsorption capacity can be increased by using concentrated whey and loading at high column volumes but this resulted in a relatively high protein content in the flow through. However, the high protein content in the flow through was minimized by counter current operation using a 2-stage adsorption strategy.

Based on the dynamic adsorption data (see FIG. 9), loading whey concentrated by factor >5 to achieve a protein concentration of >11 mg/mL and loading about 3.5 column volumes resulted in about 35 mg protein adsorbed per mL of resin, and the equilibrium protein concentration in the flow through was about 6.8 mg/mL. Presenting this primary flow through to another resin bed in a second pass (loading about 3.5 column volumes) resulted in a protein concentration in the flow through of about 1.3 mg/mL. Therefore, using two passes of adsorption and operating the chromatography in counter current mode resulted in adsorption of about 90% of the available soy protein that could be absorbed from soy whey at pH 4.5.

Elution Flow Rate

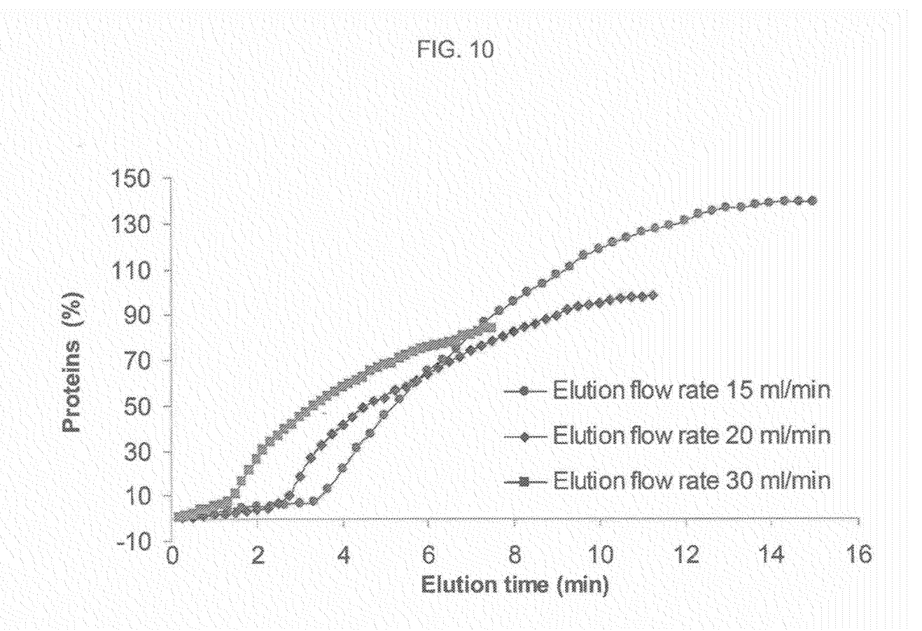

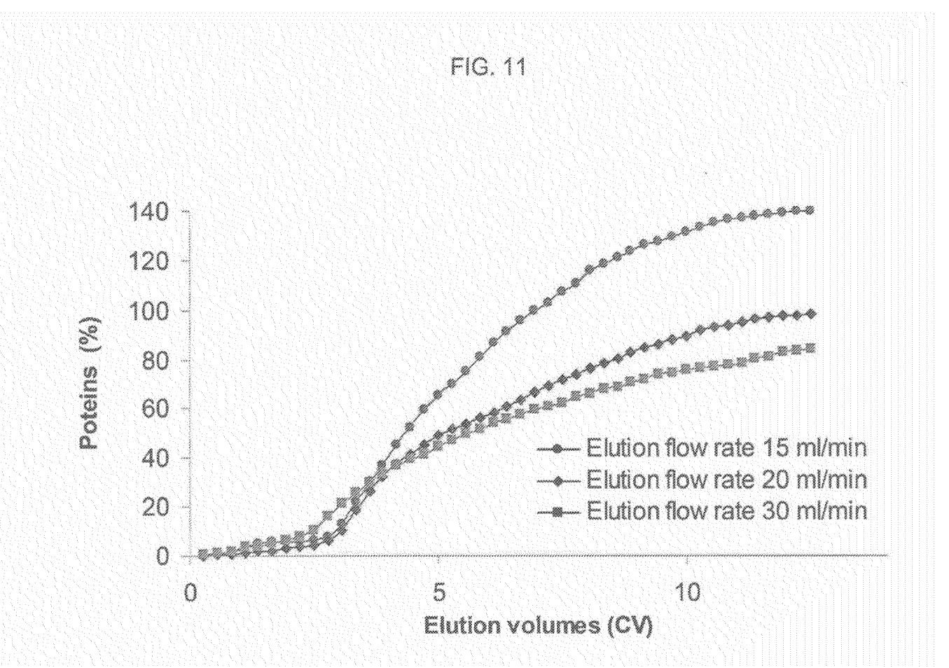

The effect of elution flow rate was investigated at three different flow rates and the recovery data are shown in Table 3. The recovery of protein at low flow rates in duplicate experiments resulted in recoveries of over 164% and 200%. The data indicate that eluting at 20 and 30 mL/min (11.3 and 17.0 cm/min, respectively) did not significantly affect the recoveries. Moreover, operating at higher flow rates achieved much faster elution (see FIG. 10), however at these higher flow rates a larger column volume of eluate was required to complete the elution (see FIG. 11). The need for a larger column volume of eluate was overcome by recycling the eluate which also reduced the total volume required for elution and also presented a more concentrated protein stream to the downstream ultrafiltration unit, reducing the membrane area needed for protein concentration.

### Table 3.

### Elution and Recovery of Bound Soy Whey Proteins at Three Different Flow Rates.

TABLE 3
Elution and recovery of bound soy whey proteins at three
different flow rates.

| | ELUTION FLOW RATES | | |
|---|---|---|---|
| | 15 mL/min | 20 mL/min | 30 mL/min |
| Protein adsorbed | 75.4 ± 4.4 | 70.8 ± 2.7 | 72.9 ± 4.8 |
| (mg) | | | |
| Protein eluted | 139.7 ± 22.9 | 73.2 ± 1.5 | 68.4 ± 6.8 |
| (mg) | | | |
| Recovery (%) | 184.2 ± 19.7 | 103.4 ± 6.1 | 93.8 ± 15.6 |

Protein adsorption was calculated as the difference in the protein content in the feed and flow through by mass balance.

Protein adsorption was calculated as the difference in the protein content in the feed and flow through by mass balance.

### Example 5

### Capture of Bulk Soy Whey Protein from a Pre-Treated Whey Process (PT)

The feed stream to the process, pre-treated whey protein, (also referred to PT whey) had approximately 1.4%-2.0% solids. It was comprised of approximately 18% minerals, 18% protein, and 74% sugars and other materials. Implementation of a Nanofiltration (NF) process allowed for water removal while retaining most of the sugars and protein, and other solid material, in the process to be recovered downstream. The NF membranes (Alfa Laval NF99 8038/48) for the trial were polyamide type thin film composite on polyester membranes with a 2 kDa molecular weight cutoff (MWCO) that allowed water, monovalent cations, and a very small amount of sugars and protein to pass through the pores. The membrane housing held 3 membrane elements. Each element was 8 inches in diameter and had 26.4 square meters of membrane surface area. The total membrane surface area for the process was 79.2 square meters. These membranes were stable up to 1 bar of pressure drop across each membrane element. For the entire module containing 3 membrane elements, a pressure drop of 3 bar was the maximum allowable. The NF feed rate of PT whey was approximately 2,500 L/hour. The temperature of this feed was approximately 45-50° C., and the temperature of the NF operation was regulated to be in this range using cooling water. Initial product flux rates were approximately 16-22 liters per meter squared per hour (LMH). The feed pressure at the inlet of the module was approximately 6 bar. Through the duration of the 6 hour run, the flux dropped as a result of fouling. The feed pressure was increased incrementally to maintain higher flux, but as fouling occurred, the pressure was increased to the maximum, and the flux slowly tapered from that point. Volumetric concentration factors were between 2× and approximately 4×.

A Precipitation step was performed to separate, e.g., phosphorous and calcium salts and complexes from the PT whey. Precipitation conditions were at pH 9 while maintaining the temperature at 45° C. with a residence time of approximately 15 minutes. The precipitation process occurred in a 1000 liter. This tank had multiple inlets and outlets where materials can be piped into and out of it. A small centrifugal pump circulated product out of the tank and back into the side of the tank to promote agitation and effective mixing of the 35% NaOH added to the system to maintain the target pH. This pump also sent product into the centrifuge when one of the T-valves connected to this recirculation loop was opened. Concentrated PT whey from the NF was fed directly into the top of the tank. 35% NaOH was connected into the feed line from the NF in order to control the pH at the target value. PT whey was fed into this mixing tank at approximately 2,500 L/hour and fed out at the same rate.

In following process step, an Alfa Laval Disc Centrifuge (Clara 80) with intermittent solids ejection system was used to separate precipitated solids (including insoluble soy fiber, insoluble soy protein) from the rest of the sugar- and protein-containing whey stream. In this process, concentrated PT whey from the precipitation tank was pumped into a disc-centrifuge where this suspension was rotated and accelerated by centrifugal force. The heavier fraction (precipitated solids) settles on the walls of the rotating centrifuge bowl with the lighter fraction (soluble liquid) was clarified through the use of disc-stacks and continuously discharged for the next step of the process. The separated precipitated solids was discharged at a regular interval (typically between 1 and 10 minutes). The clarified whey stream was less then 0.2% solids on a volumetric basis. The continuous feed flow rate was approximately 2.5 m3/hr, with a pH of 9.0 and 45° C. The insoluble fraction reached Ash=30-60%; Na=0.5-1.5% dry basis, K=1.5-3% dry basis, Ca=6-9% dry basis, Mg=3-6% dry basis, P=10-15% dry basis, Cl=1-2% dry basis, Fe, Mn, Zn, Cu<0.15% dry basis. Changes to the soluble fraction were as follows: Phytic acid was approximately 0.3% dry basis (85% reduction, P=0.2-0.3% dry basis (85-90% reduction), Ca=0.35-0.45% dry basis (80-85% reduction), Mg=0.75-0.85% dry basis (15-20% reduction).

The next step was an Ultrafiltration (UF) membrane. Protein was concentrated by being retained by a membrane while other smaller solutes pass into the permeated stream. From the centrifuge a diluted stream the containing protein, minerals and sugars was fed to the UF. The UF equipment and the membrane were supplied from Alfa Laval while the CIP chemicals came from Ecolab, Inc. The tested membrane, GR70PP/80 from Alfa-Laval, had a MWCO of 10 kD and was constructed of polyethersulfone (PES) cast onto a polypropylene polymer backing. The feed pressure varied throughout the trial from 1-7 bar, depending upon the degree of fouling of the membranes. The temperature was controlled to approximately 65° C. The system was a feed and bleed setup, where the retentate was recycled back to the feed tank while the permeate proceeded on to the next step in the process. The system was operated until a volume concentration factor of 30× was reached. The feed rate to the UF was approximately 1,600 L/hour. The setup had the ability to house 3 tubes worth of 6.3″ membrane elements. However, only one of the three tubes was used. The membrane skid had an automatic control system that allowed control of the temperature, operating pressures (inlet, outlet, and differential) and volume concentration factor during process. Once the process reached the target volume concentration factor, typically after 6-8 hours of operation, the retentate was diafiltered (DF) with one cubic meter of water, (approximately 5 parts of diafiltration water per part of concentrated retentate) to yield a high protein retentate. After a processing cycle, the system was cleaned with a typical CIP protocol used with most protein purification processes. The retentate contained about 80% dry basis protein after diafiltration.

The permeate of the UF/DF steps contained the sugars and was further concentrated in a Reverse Osmosis Membrane system (RO). The UF permeate was transferred to an RO system to concentrate the feed stream from approximately 2% total solids (TS) to 20% TS. The process equipment and membranes (RO98pHt) for the RO unit operation were supplied by Alfa-Laval. The feed pressure was increased in order to maintain a constant flux, up to 45 bar at a temperature of 50° C. Typically each batch started at a 2-3% Brix and end at 20-25% Brix (Brix=sugar concentration).

After the RO step the concentrated sugar stream was fed to an Electrodialysis Membrane (ED). Electrodialysis from Eurodia Industrie SA removes minerals from the sugar solution. The electrodialysis process has two product streams. One is the product, or diluate, stream which was further processed to concentrate and pasteurize the SOS concentrate solution. The other stream from the electrodialysis process is a brine solution which contains the minerals that were removed from the feed stream. The trial achieved >80% reduction in conductivity, resulting in a product stream that measured <3 mS/cm conductivity. The batch feed volume was approx 40 liters at a temperature of 40° C. and a pH of 7. The ED unit operated at 18V and had up to 50 cells as a stack size.

The de-mineralized sugar stream from the ED was further processed in an Evaporation step. The evaporation of the SOS stream was carried out on Anhydro's Lab E vacuum evaporator. SOS product was evaporated to 40-75% dry matter with a boiling temperature of approximately 50-55° C. and a ΔT of 5-20° C.

A Spray Dryer was used to dry UF/DF retentate suspension. The UF diafiltrate retentate, with a solids content of approximately 8%, was kept stirred in a tank. The suspension was then fed directly to the spray dryer where it was combined with heated air under pressure and then sprayed through a nozzle. The dryer removed the water from the suspension and generated a dry powder, which was collected in a bucket after it was separated from the air stream in a cyclone. The feed suspension was thermally treated at 150° C. for 9 seconds before it entered the spray dryer to kill the microbiological organisms. The spray dryer was a Production Minor from the company Niro/GEA. The dryer was set up with co-current flow and a two fluid nozzle. The drying conditions varied somewhat during the trial. Feed temperatures were about 80° C., nozzle pressure was about 4 bars, and inlet air temperatures was about 250° C.

### Example 6

### Capture of Bulk Soy Whey Protein Whey Pre-Treatment Process and Cross-Flow Filtration Membranes

Approximately 8000 lbs of aqueous soy whey (also referred to as raw whey) at 110° F. and 4.57 pH from an isolated soy protein extraction and isoelectric precipitation continuous process was fed to a reaction vessel where the pH was increased to 5.3 by the addition of 50% sodium hydroxide. The pH-adjusted raw whey was then fed to a second reaction vessel with a 10 minute average residence time in a continuous process where the temperature was increased to 190° F. by the direct injection of steam. The heated and pH-adjusted raw whey was then cooled to 90 degrees F. by passing through a plate and frame heat exchanger with chilled water as the cooling medium. The cooled raw whey was then fed into an Alfa Laval VNPX510 clarifying centrifuge where the suspended solids, predominantly insoluble large molecular weight proteins, were separated and discharged in the underflow to waste and the clarified centrate proceeded to the next reaction vessel. The pH of the clarified centrate, or pre-treated whey protein, was adjusted to 8.0 using 12.5% sodium hydroxide and held for 10 minutes prior to being fed into an Alfa Laval VNPX510 clarifying centrifuge where the suspended solids, predominantly insoluble minerals, were separated and discharged in the underflow to waste. The clarified centrate proceeded to a surge tank prior to ultrafiltration. Ultrafiltration of the clarified centrate proceeded in a feed and bleed mode at 90° F. using 3.8″ diameter polyethersulfone spiral membranes, PW3838C, made by GE Osmonics, with a 10 kDa molecular weight cut-off. Ultrafiltration continued until a 60× concentration of the initial feed volume was accomplished, which required about 4.5 hrs. The retentate, 114 lbs at 4.5% total solids and 8.2 pH, was transferred to a reaction vessel where the pH was adjusted to 7.4 using 35% hydrochloric acid. The retentate was then heated to 305° F. for 9 seconds via direct steam injection prior to flash cooling to 140° F. in a vacuum chamber. The material was then homogenized by pumping through a homogenizing valve at 6000 psi inlet and 2500 outlet pressure prior to entering the spray drier through a nozzle and orifice combination in order to atomize the solution. The spray drier was operated at 538° F. inlet temperature and 197° F. outlet temperature, and consisted of a drying chamber, cyclone and baghouse. The spray dried soy whey protein, a total of 4 lbs, was collected from the cyclone bottom discharge.

### Example 7

### Capture of Bulk Soy Whey Protein Using Expanded Bed Adsorption (EBA) Chromatography

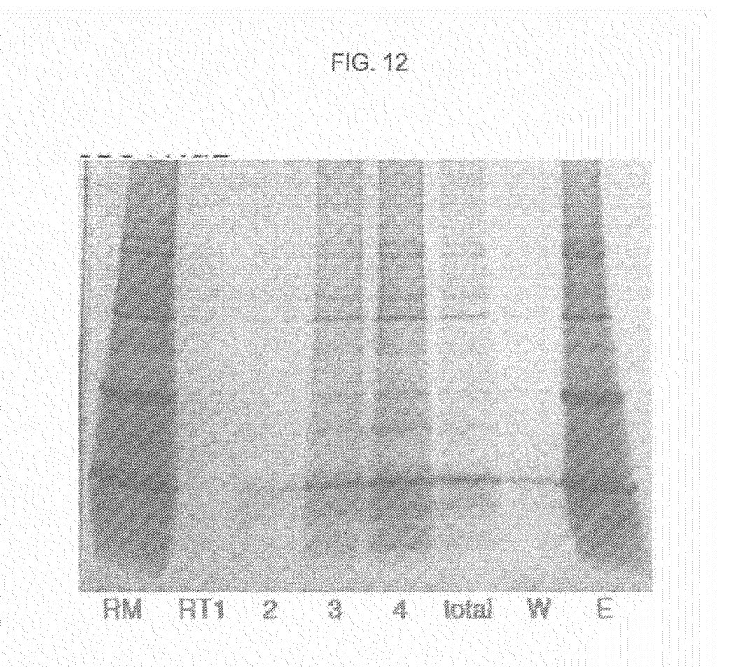

200 ml of aqueous raw soy whey (not pre-treated) with a total solids content of 1.92%, was adjusted to pH 4.5 with acetic acid and applied to a 1×25 cm column of Mimo6ME resin (UpFront Chromatography, Copenhagen Denmark) equilibrated in 10 mM sodium citrate, pH 4.5. Material was loaded onto the column from the bottom up at 20-25° C. using a linear flow rate of 7.5 cm/min. Samples of the column flow-through were collected at regular intervals for later analysis. Unbound material was washed free of the column with 10 column volumes of equilibration buffer, then bound material recovered by elution with 50 mM sodium hydroxide. 10 μls of each fraction recovered during EBA chromatography of aqueous soy whey were separated on a 4-12% SDS-PAGE gel and stained with Coomassie Brilliant Blue R 250 stain. SDS-PAGE analysis of the column load, flow-through, wash, and sodium hydroxide eluate samples is depicted in FIG. 12. As used in FIG. 12, RM: raw material (column load); RT1-4: column flow-through (run through) collected at equal intervals during the load; total: the total run-through fraction; W: column wash; E: column eluate. Binding was reasonably efficient, as very little protein is seen in the initial breakthrough fractions, only showing up in the later fractions. A total of 662 mg of protein was recovered in the eluate, for a yield of 3.3 mg/ml of starting material. Under these conditions, the capacity of this resin was shown to be 33.1 mg of protein per ml of adsorbant.

### Example 8

### Capture of Bulk Soy Whey Protein from Spray-Dried SWP Using Expanded Bed Adsorption (EBA) Chromatography

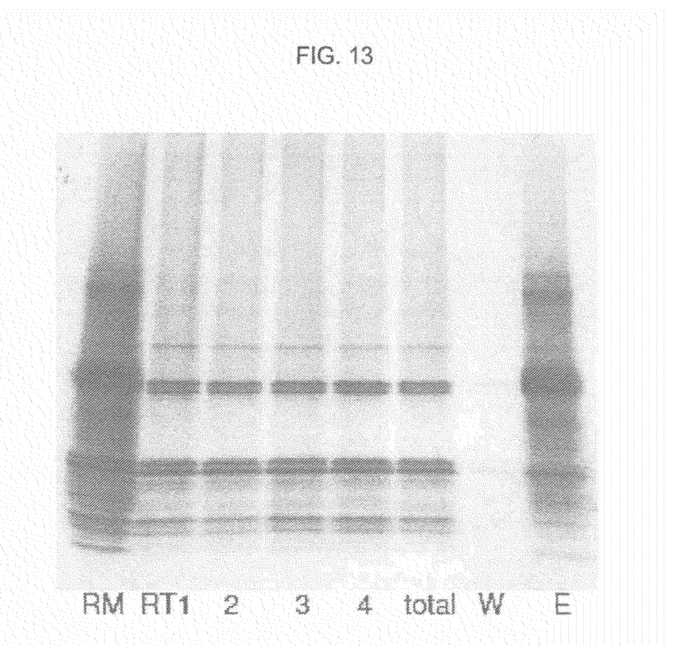

Spray-dried soy whey powder was slurried to a concentration of 10 mg/ml in water and adjusted to pH 4.0 with acetic acid. 400 ml of the slurry was then applied directly to the bottom of a 1×25 cm column of Mimo-4SE resin (UpFront Chromatography, Copenhagen Denmark) that had been equilibrated in 10 mM sodium citrate, pH 4.0. Material was loaded at 20-25° C. using a linear flow rate of 7.5 cm/min. Samples of the column flow-through were collected at regular intervals for later analysis. Unbound material was washed free of the column using 10 column volumes of equilibration buffer. Bound material was eluted with 30 mM NaOH. 10 μls of each fraction recovered during EBA chromatography of a suspension of soy whey powder were separated on a 4-12% SDS-PAGE gel and stained with Coomassie Brilliant Blue R 250 stain. SDS-PAGE analysis of the column load, flow-thru, wash, and eluate are depicted in FIG. 13. As used in FIG. 13, RM: raw material (column load); RT1-4: column flow-through (run through) collected at equal intervals during the load; total: the total run-through fraction; W: column wash; E: column eluate. Binding was not as efficient as was observed using the Mimo6ME resin, as several protein bands are seen in the breakthrough fractions. A total of 2070 mg of protein were recovered in the eluate, for a yield of 5.2 mg/ml of starting material. Under these conditions, the capacity of this resin was shown to be 104 mg of protein per ml of adsorbant.

### Example 9

### Removal of KTI from Bulk Soy Whey Protein Using Expanded Bed Adsorption (EBA) Chromatography

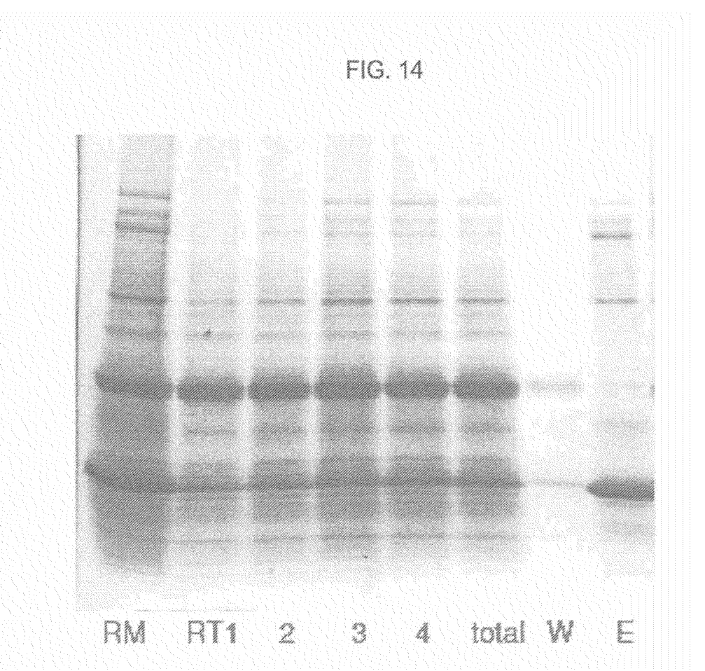

Two procedures were used to remove the majority of contaminating KTI protein from the bulk of the soy whey protein by EBA chromatography. In the first, 200 ml of aqueous raw soy whey (not pre-treated) with a total solids content of 1.92%, was adjusted to pH 6.0 with sodium hydroxide and applied to a 1×25 cm column of Mimo6HE resin (UpFront Chromatography, Copenhagen Denmark) equilibrated in 10 mM sodium citrate, pH 6.0. Material was loaded onto the column from the bottom up at 20-25° C. using a linear flow rate of 7.5 cm/min. Samples of column flow-through were collected at regular intervals for later analysis. Unbound material was washed free of the column with 10 column volumes of equilibration buffer, then bound material recovered by elution with 30 mM sodium hydroxide. 10 μls of each fraction recovered during EBA chromatography of a suspension of soy whey powder were separated on a 4-12% SDS-PAGE gel and stained with Coomassie Brilliant Blue R 250 stain. SDS-PAGE analysis of the column load, flow-through, wash, and sodium hydroxide eluate samples is depicted in FIG. 14. As used in FIG. 14, RM: raw material (column load); RT1-4: flow-through material (run through) collected at equal intervals during the load; total: the total run-through fraction; W: column wash; E: column eluate. The bulk of the loaded protein is clearly seen eluting in the flow-through, while the bulk of the KTI protein remains bound to the resin. A total of 355 mg of protein, the bulk of which is KTI, was recovered in the eluate, for a yield of 1.8 mg/ml of starting material. Under these conditions, the capacity of this resin was shown to be 17.8 mg of KTI (plus minor contaminants) per ml of adsorbant.

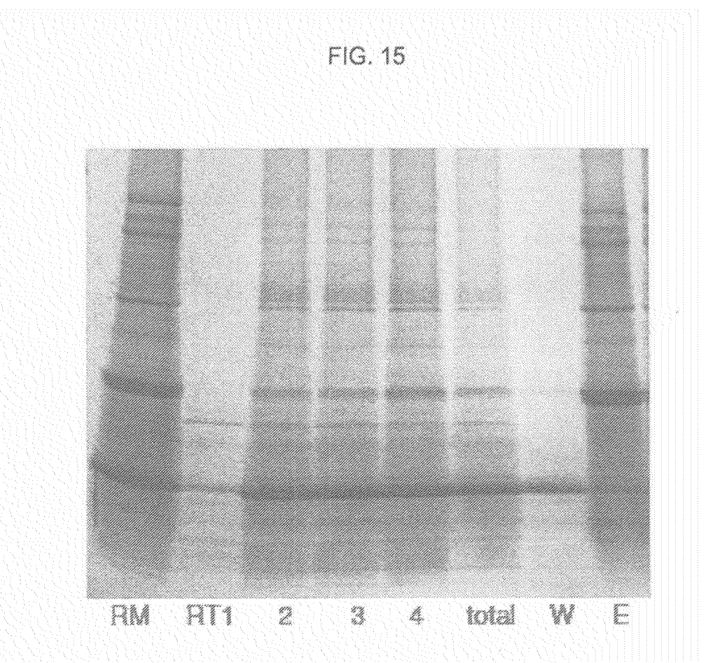

In the second procedure, 160 mls of aqueous raw soy whey (not pre-treated) with a total solids content of 1.92%, was adjusted to pH 5.1 with acetic acid and applied to a 1×25 cm column of Mimo6ZE resin (UpFront Chromatography, Copenhagen Denmark) equilibrated in10 mM sodium citrate, pH 5.0. Material was loaded onto the column from the bottom up at 20-25° C. using a linear flow rate of 7.5 cm/min. Samples of column flow-through were collected at regular intervals for later analysis. Unbound material was washed free of the column with 10 column volumes of equilibration buffer, then bound material recovered by elution with 30 mM sodium hydroxide. 10 μls of each fraction recovered during EBA chromatography of a suspension of soy whey powder were separated on a 4-12% SDS-PAGE gel and stained with Coomassie Brilliant Blue R 250 stain. SDS-PAGE analysis of the column load, flow-through, wash, and sodium hydroxide eluate samples is depicted in FIG. 15. As used in FIG. 15, RM: raw material (column load); RT1-4: flow-through material (run through) collected at equal intervals during the load; total: the total run-through fraction; W: column wash; E: column eluate. The bulk of the KTI is clearly seen eluting in the flow-through, while the bulk of the remaining protein remains bound to the resin. A total of 355 mg of soy protein essentially devoid of contaminating KTI was recovered in the eluate, for a yield of 2.1 mg/ml of starting material. Under these conditions, the capacity of this resin was shown to be 16.8 mg of soy protein per ml of adsorbant.

### Example 10

### Preparation of a Clinical Nutritional Beverage That Contains a Quantity of Soy Whey Protein

A clinical nutritional beverage product was prepared using soy whey protein recovered from a soy processing stream as described hereinabove at various replacement levels. Table 4 is the list of ingredients used to prepare a clinical nutritional beverage having 4 grams of soy whey protein and 12 grams of soy whey protein.

TABLE 4
Clinical Nutritional Beverage with soy whey protein
formulation

| | SWP 4 g | | SWP 12 g | |
|---|---|---|---|---|
| Ingredient | % | g/8 kg | % | g/8 kg |
| Water | 75.875 | 6070.00 | 75.875 | 6070.00 |
| SWP | 2.200 | 176.00 | 6.500 | 520.00 |
| Sucrose | 8.800 | 704.00 | 8.800 | 704.00 |
| Corn syrup solids | 4.480 | 358.40 | 0.180 | 14.40 |
| 25DE | | | | |
| Maltodextrin | 0.000 | 0.00 | 0.000 | 0.00 |
| 15DE | | | | |
| Maltodextrin | 4.000 | 320.00 | 4.000 | 320.00 |
| 10DE | | | | |
| Soybean oil | 0.750 | 60.00 | 0.750 | 60.00 |
| Canola Salad Oil | 0.480 | 38.40 | 0.480 | 38.40 |
| Corn oil | 0.980 | 78.40 | 0.980 | 78.40 |
| Lecithin | 0.120 | 9.60 | 0.120 | 9.60 |
| Tricalcium | 0.250 | 20.00 | 0.250 | 20.00 |
| phosphate | | | | |
| Magnesium | 0.260 | 20.80 | 0.260 | 20.80 |
| carbonate | | | | |
| Sodium citrate | 0.190 | 15.20 | 0.190 | 15.20 |
| Potassium citrate | 0.130 | 10.40 | 0.130 | 10.40 |
| Potassium | 0.160 | 12.80 | 0.160 | 12.80 |
| chloride | | | | |
| Salt | 0.030 | 2.40 | 0.030 | 2.40 |
| Resistant | 0.800 | 64.00 | 0.800 | 64.00 |
| Maltodextrin | | | | |
| Carrageenan - | 0.020 | 1.60 | 0.020 | 1.60 |
| lambda type | | | | |
| Carrageenan - | 0.035 | 2.80 | 0.035 | 2.80 |
| Iota type | | | | |
| Vitamin Premix | 0.060 | 4.80 | 0.060 | 4.80 |
| Vanilla Flavor | 0.280 | 22.40 | 0.280 | 22.40 |
| Cream Flavor | 0.100 | 8.00 | 0.100 | 8.00 |
| Total | 100.000 | 8000.000 | 100.000 | 8000.000 |

The clinical nutritional beverage samples were processed in a conventional food processing kettle, such as a stainless steel jacketed kettle equipped with air operated propeller mixer, and formed by first dry blending the carrageenans with a portion of sugar on low speed in a stainless steel mixing bowl. The formula water was heated to 60° C. and then the dry blend of carrageenans and sugars was added with high shear mixing. The citrates were then added to the pre-blend and mixed for 5 minutes until completely dispersed. The soy whey protein was then added to the blend and mixed for 15 minutes until completely dispersed. The remaining carbohydrates were added to the protein slurry and mixed well until dispersed. Following the addition of the remaining carbohydrates, the oils, lecithin and resistant maltodextrin were added and blended with the slurry for 10 minutes on low speed until dispersed. The vitamins, minerals and salts were added and mixed at low to moderate speed for 10 minutes until dispersed. Finally, flavoring ingredients were added at low to moderate speed until completely dispersed After all ingredients were completely dispersed, the pH was checked and adjusted using phosphoric acid or potassium hydroxide to ensure a pH of 7.20 or higher was achieved.

The soy whey protein-containing mixture was then pasteurized at a temperature of 141° C. with a hold time of 6 seconds. After pasteurization, the mixture was cooled to 71° C. homogenized using a 2 stage, three piston homogenizer set at 500 psi, second stage; 2500 psi, first stage. Following homogenization the mixture was cooled to 31° C. and collected in pre-sterilized bottles and refrigerated until evaluation.

The clinical nutritional beverage product that was made by the method described above had an increased amount of protein and delivered lower viscosity, while retaining the aroma and appearance of typical nutritional beverage products currently on the market.

### Example 11

### Preparation of a Yogurt-Based Beverage that Contains a Quantity of Soy Whey Protein

A yogurt-based beverage product was prepared using soy whey protein recovered from a soy processing stream as described hereinabove at various replacement levels. Table 5 is the list of ingredients used to prepare a 100% soy yogurt-based beverage having 3 grams and 10 grams of soy whey protein.

TABLE 5
Yogurt-Based Beverage with soy whey protein formulation

| | SWP 3 g | | SWP 10 g | |
|---|---|---|---|---|
| Ingredient | % | g/batch | % | g/batch |
| Water | 79.71% | 2391.30 | 78.15% | 2344.50 |
| SWP | 2.09% | 62.70 | 6.60% | 198.00 |
| Sunflower oil | 2.38% | 71.40 | 2.38% | 71.40 |
| Sugar | 7.34% | 220.20 | 7.34% | 220.20 |
| Maltodextrin, 15DE | 3.08% | 92.40 | 2.42% | 72.60 |
| Corn Syrup Solids, 25DE | 2.29% | 68.70 | | |
| Fructose | 0.99% | 29.70 | 0.99% | 29.70 |
| Inulin | 2.00% | 60.00 | 2.00% | 60.00 |
| Pectin | 0.03% | 0.90 | 0.03% | 0.90 |
| Salt | 0.09% | 2.70 | 0.09% | 2.70 |
| Total (unfruited) | 100.00% | 3000.00 | 100.00% | 3000.00 |

The yogurt-based beverage samples were formed by first dispersing the protein using moderate speed mixing into the water using a jacketed stainless steel kettle equipped with air operated propeller mixer. The slurry was then heated to a temperature of 66° C. and held for 5 minutes. A dry blend was then prepared by mixing the remaining dry ingredients and dispersing into the slurry. Mixing continued for an additional 5 minutes. Oil was then added to the slurry and mixing continued for 3 minutes

The mixture was then homogenized using a 2 stage, single piston homogenizer set at 500 psi, second stage; 2500 psi, first stage. After homogenization, the mixture was pasteurized at a temperature of 82° C. with a hold time of 3 minutes. After pasteurization, the slurry was cooled to 42° C. and inoculated with yogurt culture at 4% of the slurry to accelerate growth for timing purposes. The yogurt culture was prepared by diluting the culture 1:10 with sterile phosphate buffer. The pH of the slurry was monitored until pH reached 4.5. The mixture was slowly stirred with a propeller type mixer, such as a Kitchen-Aid or Hobart mixer, to achieve a smooth appearance of the resultant yogurt base. A seedless raspberry fruit puree was then added to the prepared yogurt base at a 1:10 ratio and the beverage was packaged in 250 ml pre-sterilized bottles. The bottles were refrigerated at <5° C. for 24 hours before evaluation.

The yogurt-based beverage product that was made by the method described above was formulated to have an increased amount of protein, while retaining the aroma and appearance of typical yogurt-based beverage products currently on the market.

### Example 12

### Preparation of Spray-Dried Infant Formula that Contains a Quantity of Soy Whey Protein

A spray-dried infant formula can be prepared according to typical industry processing techniques using soy whey protein recovered from a soy processing stream as described hereinabove. Table 6 is the list of ingredients that can be used to prepare an infant formula product comprising soy whey protein.

TABLE 6
Infant Formula Formulation

| Ingredients | % |
|---|---|
| Water | 53.00 |
| Corn syrup solids, 25DE | 22.73 |
| Soy Whey Protein | 9.70 |
| Soybean oil | 6.11 |
| Sunflower oil | 3.67 |
| Palm oil | 2.44 |
| Tricalcium phosphate | 0.99 |
| Potassium citrate | 0.30 |
| Sodium hexametaphosphate | 0.25 |
| Sodium citrate | 0.25 |
| Vitamin/mineral premix | 0.20 |
| Distilled mono-and diglycerides | 0.18 |
| Soy lecithin | 0.12 |
| Magnesium phosphate | 0.04 |
| Ascorbic acid | 0.02 |
| Total | 100.00 |

The infant formula can be prepared by first pre-blending the soybean oil, sunflower oil, and palm oil with the soy lecithin and distilled mono- and diglycerides. Heat the mixture to approximately 70° C. with continued slow mixing using a stainless steel jacketed (to allow for heating) mixing vessel equipped with a propeller-type mixer. In a second stainless steel mixing vessel, pre-blend the vitamin/mineral premix with the magnesium phosphate and tricalcium phosphate. To this second pre-blend, add approximately 2% of the water.

In a third stainless steel jacketed mixing vessel, add the remainder of the water, potassium citrate, sodium hexametaphosphate and sodium citrate. Heat the mixture to 60° C. using slow mixing until the salts are completely dispersed and dissolved. Add the soy whey protein to this mixture with slow mixing and increase the temperature to 77° C. Continue the slow mixing for 10-15 minutes. Add the corn syrup solids to the hydrated soy whey protein mixture and continue slow mixing for 5 minutes or until completely dissolved and homogenous. Add the pre-blend of vegetable oils, mono- and diglycerides, and lecithin to the mixture and continue slow mixing for 5 minutes. Add the vitamin/mineral pre-blend solution and ascorbic acid to the mixture and continue slow mixing for an additional 5 minutes. Check the pH and total solids of the slurry and adjust the pH, if necessary, to between a range of pH 7.0 and pH 7.2 using a 45% solution of potassium hydroxide or a 50% solution of citric acid. The total solids of the mixture should be within the range of 45% total solids to 50% total solids.

Homogenize the mixture using a piston-type, 2 stage homogenizer set with 500 psi pressure on the second stage and 2500 psi pressure on the first stage. Pump the homogenized slurry to a spray dryer, post-agglomeration apparatus with operating parameters set to achieve final product moisture content of between 2% moisture and 5% moisture.

The resultant spray-dried soy based infant formula will be very dispersible in water. In addition the infant formula, when formulated using a vitamin/mineral premix designed to meet the requirements for infant feeding, will provide an increased amount of protein, while retaining a carbohydrate and fat composition similar to commercially available powdered infant formulas.

### Example 13

### Preparation of a Liquid Coffee Creamer that Contains a Quantity of Soy Whey Protein

A liquid coffee creamer product was prepared using soy whey protein recovered from a soy processing stream as described hereinabove, in accordance with the process below. Table 7 is the list of ingredients used to prepare the coffee creamer and the amount used expressed in both concentration (%) and weight (grams).

TABLE 7
Liquid Coffee Creamer Formulation

| | 1 | | 2 | | 3 | | 4 | |
|---|---|---|---|---|---|---|---|---|
| | Protein Ingredient: | | | | | | | |
| | Sodium Caseinate Ref. | | SWP Test 1 | | SWP Test 2 | | SWP Test 3 | |
| | Bottles to collect | | | | | | | |
| | 10 each | 250 ml | 10 each | 250 ml | 10 each | 250 ml | 10 each | 250 ml |
| | % | grams/ | % | grams/ | % | grams/ | % | grams/ |
| Ingredient | as is | 10000 g | as is | 10000 g | as is | 10000 g | as is | 10000 g |
| Water | 77.8200 | 7782.0000 | 77.8200 | 7782.0000 | 77.8200 | 7782.0000 | 77.8200 | 7782.0000 |
| Corn Syrup Solids (CSS), 25DE | 11.0025 | 1100.2500 | 10.7625 | 1076.2500 | 10.8425 | 1084.2500 | 10.9925 | 1099.2500 |
| Partially hydrogenated Palm Oil | 9.5000 | 950.0000 | 9.5000 | 950.0000 | 9.5000 | 950.0000 | 9.5000 | 950.0000 |
| Sodium caseinate | 0.5700 | 57.0000 | 0.0000 | 0.0000 | 0.0000 | 0.0000 | 0.0000 | 0.0000 |
| SWP Test 1 | 0.0000 | 0.0000 | 0.8100 | 81.0000 | 0.0000 | 0.0000 | 0.0000 | 0.0000 |
| SWP Test 2 | 0.0000 | 0.0000 | 0.0000 | 0.0000 | 0.7300 | 73.0000 | 0.0000 | 0.0000 |
| SWP Test 3 | 0.0000 | 0.0000 | 0.0000 | 0.0000 | 0.0000 | 0.0000 | 0.5800 | 58.0000 |
| Dipotassium phosphate | 0.3500 | 35.0000 | 0.3500 | 35.0000 | 0.3500 | 35.0000 | 0.3500 | 35.0000 |
| Sodium Stearoyl-2Lactylate | 0.1500 | 15.0000 | 0.1500 | 15.0000 | 0.1500 | 15.0000 | 0.1500 | 15.0000 |
| (SSL) | | | | | | | | |
| Polysorbate 60 (PS60) | 0.1500 | 15.0000 | 0.1500 | 15.0000 | 0.1500 | 15.0000 | 0.1500 | 15.0000 |
| Natural & Artificial Flavors | 0.4575 | 45.7500 | 0.4575 | 45.7500 | 0.4575 | 45.7500 | 0.4575 | 45.7500 |
| Total | 100.0000 | 10000.0000 | 100.0000 | 10000.0000 | 100.0000 | 10000.0000 | 100.0000 | 10000.0000 |

To prepare the liquid coffee creamer product, the water and phosphates were added to a conventional food processing kettle, such as a stainless steel jacketed kettle equipped with air operated propeller mixer. The soy whey protein was added to the water and the mixture was heated to 77° C. and mixed for 6 minutes on low to moderate speed until the protein was completely dispersed. The CSS 25DE and SSL were dry blended together and added to the protein slurry. Mixing continued for 5 minutes until all components were completely dispersed.

The oil and PS60 were blended together and added to the protein slurry. Mixing continued for 5 minutes. All other ingredients were added to the slurry and mixing continued for 5 minutes.

The slurry was maintained at a minimum temperature of 60° C. but no more than 76° C. The slurry was homogenized using a three piston, 2 stage homogenizer set with 500 psi pressure on the second stage and 2500 psi pressure on the first stage and UHT at a temperature of 142° C. for a hold time of 4 to 6 seconds. The mixture was then cooled.

The cooled mixture was cold-filled into approximately 10-250 ml sterilized bottles and cooled in a refrigerator at a temperature of 4° C.

The liquid coffee creamer product that was made by the method described above was found to have an increased amount of protein, while retaining the structure, aroma and appearance of typical liquid coffee creamers currently on the market.

### Example 14

### Sensory Profiling of Liquid Coffee Creamer Comprising Soy Whey Compared to Coffee Creamer Comprising Sodium Caseinate

Seven panelists trained in the Sensory Spectrum™ Descriptive Profiling method evaluated the samples for twenty-five (25) flavor and nine (9) texture attributes. The purpose of the evaluation was to quantify the flavor characteristics of a coffee creamer product containing soy whey protein (prepared in accordance with Example 13) in coffee. The attributes were evaluated on a 15-point intensity scale, with 0 for none/not applicable and 15 for very strong/high in each sample. Definitions of the flavor attributes are given in Table 8 and definition of texture attributes are given in Table 9.

TABLE 8
Flavor Attribute Lexicon

| Attribute | Definition | References |
|---|---|---|
| | | Intensities based on Universal Scale: |
| | | Baking Soda in Saltine = 2.5 |
| | | Cooked Apple in Applesauce = 5.0 |
| | | Orange in Orange Juice = 7.5 |
| | | Concord Grape in Grape Juice = 10.0 |
| | | Cinnamon in Big Red Gum = 12.0 |

AROMATICS

| | | |
|---|---|---|
| Overall Flavor | The overall intensity of the product | |
| Impact | aromas, an amalgamation of all | |
| | perceived aromatics, basic tastes | |
| | and chemical feeling factors. | |
| Dark Roasted | The aromatic associated with dark | Dark roasted nuts, |
| | roasted nutmeat and having a very | coffee grounds |
| | browned or toasted characteristic. | |
| Sweet Aromatics | The general category of aromatics | |
| | associated with sweet foods | |
| Lactone | The sweet, tropical, nutty aromatic | Cocoa butter, imitation |
| | associated with meat or milk from | coconut flavor |
| | coconut | |
| Vanilla/vanillin | The aromatics associated with | Vanilla Extract, Vanillin |
| | vanilla, including artificial vanilla, | crystals |
| | woody, and browned notes. | |
| Caramelized | The aromatics associated with | Caramelized sugar |
| | browned sugars such as caramel. | |
| Soy/Legume | The aromatics associated with | Unsweetened SILK ™ |
| | legumes/soybeans; may include all | soymilk, canned |
| | types and different stages of | soybeans, tofu |
| | heating. | |
| Grain | The aromatics associated with the | All-purpose flour paste, |
| | total grain impact, which may | cream of wheat, whole |
| | include all types of grain and | wheat pasta |
| | different stages of heating. May | |
| | include wheat, whole wheat, oat, | |
| | rice, graham, etc. | |
| Burnt | The progression of cooking | Burnt meat, burnt |
| | attributes after Browned/Roasted/ | charcoal, burnt grains |
| | Caramelized that may or may not | (popcorn and toast) |
| | include charcoal and ash | |
| | aromatics | |
| Nutty | The aromatics associated with a | Most tree nuts: pecans, |
| | nutty/woody flavor; also a | almonds, hazelnuts, |
| | characteristic of walnuts and other | walnuts |
| | nuts. Includes hulls/skins of nuts. | |
| Milky | The slightly sour, animal, milky | Skim milk, NFDM |
| | aromatic associated with skim milk | |
| | and milk derived products. | |
| Overcooked oil | An aromatic reminiscent of oil | Heated corn oil at 240° C. |
| | overheated during processing | for 30 minutes |
| Barnyard | Aromatic characteristic of a | Old casein, white |
| | barnyard; combination of manure, | pepper, processed |
| | urine, moldy hay, feed, livestock | rotten potatoes |
| | odors. | |
| Diacetyl | The aromatic associated with | Artificial butter, movie |
| | artificial butter flavoring | theater popcorn, Hot |
| | | Buttered Popcorn Jelly |
| | | Belly |
| Dairy Fat | The slightly sweet, buttery (real) | Heavy cream |
| | aromatic associated with dairy fat. | |
| Cardboard/ | The aromatics associated with | Toothpicks, water from |
| Woody | dried wood and the aromatics | cardboard soaked for 1 |
| | associated with slightly oxidized | hour |
| | fats and oils, reminiscent of a | |
| | cardboard box. | |
| Chemical | A general term used to describe | Saccharin, Aspartame |
| | the aromatic associated with | |
| | artificial sweetener. (Does not | |
| | include basic taste sweet). | |
| Metallic | The aromatic associated with | Iron tablet, canned |
| | metals, tin or iron. | tomato juice, pennies |

BASIC TASTES

| Sweet | The taste on the tongue stimulated | Sucrose solution: | |
|---|---|---|---|
| | by sucrose and other sugars, such | 2% | 2.0 |
| | as fructose, glucose, etc., and by | 5% | 5.0 |
| | other sweet substances, such as | 10% | 10.0 |
| | saccharin, Aspartame, and | 16% | 15.0 |
| | Acesulfame-K. | | |
| Sour | The taste on the tongue stimulated | Citric acid solution: | |
| | by acid, such as citric, malic, | 0.05% | 2.0 |
| | phosphoric, etc. | 0.08% | 5.0 |
| | | 0.15% | 10.0 |
| | | 0.20% | 15.0 |
| Salt | The taste on the tongue | Sodium chloride | |
| | associated with sodium salts. | solution: | |
| | | 0.2% | 2.0 |
| | | 0.35% | 5.0 |
| | | 0.5% | 8.5 |
| | | 0.57% | 10.0 |
| | | 0.7% | 15.0 |
| Bitter | The taste on the tongue | Caffeine solution: | |
| | associated with caffeine and other | 0.05% | 2.0 |
| | bitter substances, such as quinine | 0.08% | 5.0 |
| | and hop bitters. | 0.15% | 10.0 |
| | | 0.20% | 15.0 |

CHEMICAL FEELING FACTOR

| Astringent | The shrinking or puckering of the | Alum solutions: | |
|---|---|---|---|
| | tongue surface caused by | 0.05% | 3.0 |
| | substances such as tannins or | 0.10% | 6.0 |
| | alum. | 0.20% | 9.0 |

| | | |
|---|---|---|
| Burn | A chemical feeling factor | Lemon juice, vinegar |
| | associated with high concentration | |
| | of irritants to the mucous | |
| | membranes of the oral cavity | |

TABLE 9
Texture Attribute Lexicon

| Attribute | Definition | Reference Scale | |
|---|---|---|---|
| INITIAL | | | |
| Initial Viscosity | The rate of flow per unit force | Water | 1.0 |
| | across tongue. | Plain Silk | 2.0 |
| | Not viscous/Fast - - - | Light cream | 2.2 |
| | Viscous/Slow | Heavy Cream | 3.0 |
| | | Evap. Milk | 3.9 |
| | | Maple Syrup | 6.8 |
| | | Chocolate Syrup | 9.2 |
| | | Dairy Mixture | 11.7 |
| | | Condensed Milk | 14.0 |
| Amount of | The amount of particles perceived | Miracle Whip | 0.0 |
| Particles | in the sample. | Silk | 0.0 |
| | No particles - - - Many | Sour cream + cream of wheat | 5.0 |
| | particles | Mayo + corn flour | 10.0 |
| Particle Size | The size of the particles perceived | Add each to vanilla pudding in a | |
| | in the sample (gritty, grainy, | 1:1 ratio: | |
| | lumpy, etc.) | Silk (no mixing w/ pudding) | 0.0 |
| | Very small - - - Very large | Vanilla pudding | 0.0 |
| | | Corn starch | 1.0 |
| | | My*T*Fine tapioca pudding mix | 3.5 |
| | | (dry) | |
| | | Grape Nuts | 6.5 |
| | | Uncle Ben's white rice | 9.0 |
| | | (uncooked) | |
| | | Tic Tac's | 14.0 |
| TEN | | | |
| MANIPULATIONS | | | |
| Viscosity at 10 | The rate of flow per unit force | Water | 1.0 |
| manipulations | across tongue. | Light cream | 2.2 |
| | Not viscous/Fast - - - Viscous/Slow | Plain Silk | 2.5 |
| | | Heavy Cream | 3.0 |
| | | Evap. Milk | 3.9 |
| | | Maple Syrup | 6.8 |
| | | Chocolate Syrup | 9.2 |
| | | Dairy Mixture | 11.7 |
| | | Condensed Milk | 14.0 |
| Mixes with saliva | The saliva solubility of the | JIF Peanut butter (smooth) | 5.0 |
| | product. | Mashed potatoes | 10.0 |
| | No mixing - - - Complete | Jell-O Choc. Pudding | 13.5 |
| | mixing | | |
| RESIDUAL | | | |
| Chalky | The amount of coating/film | Silk (chalky, Tacky) | 1.0 |
| Mouthcoating | remaining in the mouth after | Cooked corn starch | 3.0 |
| | expectoration associated with | Pureed potato | 8.0 |
| | chalky products such as milk of | Naked Protein Zone | 14.0 |
| | magnesia. | | |
| | None - - - A lot | | |
| Slick | The amount of coating/film | Silk (chalky, Tacky) | 1.0 |
| Mouthcoating | remaining in the mouth after | Cooked corn starch | 3.0 |
| | expectoration associated with | Pureed potato | 8.0 |
| | slick products such as over-ripe | Naked Protein Zone | 14.0 |
| | fruit. | | |
| Tacky | The amount of coating/film | Silk (chalky, Tacky) | 1.0 |
| Mouthcoating | remaining in the mouth after | Cooked corn starch | 3.0 |
| | expectoration associated with | Pureed potato | 8.0 |
| | tacky products such as | Naked Protein Zone | 14.0 |
| | marshmallow fluff. | | |
| Oily Mouthcoating | The amount of coating/film | Silk (chalky, Tacky) | 1.0 |
| | remaining in the mouth after | Cooked corn starch | 3.0 |
| | expectoration. | Pureed potato | 8.0 |
| | | Naked Protein Zone | 14.0 |

Each panelist added twenty-two (22) grams of the liquid coffee creamer into 180 mL of brewed coffee. The liquid coffee creamer was blended until homogenized. The samples were presented monadically in triplicate.

The data were analyzed using the Analysis of Variance (ANOVA) to test product and replication effects. When the ANOVA result was significant, multiple comparisons of means were performed using the Tukey's HSD t-test. All differences were significant at a 95% confidence level unless otherwise noted. For flavor attributes, mean values <1.0 indicate that not all panelists received the attribute in the sample. A value of 2.0 was considered recognition threshold for all flavor attributes, which was the minimum level that the panelist could detect and still identify the attribute.

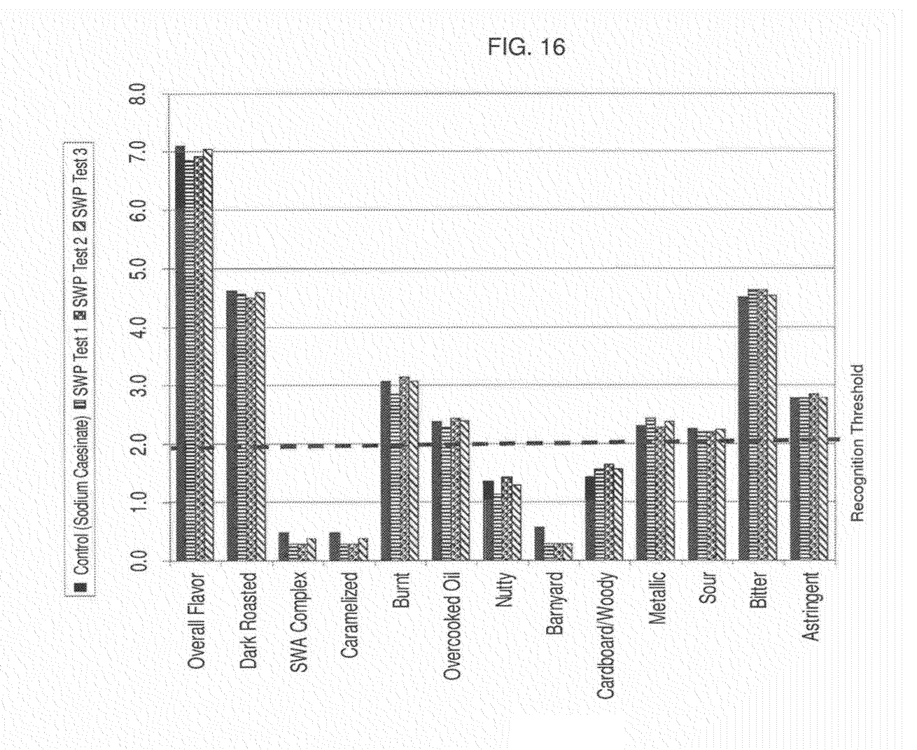

There were detectable differences between the Control (Sodium Caseinate) and the Soy Whey Protein samples, as shown in Table 10 and FIG. 16. For example, Overall Flavor Impact attributes Dark Roasted and Bitter associated within coffee creamer in coffee were stronger intensity than any other attributes associated with soy and dairy. All three soy whey protein samples were similar to each other and to the Control. The Control and Soy Whey Protein Test 3 were higher in Overall Flavor Impact compared to Soy Whey Protein Test

1. Soy Whey Protein Test 2 was higher in Burnt aromatics compared to Soy Whey Protein Test 1.

TABLE 10
Mean Scores for Flavor Attributes of Liquid Coffee Creamer
Samples Containing Soy Whey Protein in Coffee

| | | | | | |
|---|---|---|---|---|---|
| | Soy | Soy | Soy | | |
| Control | Whey | Whey | Whey | | |
| (Sodium | Protein | Protein | Protein | HSD | |
| Caseinate) | Test 1 | Test 2 | Test 3 | value | P value |

Aromatics

| | | | | | | |
|---|---|---|---|---|---|---|
| Overall Flavor | 7.1 a | 6.9 b | 6.9 ab | 7.1 a | 0.188 | *** |
| Impact | | | | | | |
| Dark Roasted | 4.6 a | 4.6 a | 4.5 a | 4.6 a | 0.189 | NS |
| SWA Complex | 0.5 a | 0.3 a | 0.3 a | 0.4 a | 0.307 | NS |
| Caramelized | 0.5 a | 0.3 a | 0.3 a | 0.4 a | 0.307 | NS |
| Vanilla/ | 0.0 a | 0.0 a | 0.0 a | 0.0 a | n/a | n/a |
| Vanillin | | | | | | |
| Lactone | 0.0 a | 0.0 a | 0.0 a | 0.0 a | n/a | n/a |
| Other SWA | 0.0 a | 0.0 a | 0.0 a | 0.0 a | n/a | n/a |
| Grain | 0.3 a | 0.3 a | 0.3 a | 0.3 a | n/a | n/a |
| Burnt | 3.1 ab | 2.9 b | 3.1 a | 3.1 ab | 0.218 | *** |
| Soy/Legume | 0.0 a | 0.0 a | 0.0 a | 0.0 a | n/a | n/a |
| Overcooked | 2.4 a | 2.3 a | 2.4 a | 2.4 a | 0.192 | NS |
| oil | | | | | | |
| Nutty | 1.4 a | 1.1 a | 1.4 a | 1.3 a | 0.359 | NS |
| Milky | 0.0 a | 0.0 a | 0.0 a | 0.0 a | n/a | n/a |
| Barnyard | 0.6 a | 0.3 a | 0.3 a | 0.3 a | 0.534 | NS |
| Diacetyl | 0.0 a | 0.0 a | 0.0 a | 0.0 a | n/a | n/a |
| Fishy | 0.0 a | 0.0 a | 0.0 a | 0.0 a | n/a | n/a |
| Cardboard/ | 1.4 a | 1.6 a | 1.6 a | 1.6 a | 0.414 | NS |
| Woody | | | | | | |
| Metallic | 2.3 a | 2.4 a | 2.3 a | 2.4 a | 0.172 | NS |
| Chemical | 0.0 a | 0.0 a | 0.0 a | 0.0 a | n/a | n/a |
| Other: Ashy | 0.0 a | 0.0 a | 0.0 a | 0.0 a | n/a | n/a |

Basic Tastes & Feeling Factors

| | | | | | | |
|---|---|---|---|---|---|---|
| Sweet | 0.3 a | 0.3 a | 0.3 a | 0.3 a | n/a | n/a |
| Sour | 2.3 a | 2.2 a | 2.2 a | 2.2 a | 0.077 | NS |
| Salt | 0.3 a | 0.3 a | 0.3 a | 0.3 a | n/a | n/a |
| Bitter | 4.5 a | 4.6 a | 4.6 a | 4.6 a | 0.287 | NS |
| Astringent | 2.8 a | 2.8 a | 2.9 a | 2.8 a | 0.134 | NS |
| Burn | 0.0 a | 0.0 a | 0.0 a | 0.0 a | n/a | n/a |

Texture & Mouthfeel

| | | | | | | |
|---|---|---|---|---|---|---|
| Initial | 1.66 a | 1.66 a | 1.66 a | 1.66 a | 0.000 | NS |
| viscosity | | | | | | |
| Particle | 0.0 a | 0.0 a | 0.0 a | 0.0 a | n/a | n/a |
| Amount | | | | | | |
| Particle | 0.0 a | 0.0 a | 0.0 a | 0.0 a | n/a | n/a |
| size | | | | | | |
| 10 Viscosity | 1.81 a | 1.81 a | 1.81 a | 1.81 a | 0.000 | NS |
| Mixes with | 14.0 a | 14.0 a | 14.0 a | 14.0 a | n/a | n/a |
| Saliva | | | | | | |
| Chalky | 0.4 a | 0.4 a | 0.4 a | 0.4 a | n/a | n/a |
| Mouthcoating | | | | | | |
| Slick | 0.0 a | 0.0 a | 0.0 a | 0.0 a | n/a | n/a |
| Mouthcoating | | | | | | |
| Tacky | 0.0 a | 0.0 a | 0.0 a | 0.0 a | n/a | n/a |
| Mouthcoating | | | | | | |
| Oily | 1.6 a | 1.5 a | 1.5 a | 1.6 a | 0.169 | NS |
| Mouthcoating | | | | | | |

1Means in the same row followed by the same letter are no significantly different at 95% Confidence.
***—99% Confidence,
**—95% Confidence,
*—90% Confidence,
NS—Not Significant
The attributes above threshold are bold.
The attributes significant at 90% Confidence are italicized.
For other attributes, % score is the percentage of times the attribute was perceived, and the score is reported as an average value of the detectors.

This data illustrates that a coffee creamer product which includes an amount of soy whey protein in lieu of dairy or other dairy substitute, may be an acceptable replacement coffee creamer based on similar taste and texture, while additionally including a higher amount of protein than regular non-dairy coffee creamers.

### Example 15

### Preparation of a Spray-Dried Coffee Creamer Containing a Quantity of Soy Whey Protein

A spray-dried non-dairy coffee creamer was prepared using soy whey protein recovered from a soy processing stream as described in the present invention, according to typical industry processing techniques using the step-by-step process described below. Table 11 is the list of ingredients used to prepare the coffee creamer composition (control and soy whey protein replacement) and the amounts used are expressed in concentration (%) and weight (g).

TABLE 11
Spray-Dried Coffee Creamer Formulation

| | | | Soy Whey Protein | |
|---|---|---|---|---|
| | | | 100% replacement | |
| | | | as is | |
| Formulation | Soy Caseinate | | 30% | grams/ |
| Ingredient | Control | | TS | 45 kg |
| Water | 70.00 | 31500.00 | 70.00 | 31500.00 |
| Corn Syrup Solids, 25DE | 18.75 | 8436.38 | 18.79 | 8457.08 |
| Sodium caseinate | 0.61 | 274.50 | 0.00 | 0.00 |
| Soy Whey Protein, | 0.00 | 0.00 | 0.57 | 256.50 |
| Dipotassium phosphate | 0.43 | 193.50 | 0.43 | 191.70 |
| Tripotassium phosphate | 0.29 | 130.50 | 0.29 | 129.60 |
| Coconut oil | 8.10 | 3645.00 | 7.74 | 3483.00 |
| Coconut oil | 1.47 | 661.50 | 1.41 | 634.50 |
| Distilled mono-diglycerides | 0.24 | 108.00 | 0.00 | 0.00 |
| DATEM (diacetyl tartaric acid | 0.00 | 0.00 | 0.66 | 297.00 |
| ester of monoglyceride) | | | | |
| SSL (sodium stearoyl-2- | 0.09 | 40.50 | 0.09 | 40.50 |
| lactylate) | | | | |
| Soy Masking Flavor | 0.01 | 3.38 | 0.01 | 3.38 |
| Condensed Milk Flavor | 0.02 | 6.75 | 0.02 | 6.75 |
| TOTAL | 100.00 | 45000.00 | 100.00 | 45000.00 |

To prepare the spray-dried coffee creamer, all phosphates were added to water and heated to 60° C. until dispersed. The soy whey protein was added to water and dispersed with moderate shear. After the protein was completely dispersed, mixing speed was reduced and the temperature was increased to 75° C. Mixing continued for 10 minutes.

Sodium stearoyl-2-lactylate (SSL) was pre-blended with CSS and the blend was added to the protein slurry. Mixing continued for 5 minutes. Dimodan and/or DATEM was blended with vegetable oil and added to the slurry. Mixing continued for 3 minutes. The pH of the slurry was checked and adjusted to between about 7.2 and 7.6 using 45% KOH.

The slurry was homogenized using a piston-type, 2 stage homogenizer set with 500 psi pressure on the second stage and 3000 psi pressure on the first stage. The homogenized mixture was then fed to a spray dryer having a feed pressure of 4000 psi. The slurry was spray dried at 288° C. to 310° C. inlet and 87.8° C. to 98.9° C. outlet temperature using spray systems nozzle 30/2.

The final moisture of the spray dried coffee creamer was between 1% and 2%. 10-12 pounds of dry material was collected, labeled and stored in a walk-in cooler.

Table 12 sets forth some of the characteristics of the creamer sample prepared with soy whey protein compared to the control sample prepared with sodium caseinate, in addition to containing a higher amount of protein. As illustrated in Table 12, the sample prepared with soy whey protein had the same appearance as the creamer prepared with sodium caseinate, but did not oil off like the control did.

TABLE 12
Characteristics of Spray-Dried Coffee Creamer Prepared With Soy
Whey Protein

| | Na Cas | Soy Whey |
|---|---|---|
| Color, L-value | 29.74 | 30.48 |
| | 30.91 | 30.55 |
| Color, a-value | 8.41 | 8.10 |
| | 8.26 | 8.04 |
| Color, b-value | 13.99 | 13.90 |
| | 14.24 | 13.82 |
| Oiling off | slight | none |
| | slight | none |
| Feathering | none | none |
| | none | none |
| pH | 5.74 | 5.75 |

### Example 16

### Preparation of an Apple Flavored RTD-A Beverage Containing a Quantity of Soy Whey Protein

An apple flavored RTD-A beverage product was prepared using soy whey protein recovered from a soy processing stream as described hereinabove, in accordance with the process below. Table 13 is the list of ingredients used to prepare the apple flavored RTD-A beverage product with varying amounts of soy whey protein. The amounts are expressed in both concentration (%) and weight (grams).

TABLE 13
Apple Flavored RTD-A Beverage Formulation

| | Control | | | | | | | | | |
|---|---|---|---|---|---|---|---|---|---|---|
| RTD-A Apple | (100% WPI) | | SWP Test 1 | | SWP Test 2 | | SWP Test 3 | | SWP Test 4 | |
| Flavor | % | Gms | % | Gms | % | Gms | % | Gms | % | Gms |
| Water | 95.0510 | 11406.12 | 87.6795 | 10521.54 | 80.9475 | 9713.70 | 81.4460 | 9773.52 | 83.3760 | 10005.12 |
| PolyDextrose | 1.68000 | 201.60 | 1.68000 | 201.60 | 1.68000 | 201.60 | 1.68000 | 201.60 | 1.68000 | 201.60 |
| Sugar | 1.15000 | 138.00 | 1.15000 | 138.00 | 1.15000 | 138.00 | 1.15000 | 138.00 | 1.15000 | 138.00 |
| WPI | 1.15000 | 138.00 | 0.00000 | 0.00 | 0.00000 | 0.00 | 0.00000 | 0.00 | 0.00000 | 0.00 |
| SWP Test 1 | 0.00000 | 0.00 | 8.580 | 1029.60 | 0.00000 | 0.00 | 0.00000 | 0.00 | 0.00000 | 0.00 |
| SWP Test 2 | 0.00000 | 0.00 | 0.00000 | 0.00 | 15.020 | 1802.40 | 0.00000 | 0.00 | 0.00000 | 0.00 |
| SWP Test 3 | 0.00000 | 0.00 | 0.00000 | 0.00 | 0.00000 | 0.00 | 14.890 | 1786.80 | 0.00000 | 0.00 |
| SWP Test 4 | 0.00000 | 0.00 | 0.00000 | 0.00 | 0.00000 | 0.00 | 0.00000 | 0.00 | 12.960 | 1555.20 |
| Malic/Citric Acid | 0.41700 | 50.04 | 0.56700 | 68.04 | 0.83400 | 100.08 | 0.51700 | 62.04 | 0.51700 | 62.04 |
| Blend | | | | | | | | | | |
| Apple Flavor | 0.25000 | 30.00 | 0.25000 | 30.00 | 0.25000 | 30.00 | 0.25000 | 30.00 | 0.2500 | 30.00 |
| Phosphoric Acid | 0.08350 | 10.02 | 0.07500 | 9.00 | 0.10000 | 12.00 | 0.04850 | 5.82 | 0.04850 | 5.82 |
| Calcium | 0.10000 | 12.00 | 0.00000 | 0.00 | 0.00000 | 0.00 | 0.00000 | 0.00 | 0.00000 | 0.00 |
| Gluconate | | | | | | | | | | |
| Calcium Lactate | 0.10000 | 12.00 | 0.00000 | 0.00 | 0.00000 | 0.00 | 0.00000 | 0.00 | 0.00000 | 0.00 |
| Vitamin and | 0.00250 | 0.30 | 0.00250 | 0.30 | 0.00250 | 0.30 | 0.00250 | 0.30 | 0.00250 | 0.30 |
| Mineral Premix | | | | | | | | | | |
| Colorant | 0.00100 | 0.12 | 0.00100 | 0.12 | 0.00100 | 0.12 | 0.00100 | 0.12 | 0.00100 | 0.12 |
| Sucralose | 0.00500 | 0.60 | 0.00500 | 0.60 | 0.00500 | 0.60 | 0.00500 | 0.60 | 0.00500 | 0.60 |
| Acesulfame K | 0.01000 | 1.20 | 0.01000 | 1.20 | 0.01000 | 1.20 | 0.01000 | 1.20 | 0.01000 | 1.20 |
| | 100.000 | 12000.00 | 100.000 | 12000.00 | 100.000 | 12000.00 | 100.000 | 12000.00 | 100.000 | 12000.00 |

To prepare the apple flavored RTD-A beverage, the formula water was weighed, heated to approximately 25° C. and transferred to a conventional food processing kettle such as a stainless steel jacketed kettle equipped with air operated propeller mixer.

The soy whey protein was blended 1:1 with the sugar and then added to the water. The protein was mixed in the water with good shear to fully disperse the protein and form a protein slurry. All remaining ingredients were added to the protein slurry and mixing continued for approximately 10 minutes. The pH of the combined mixture was checked and first adjusted to a pH of 3.6 (+/−0.05) using a 50% solution of a 75:25 blend of Malic:Citric acid solution. The pH was again checked and further adjusted to a pH of 3.0-3.1 using an 85% phosphoric acid solution.

The mixture was homogenized using a piston-type, 2 stage homogenizer set with 500 psi pressure on the second stage and 2500 psi pressure on the first stage. The homogenized mixture was returned to the batch kettle. The mixture was then pasteurized at a temperature of 85° C. for 15 seconds.

The samples were heated to approximately 85° C. and filled into bottles suited for hot filling. The filled bottles were arranged on their sides and held in that position for approximately 3 minutes, rotating once at 1.5 minutes. The bottles were then cooled to room temperature in an ice bath and were refrigerated until evaluation.

The apple flavored RTD-A beverage made by the method described above was found to have an increased amount of protein, lowered viscosity and improved clarity, while retaining the aroma and appearance of typical flavored RTD-A products currently on the market.

### Example 17

### Profiling of an Apple Flavored RTD-A Beverage Containing a Quantity of Soy Whey Protein

Sensory descriptive analysis was conducted on apple flavored RTD-A Beverage prepared in accordance with Example 16 over a 6 week shelf life, testing at Time 0 and 6 Weeks (stored at 25° C.) to understand the attribute differences of Whey Protein Isolate and Soy Whey Protein in an apple flavored RTD-A Beverage. At Time 0 there were eight panelists and at 6 Weeks there were seven panelists trained in the Sensory Spectrum™ Descriptive Profiling method evaluated the samples for eighteen (18) flavor, eight (8) texture attributes, and five (5) aftertaste attributes. The attributes were evaluated on a 15-point scale, with 0=none/not applicable and 15=very strong/high in each sample. Definitions of the flavor attributes are given in Table 14 and definitions of the texture attributes are given above in Table 9.

TABLE 14
Flavor Attribute Lexicon

| Attribute | Definition | References |
|---|---|---|
| | | Intensities based on Universal |
| | | Scale: |
| | | Baking Soda in Saltine = 2.5 |
| | | Cooked Apple in Applesauce = 5.0 |
| | | Orange in Orange Juice = 7.5 |
| | | Concord Grape in Grape Juice = |
| | | 10.0 |
| | | Cinnamon in Big Red Gum = 12.0 |

AROMATICS

| | | |
|---|---|---|
| Overall Flavor | The overall intensity of the product | |
| Impact | aromas, an amalgamation of all | |
| | perceived aromatics, basic tastes | |
| | and chemical feeling factors. | |
| Apple Complex | The general category used to | Dark roasted nuts, |
| | describe the total apple flavor | coffee grounds |
| | impact of the product. | |
| Raw Apple | The green-viney, peely, uncooked | Freshly harvested ripe |
| | pomme aromatics associated with | apples |
| | uncooked apple. | |
| Artificial Apple | The slight painty, metallic, and | Apple Jolly Rancher |
| | pomme aromatics associated with | |
| | artificial apple. | |
| Apple, Cooked | Flat, slightly sour aroma and taste | Mott's Natural |
| | of cooked apples | applesauce |
| Soy/Legume | The aromatics associated with | Unsweetened SILK ™ |
| | legumes/soybeans; may include | soymilk, canned |
| | all types and different stages of | soybeans, tofu |
| | heating. | |
| Cardboard/ | The aromatics associated with | Toothpicks, water from |
| Woody | dried wood and the aromatics | cardboard soaked for 1 |
| | associated with slightly oxidized | hour |
| | fats and oils, reminiscent of a | |
| | cardboard box. | |
| Metallic | The aromatic associated with | Iron tablet, canned |
| | metals, tin or iron | tomato juice, pennies |
| Mineral | The aromatic associated with | Calcium pills |
| | minerals such as calcium, | |
| | magnesium and iron | |
| Vitamin | The aroma associated with B- | PolyVi Vitamins |
| | vitamins | |
| Chemical | A general term used to describe | Saccharin, Aspartame |
| | the aromatic associated with | |
| | artificial sweetener. (Does not | |
| | include basic taste sweet). | |
| Overripe/Browned | The aromatic associated with | Banana baby food |
| Fruit | overripe, browning fruit, slight | |
| | decomposition | |

BASIC TASTES

| Sweet | The taste on the tongue | Sucrose solution: | |
|---|---|---|---|
| | stimulated by sucrose and other | 2% | 2.0 |
| | sugars, such as fructose, glucose, | 5% | 5.0 |
| | etc., and by other sweet | 10% | 10.0 |
| | substances, such as saccharin, | 16% | 15.0 |
| | Aspartame, and Acesulfame-K. | | |
| Sour | The taste on the tongue | Citric acid solution: | |
| | stimulated by acid, such as citric, | 0.05% | 2.0 |
| | malic, phosphoric, etc. | 0.08% | 5.0 |
| | | 0.15% | 10.0 |
| | | 0.20% | 15.0 |
| Salt | The taste on the tongue | Sodium chloride | |
| | associated with sodium salts. | solution: | |
| | | 0.2% | 2.0 |
| | | 0.35% | 5.0 |
| | | 0.5% | 8.5 |
| | | 0.57% | 10.0 |
| | | 0.7% | 15.0 |
| Bitter | The taste on the tongue | Caffeine solution: | |
| | associated with caffeine and other | 0.05% | 2.0 |
| | bitter substances, such as quinine | 0.08% | 5.0 |
| | and hop bitters. | 0.15% | 10.0 |
| | | 0.20% | 15.0 |

CHEMICAL FEELING FACTOR

| Astringent | The shrinking or puckering of the | Alum solutions: | |
|---|---|---|---|
| | tongue surface caused by | 0.05% | 3.0 |
| | substances such as tannins or | 0.10% | 6.0 |
| | alum. | 0.20% | 9.0 |

| | | |
|---|---|---|
| Burn | A chemical feeling factor | Lemon juice, vinegar |
| | associated with high concentration | |
| | of irritants to the mucous | |
| | membranes of the oral cavity | |

The samples were shaken then approximately and then each panelist received 2 ounces of beverage in 3 ounce cups with lids. The samples were presented monadically in duplicate.

The data were analyzed using the Analysis of Variance (ANOVA) to test product and replication effects. When the ANOVA result was significant, multiple comparisons of means were performed using the Tukey's HSD t-test. All differences were significant at a 95% confidence level unless otherwise noted. For flavor attributes, mean values <1.0 indicate that not all panelists perceived the attribute in the sample. A value of 2.0 was considered recognition threshold for all flavor attributes, which was the minimum level that the panelist could detect and still identify the attribute.

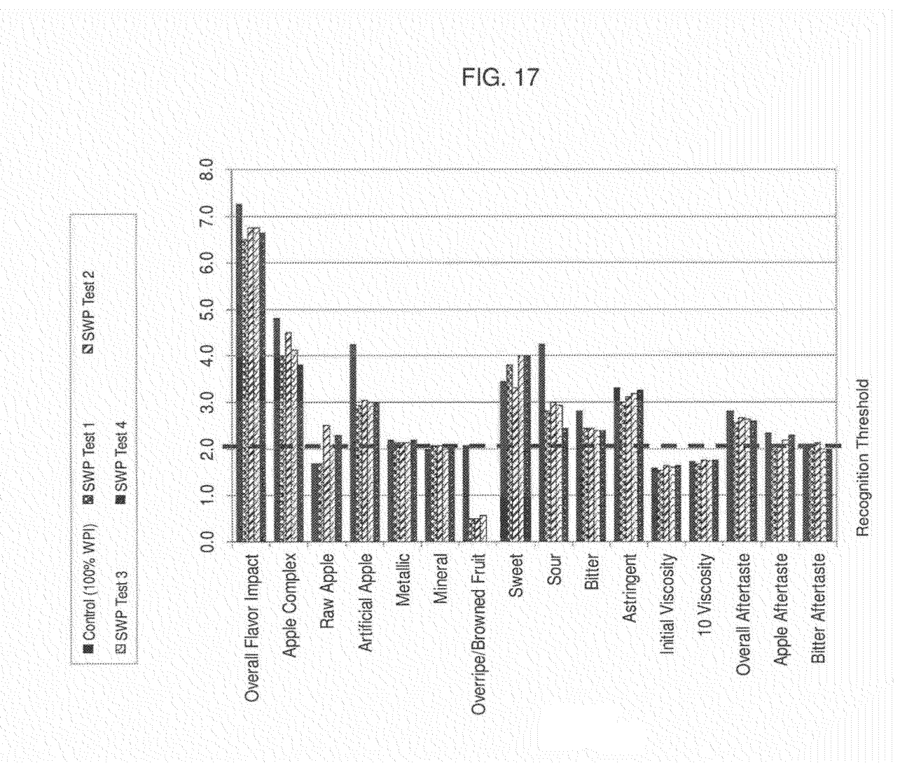

There were detectable differences between the Whey Protein Isolate (control) and Soy Whey Protein apple flavored RTD-A Beverage at Time 0, shown in Table 15. FIG. 17 illustrates that at Time 0, the control (100% WPI) beverage was higher in Overall Flavor Impact, Artificial Apple aromatics, Overripe/Browned Fruit aromatics, Sour basic taste, and Bitter basic taste compared to the all Soy Whey Protein beverage. At Time 0, the control beverage was also higher in Vitamin aromatics, Astringency, and Overall Aftertaste as well as lower in Raw Apple and Cooked Apple aromatics.

At Time 0, Soy Whey Protein Test 1 was lower in Raw Apple aromatics, Initial Viscosity, 10 Viscosity, Apple aftertaste, and higher in Sweet basic taste.

At Time 0, Soy Whey Protein Test 2 was higher in Raw Apple aromatics.

At Time 0, Soy Whey Protein Test 3 was higher in Sweet basic taste.

At Time 0, Soy Whey Protein Test 4 was higher in Sweet basic taste, Astringent, and Initial Viscosity.

All the samples did not have any Soy/Legume aromatics or were below the recognition threshold (2.0), which most consumers would be able to detect these attributes in the samples. All the Soy Whey Protein samples were similar to each other.

TABLE 15
Flavor, Texture, and Aftertaste Attributes for the Apple Flavored
RTD-A Beverage at Time 0

| | Control | | Soy Whey | | Soy Whey | | Soy Whey | | Soy Whey | | |
|---|---|---|---|---|---|---|---|---|---|---|---|
| | (100% WPI) | | Protein Test 1 | | Protein Test 2 | | Protein Test 3 | | Protein Test 4 | | p value |
| Aromatics | | | | | | | | | | | |
| Overall Flavor | 7.3 | a | 6.5 | b | 6.8 | b | 6.8 | b | 6.6 | b | *** |
| Impact | | | | | | | | | | | |
| Apple Complex | 4.8 | a | 4.0 | b | 4.5 | a | 4.1 | b | 3.8 | b | *** |
| Raw Apple | 1.7 | b | 1.7 | b | 2.5 | a | 2.1 | ab | 2.3 | ab | *** |
| Artifical Apple | 4.3 | a | 2.9 | b | 3.1 | b | 3.0 | b | 3.0 | b | *** |
| Cooked Apple | 0.0 | b | 0.5 | a | 0.8 | a | 0.5 | a | 0.8 | a | *** |
| Soy/Legume | 0.0 | a | 0.3 | a | 0.0 | a | 0.0 | a | 0.0 | a | * |
| Cardboard/Woody | 0.0 | | 0.0 | | 0.0 | | 0.0 | | 0.0 | | n/a |
| Metallic | 2.2 | a | 2.1 | a | 2.1 | a | 2.1 | a | 2.2 | a | NS |
| Mineral | 2.0 | a | 2.1 | a | 2.1 | a | 2.0 | a | 2.1 | a | * |
| Vitamin | 1.3 | a | 1.0 | b | 1.1 | ab | 1.0 | b | 1.0 | b | ** |
| Chemical | 2.6 | a | 2.7 | a | 2.6 | a | 2.6 | a | 2.5 | a | NS |
| Overripe/Browned | 2.1 | a | 0.5 | b | 0.5 | b | 0.6 | b | 0.0 | c | *** |
| Fruit | | | | | | | | | | | |
| Other: Barnyard | 2.5 | (13%) | 0.0 | | 0.0 | | 0.0 | | 0.0 | | |
| Basic Tastes & | | | | | | | | | | | |
| Feeling Factors | | | | | | | | | | | |
| Sweet | 3.4 | b | 3.8 | a | 3.3 | b | 4.0 | a | 4.0 | a | *** |
| Sour | 4.3 | a | 2.8 | b | 3.0 | b | 2.9 | b | 2.4 | c | *** |
| Salt | 1.1 | a | 1.0 | a | 1.0 | a | 1.0 | a | 1.0 | a | NS |
| Bitter | 2.8 | a | 2.4 | b | 2.4 | b | 2.4 | b | 2.4 | b | *** |
| Astringent | 3.3 | a | 3.0 | b | 3.1 | ab | 3.2 | ab | 3.3 | a | *** |
| Burn | 0.0 | | 0.0 | | 0.0 | | 0.0 | | 0.0 | | n/a |
| Other FF: Puckering | 2.0 | (13%) | 0.0 | | 0.0 | | 0.0 | | 0.0 | | |
| Texture & Mouthfeel | | | | | | | | | | | |
| Initial Viscosity | 1.59 | b | 1.54 | c | 1.63 | ab | 1.61 | ab | 1.64 | a | *** |
| Particle Amount | 0.0 | | 0.0 | | 0.0 | | 0.0 | | 0.0 | | n/a |
| Particle Size | 0.0 | | 0.0 | | 0.0 | | 0.0 | | 0.0 | | n/a |
| 10 Viscosity | 1.73 | a | 1.68 | b | 1.75 | a | 1.74 | a | 1.76 | a | *** |
| Mixes With Saliva | 14.0 | a | 14.0 | a | 14.0 | a | 14.0 | a | 14.0 | a | n/a |
| Chalky Mouthcoating | 0.3 | a | 0.4 | a | 0.4 | a | 0.4 | a | 0.4 | a | * |
| Slick Mouthcoating | 0.0 | | 0.0 | | 0.0 | | 0.0 | | 0.0 | | n/a |
| Tacky Mouthcoating | 0.0 | | 0.0 | | 0.0 | | 0.0 | | 0.0 | | n/a |
| Aftertaste | | | | | | | | | | | |
| Overall Aftertaste | 2.8 | a | 2.6 | b | 2.7 | ab | 2.6 | ab | 2.6 | b | *** |
| Apple AT | 2.3 | a | 2.0 | c | 2.1 | bc | 2.2 | abc | 2.3 | ab | *** |
| Soy AT | 0.0 | a | 0.3 | a | 0.0 | a | 0.0 | a | 0.0 | a | * |
| Bitter AT | 2.1 | a | 2.1 | a | 2.1 | a | 2.0 | a | 2.0 | a | NS |

1Means in the same row followed by the same letter are not significantly different at 95% Confidence.
***—99% Confidence,
**—95% Confidence,
*—90% Confidence,
NS—Not Significant
The attributes above threshold are bold.
The attributes significant at 90% Confidence are italicized.
For other attributes, % score is the percentage of times the attribute was perceived, and the score is reported as an average value of the detectors.

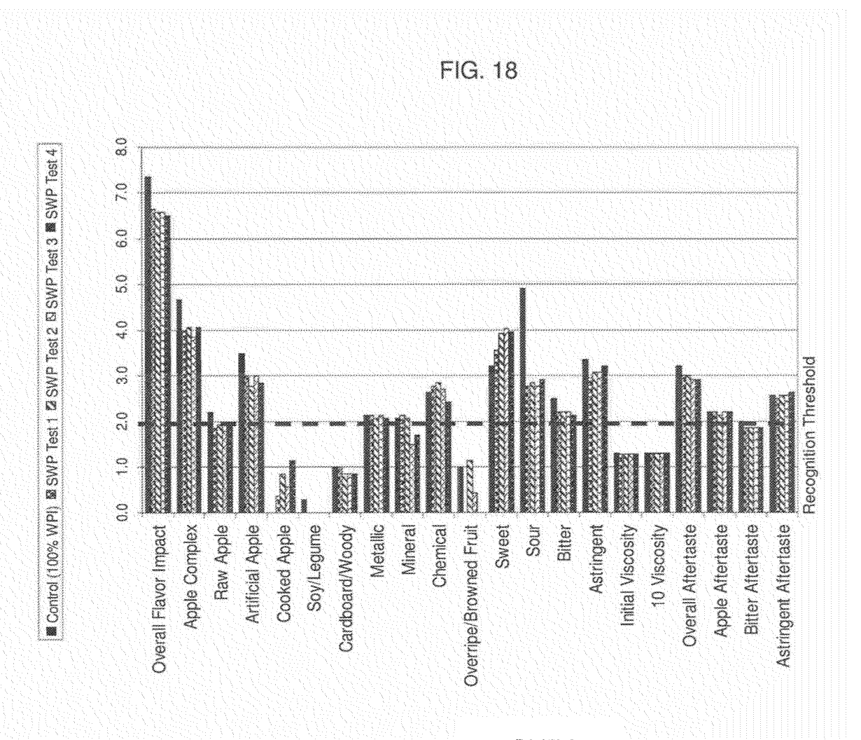

There were detectable differences between the Whey Protein Isolate and Soy Whey Protein apple flavored RTD-A Beverage at 6 Weeks, shown in Table 16. FIG. 18 illustrates that at 6 Weeks, the control (100% WPI) beverage was higher in Overall Flavor Impact, Apple Complex, Raw Apple aromatics, Artificial Apple aromatics, Cardboard/Woody aromatics, Sour basic taste, Bitter basic taste, Astringent, and Overall Aftertaste as well as being lower in Sweetness.

At 6 Weeks, Soy Whey Protein Test 1 was higher in Cardboard/Woody aromatics and lower in Astringent.

At 6 Weeks, Soy Whey Protein Test 2 was higher in Overripe/Browned Fruit.

At 6 Weeks, Soy Whey Protein Test 3 was lower in Apple Complex and Mineral aromatics.

At 6 Weeks, Soy Whey Protein Test 4 was higher in Cooked Apple aromatics and Sweetness and lower in Chemical aromatics.

All the samples did not have any Soy/Legume aromatics or where below the recognition threshold (2.0), which most consumers would be able to detect these attributes in the samples. All the Soy Whey Protein samples were similar to each other.

TABLE 16
Flavor, Texture, and Aftertaste Attributes for the Apple Flavored
RTD-A Beverage at 6 Weeks

| | Control (100% | | Soy Whey | | Soy Whey | | Soy Whey | | Soy Whey | | |
|---|---|---|---|---|---|---|---|---|---|---|---|
| | WPI) | | Protein Test 1 | | Protein Test 2 | | Protein Test 3 | | Protein Test 4 | | p value |
| Aromatics | | | | | | | | | | | |
| Overall Flavor Impact | 7.4 | a | 6.6 | b | 6.6 | b | 6.6 | b | 6.5 | b | *** |
| Apple Complex | 4.7 | a | 4.0 | bc | 4.1 | b | 3.9 | c | 4.1 | b | *** |
| Raw Apple | 2.2 | a | 1.9 | ab | 1.9 | ab | 1.8 | b | 1.9 | ab | ** |
| Artifical Apple | 3.5 | a | 3.0 | b | 2.8 | b | 3.0 | b | 2.9 | b | *** |
| Cooked Apple | 0.0 | c | 0.4 | bc | 0.9 | ab | 0.6 | abc | 1.1 | a | *** |
| Soy/Legume | 0.3 | a | 0.0 | a | 0.0 | a | 0.0 | a | 0.0 | a | * |
| Cardboard/Woody | 1.0 | a | 1.0 | a | 0.9 | b | 0.9 | b | 0.9 | b | *** |
| Metallic | 2.1 | a | 2.1 | a | 2.1 | a | 2.1 | a | 2.1 | a | NS |
| Mineral | 2.1 | a | 2.1 | a | 2.1 | a | 1.5 | b | 1.7 | ab | *** |
| Vitamin | 0.3 | a | 0.3 | a | 0.3 | a | 0.3 | a | 0.3 | a | NS |
| Chemical | 2.6 | ab | 2.8 | a | 2.9 | a | 2.7 | a | 2.4 | b | *** |
| Overripe/Browned | 1.0 | a | 0.0 | b | 1.1 | a | 0.4 | ab | 0.0 | b | *** |
| Fruit | | | | | | | | | | | |
| Basic Tastes & | | | | | | | | | | | |
| Feeling Factors | | | | | | | | | | | |
| Sweet | 3.2 | c | 3.6 | b | 3.9 | a | 4.0 | a | 4.0 | a | *** |
| Sour | 4.9 | a | 2.8 | b | 2.9 | b | 2.8 | b | 2.9 | b | *** |
| Salt | 1.5 | a | 1.4 | a | 1.4 | a | 1.4 | a | 1.5 | a | * |
| Bitter | 2.5 | a | 2.2 | b | 2.2 | b | 2.2 | b | 2.1 | b | *** |
| Astringent | 3.4 | a | 3.0 | c | 3.1 | bc | 3.1 | bc | 3.2 | ab | *** |
| Burn | 0.1 | a | 0.1 | a | 0.0 | a | 0.1 | a | 0.0 | a | NS |
| Texture & Mouthfeel | | | | | | | | | | | |
| Initial Viscosity | 1.30 | a | 1.29 | a | 1.29 | a | 1.29 | a | 1.29 | a | * |
| Particle Amount | 0.0 | | 0.0 | | 0.0 | | 0.0 | | 0.0 | | n/a |
| Particle Size | 0.0 | | 0.0 | | 0.0 | | 0.0 | | 0.0 | | n/a |
| 10 Viscosity | 1.31 | a | 1.30 | a | 1.30 | a | 1.30 | a | 1.30 | a | * |
| Mixes With Saliva | 14.0 | a | 14.0 | a | 14.0 | a | 14.0 | a | 14.0 | a | NS |
| Chalky Mouthcoating | 0.5 | a | 0.4 | a | 0.4 | a | 0.4 | a | 0.4 | a | NS |
| Slick Mouthcoating | 0.0 | | 0.0 | | 0.0 | | 0.0 | | 0.0 | | n/a |
| Tacky Mouthcoating | 0.1 | a | 0.1 | a | 0.1 | a | 0.1 | a | 0.1 | a | NS |
| Aftertaste | | | | | | | | | | | |
| Overall AT | 3.2 | a | 3.0 | b | 3.0 | b | 2.9 | b | 2.9 | b | *** |
| Apple AT | 2.2 | a | 2.2 | a | 2.1 | a | 2.2 | a | 2.2 | a | NS |
| Soy AT | 0.0 | | 0.0 | | 0.0 | | 0.0 | | 0.0 | | n/a |
| Bitter AT | 2.0 | a | 1.9 | a | 1.9 | a | 1.9 | a | 1.9 | a | NS |
| Astringent AT | 2.6 | ab | 2.5 | b | 2.6 | ab | 2.6 | ab | 2.6 | a | ** |

¹Means in the same row followed by the same letter are not significantly different at 95% Confidence.
***—99% Confidence,
**—95% Confidence,
*—90% Confidence,
NS—Not Significant
The attributes above threshold are bold.
The attributes significant at 90% Confidence are italicized.
For other attributes, % score is the percentage of times the attribute was perceived, and the score is reported as an average value of the detectors.

### Example 18

### Preparation of an Orange Flavored Smoothie RTD-A Beverage Containing a Quantity of Soy Whey Protein

An orange flavored smoothie RTD-A beverage product was prepared using soy whey protein recovered from a soy processing stream as described hereinabove, in accordance with the process below. Table 17 is the list of ingredients used to prepare the smoothie beverage product with both 1% soy whey protein and 7% soy whey protein. The amounts are expressed in both concentration (%) and weight (grams).

TABLE 17
Orange Flavored Smoothie RTD-A Beverage Formulation

| | 1% SWP | | 7% SWP | |
|---|---|---|---|---|
| | Percent | Formula | Percent | Formula |
| Ingredient | Usage | Weight (g) | Usage | Weight (g) |
| Water | 66.5408 | 5323.26 | 66.5408 | 5323.26 |
| SWP | 1.3500 | 108.00 | 9.4200 | 753.60 |
| Maltodextrin 10DE | 8.0700 | 645.60 | 0.0000 | 0.00 |
| Resistant Maltodextrin | 1.0000 | 80.00 | 1.0000 | 80.00 |
| Apple Juice Concentrate, | 8.2143 | 657.14 | 8.2143 | 657.14 |
| 70 brix | | | | |
| Carrot Juice Concentrate | 8.3333 | 666.67 | 8.3333 | 666.67 |
| 24 brix | | | | |
| Orange Juice Concentrate | 4.5385 | 363.08 | 4.5385 | 363.08 |
| 65 brix | | | | |
| Sugar | 1.0000 | 80.00 | 1.0000 | 80.00 |
| Pectin | 0.3000 | 24.00 | 0.3000 | 24.00 |
| Propylene Glycol | 0.3000 | 24.00 | 0.3000 | 24.00 |
| Alginate | | | | |
| Citric acid | 0.2700 | 21.60 | 0.2700 | 21.60 |
| Orange Color | 0.0031 | 0.25 | 0.0031 | 0.25 |
| Orange Flavor | 0.0800 | 6.40 | 0.0800 | 6.40 |
| | 100.0000 | 8000.00 | 100.0000 | 8000.00 |

To prepare the smoothie RTD-A beverage, half of the batch water was heated to 71° C. in a conventional food processing kettle such as a stainless steel jacketed kettle equipped with air operated propeller mixer. Next, the pectin and propylene glycol alginate was dispersed in the water with high shear to form a pectin solution. The pectin solution was then heated to 71° C. and mixed for 10 minutes. The juice concentrates were then added to the pectin solution.

To form the protein slurry, the remaining half of the batch water was heated to 60° C. The soy whey protein was added to the water and the slurry was mixed well. To reduce foaming, 3-4 drops of an antifoaming agent was added to the slurry as needed. The slurry was heated to 76.7° C. and held for 15 minutes. The pectin solution was then added to the protein slurry. Also added was the sugar, flavors, citric acid and vitamin/mineral premix. The pH of the combined mixture was checked and adjusted to 4.0 using phosphoric acid.

The mixture was then pasteurized at a temperature of 106° C. at a holding time of 7 seconds. After pasteurization, the mixture was homogenized using a piston-type, 2 stage homogenizer set with 500 psi pressure on the second stage and 2500 psi pressure on the first stage.

The samples were then bottled at room temperature and were allowed to cool in an ice bath until evaluation.

The orange flavored smoothie RTD-A beverage made by the method described above was found to have an increased amount of protein and increased viscosity, while retaining the aroma and appearance of typical flavored RTD-A smoothie products currently on the market.

### Example 19

### Preparation of an Unflavored RTD-N Beverage Containing a Quantity of Soy Whey Protein

An unflavored RTD-N beverage product was prepared using soy whey protein recovered from a soy processing stream as described hereinabove, in accordance with the process below. Table 18 is the list of ingredients used to prepare the unflavored RTD-N beverage product with about 13.6% Soy Whey Protein. The amounts are expressed in both concentration (%) and weight (grams).

TABLE 18
Unflavored RTD-N Beverage Formulation

| | Control (All | | | |
|---|---|---|---|---|
| | Dairy) | | Test | |
| | 50 g. | | 50 g. | |
| | protein/15 oz. | | protein/15 oz. | |
| Ingredient | % | g/kg | % | g/kg |
| Water | 86.314 | 12947.10 | 84.814 | 12722.10 |
| Potassium Phosphate | 0.220 | 33.00 | 0.220 | 33.00 |
| Stabilizer | 0.100 | 15.00 | 0.100 | 15.00 |
| SWP | 0.000 | 0.00 | 13.600 | 2040.00 |
| Whey Protein Hydrolysate | 6.150 | 922.50 | 0.000 | 0.00 |
| Sodium Caseinate | 6.050 | 907.50 | 0.000 | 0.00 |
| Canola Oil | 0.350 | 52.50 | 0.450 | 67.50 |
| Sucralose | 0.016 | 2.40 | 0.016 | 2.40 |
| Sugar | 0.800 | 120.00 | 0.800 | 120.00 |
| Total | 100.00 | 15000.00 | 100.00 | 15000.00 |

To prepare the unflavored RTD-N beverage, half of the batch water was placed into a stainless steel jacketed kettle equipped with air operated propeller mixer. The measured water was heated to 60° C. and an antifoaming agent was added as needed. The stabilizer and the soy whey protein were added to the water and mixed with high shear until completely dispersed. The formed protein slurry was heated to a temperature of between 71° C. and 74° C. and the slurry was mixed for 15 minutes until the protein was hydrated.

The oil was added to the protein slurry and mixed for 2-3 minutes. Next, all remaining ingredients were pre-blended and this blend was added to the protein slurry and mixed together for 5 minutes. The pH was checked and adjusted to between 7.0 and 7.2 by adding phosphoric acid or potassium hydroxide, as necessary.

The mixture was then subjected to a UHT (Ultra High Temperature) process at a temperature of 141° C. for 6 seconds and homogenized using a three piston, 2 stage homogenizer set with 500 psi pressure on the second stage and 2500 psi pressure on the first stage.

The beverage slurry was cooled to 31° C. and bottled using pre-sterilized plastic bottles and cooled immediately in an ice bath. Samples were then stored at refrigerated temperatures.

The unflavored RTD-N beverage made by the method described above was found to have an increased amount of protein and lowered viscosity, while retaining the aroma and appearance of typical unflavored RTD-N products currently on the market.

### Example 19

### Profiling of an Unflavored RTD-N Beverage Containing a Quantity of Soy Whey Protein

Sensory descriptive analysis was conducted on the unflavored RTD-N Beverage prepared in accordance with Example 18 to understand the attribute differences between the control (100% Sodium Caseinate) and Soy Whey Protein. Seven panelists trained in the Sensory Spectrum™ Descriptive Profiling method evaluated the samples for twenty-nine (29) flavor, eight (8) texture attributes, and fourteen (14) aftertaste attributes. The attributes were evaluated on a 15-point scale, with 0=none/not applicable and 15=very strong/high in each sample. Definitions of the flavor attributes are given in Table 19 and definitions of the texture attributes are given above in Table 9.

TABLE 19
Flavor Attribute Lexicon

| Attribute | Definition | References |
|---|---|---|
| | | Intensities based on Universal Scale: |
| | | Baking Soda in Saltine = 2.5 |
| | | Cooked Apple in Applesauce = 5.0 |
| | | Orange in Orange Juice = 7.5 |
| | | Concord Grape in Grape Juice = 10.0 |
| | | Cinnamon in Big Red Gum = 12.0 |

AROMATICS

| | | |
|---|---|---|
| Overall Flavor | The overall intensity of the product | |
| Impact | aromas, an amalgamation of all | |
| | perceived aromatics, basic tastes | |
| | and chemical feeling factors. | |
| Dark Roasted | The aromatic associated with dark | Dark roasted nuts, |
| | roasted nutmeat and having a very | coffee grounds |
| | browned or toasted characteristic. | |
| Sweet Aromatics | The general category of aromatics | |
| | associated with sweet foods | |
| Lactone | The sweet, tropical, nutty aromatic | Cocoa butter, imitation |
| | associated with meat or milk from | coconut flavor |
| | coconut | |
| Vanilla/vanillin | The aromatics associated with | Vanilla Extract, Vanillin |
| | vanilla, including artificial vanilla, | crystals |
| | woody, and browned notes. | |
| Caramelized | The aromatics associated with | Caramelized sugar |
| | browned sugars such as caramel. | |
| Molasses | An aromatic associated with | molasses |
| | molasses; has a sharp, slight | |
| | sulfur and/or caramelized | |
| | character | |
| dark corn syrup | Flavor associated with products | Dark Corn Syrup |
| | sweetened with dark corn syrup | |
| Soy/Legume | The aromatics associated with | Unsweetened SILK ™ |
| | legumes/soybeans; may include all | soymilk, canned |
| | types and different stages of | soybeans, tofu |
| | heating. | |
| Grain | The aromatics associated with the | All-purpose flour paste, |
| | total grain impact, which may | cream of wheat, whole |
| | include all types of grain and | wheat pasta |
| | different stages of heating. May | |
| | include wheat, whole wheat, oat, | |
| | rice, graham, etc. | |
| Green | The general category of aromatics | Green beans, tomato |
| | associated with green vegetation | vines, fresh cut grass |
| | including stems, grass, leaves and | |
| | green herbs | |
| Nutty | The aromatics associated with a | Most tree nuts: pecans, |
| | nutty/woody flavor; also a | almonds, hazelnuts, |
| | characteristic of walnuts and other | walnuts |
| | nuts. Includes hulls/skins of nuts. | |
| Milky | The slightly sour, animal, milky | Skim milk, NFDM |
| | aromatic associated with skim milk | |
| | and milk derived products. | |
| Barnyard | Aromatic characteristic of a | Old casein, white |
| | barnyard; combination of manure, | pepper, processed |
| | urine, moldy hay, feed, livestock | rotten potatoes |
| | odors. | |
| Animal | Aroma similar to smell of live | Unprocessed sheep |
| | animal, including its hair | wool |
| Painty | The solvent aromatic associated | Aroma of Linseed oil |
| | with linseed oils and moderately | |
| | oxidized oil | |
| Dairy Fat | The slightly sweet, buttery (real) | Heavy cream |
| | aromatic associated with dairy fat. | |
| Cardboard/ | The aromatics associated with | Toothpicks, water from |
| Woody | dried wood and the aromatics | cardboard soaked for 1 |
| | associated with slightly oxidized | hour |
| | fats and oils, reminiscent of a | |
| | cardboard box. | |
| Vitamin | The aroma associated with B- | PolyVi Vitamins |
| | vitamins | |
| Chemical | A general term used to describe | Saccharin, Aspartame |
| | the aromatic associated with | |
| | artificial sweetener. (Does not | |
| | include basic taste sweet). | |

BASIC TASTES

| Sweet | The taste on the tongue stimulated | Sucrose solution: | |
|---|---|---|---|
| | by sucrose and other sugars, such | 2% | 2.0 |
| | as fructose, glucose, etc., and by | 5% | 5.0 |
| | other sweet substances, such as | 10% | 10.0 |
| | saccharin, Aspartame, and | 16% | 15.0 |
| | Acesulfame-K. | | |
| Sour | The taste on the tongue stimulated | Citric acid solution: | |
| | by acid, such as citric, malic, | 0.05% | 2.0 |
| | phosphoric, etc. | 0.08% | 5.0 |
| | | 0.15% | 10.0 |
| | | 0.20% | 15.0 |
| Salt | The taste on the tongue | Sodium chloride | |
| | associated with sodium salts. | solution: | |
| | | 0.2% | 2.0 |
| | | 0.35% | 5.0 |
| | | 0.5% | 8.5 |
| | | 0.57% | 10.0 |
| | | 0.7% | 15.0 |
| Bitter | The taste on the tongue | Caffeine solution: | |
| | associated with caffeine and other | 0.05% | 2.0 |
| | bitter substances, such as quinine | 0.08% | 5.0 |
| | and hop bitters. | 0.15% | 10.0 |
| | | 0.20% | 15.0 |

CHEMICAL FEELING FACTOR

| Astringent | The shrinking or puckering of the | Alum solutions: | |
|---|---|---|---|
| | tongue surface caused by | 0.05% | 3.0 |
| | substances such as tannins or | 0.10% | 6.0 |
| | alum. | 0.20% | 9.0 |

| | | |
|---|---|---|
| Burn | A chemical feeling factor | Lemon juice, vinegar |
| | associated with high concentration | |
| | of irritants to the mucous | |
| | membranes of the oral cavity | |

The samples were shaken and then each panelist received 2 ounces of beverage in 3 ounce cups with lids. The samples were presented monadically in triplicate.

The data were analyzed using the Analysis of Variance (ANOVA) to test product and replication effects. When the ANOVA result was significant, multiple comparisons of means were performed using the Tukey's HSD t-test. All differences were significant at a 95% confidence level unless otherwise noted. For flavor attributes, mean values <1.0 indicate that not all panelists perceived the attribute in the sample. A value of 2.0 was considered recognition threshold for all flavor attributes, which was the minimum level that the panelist could detect and still identify the attribute.

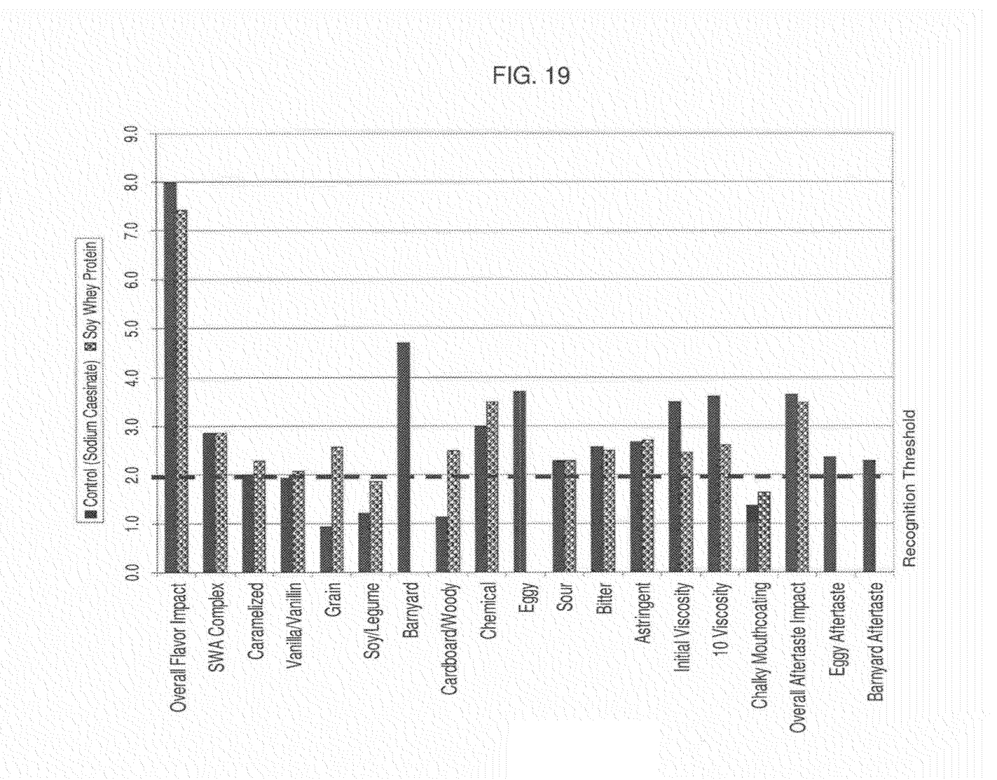

There were detectable differences between the Control (Sodium Caseinate) and Soy Whey Protein shown in Table 20. FIG. 19 illustrates that the Control beverage was higher in Overall Flavor, Barnyard aromatics, Eggy aromatics, Initial Viscosity, 10 Viscosity, Slick Mouthcoating, Overall Aftertaste, Soy/Legume Aftertaste, Sour Aftertaste, Eggy Aftertaste, and Barnyard Aftertaste. The Soy/Legume Aftertaste was below recognition threshold (2.0), which most consumers would not be able to detect this attribute in the beverage.

Again with reference to FIG. 19, the Soy Whey Protein beverage was higher in Grain aromatics, Soy/Legume aromatics, Fruity aromatics, Cardboard/Woody aromatics, Vitamin aromatics, Silage aromatics, Chemical aromatics, Mixes with Salvia, Chalky Mouthcoating, Astringent Aftertaste, Chemical Aftertaste, Cardboard/Woody Aftertaste, and Silage Aftertaste. The Soy/Legume aromatics, Fruity aromatics, Vitamin aromatics, Silage aromatics, Cardboard/Woody Aftertaste, and Silage Aftertaste were below recognition threshold (2.0), which most consumers would not be able to detect these attributes in the beverage.

When comparing the Soy Whey Protein to the Control (Sodium Caseinate), the Control has the typical dairy and off notes such as the Barnyard and Eggy aromatics and aftertaste whereas the Soy Whey Protein has Soy/Legume aromatics, but below the recognition threshold (2.0), which most consumers would be able to detect these attributes in the beverage.

TABLE 20
Flavor, Texture, and Aftertaste Attributes for the
Unflavored 50 gram Protein RTD-N Beverage

| | | | |
|---|---|---|---|
| | Control | | |
| | (Sodium | Soy Whey | p |
| Aromatics | Caseinate) | Protein | value |

| | | | | | |
|---|---|---|---|---|---|
| Overall Flavor Impact | 8.0 | a | 7.4 | b | *** |
| SWA Complex | 2.9 | a | 2.9 | a | NS |
| Caramelized | 2.0 | a | 2.3 | a | NS |
| Vanilla/Vanillin | 1.9 | a | 2.1 | a | NS |
| Lactone | 0.0 | | 0.0 | | n/a |
| Molasses | 0.0 | | 0.0 | | n/a |
| Dark Corn Syrup | 0.0 | | 0.0 | | n/a |
| Other SWA | 0.0 | | 0.0 | | n/a |
| Grain | 0.9 | b | 2.6 | a | *** |
| Green | 0.0 | | 0.0 | | n/a |
| Soy/Legume | 1.2 | b | 1.9 | a | ** |
| Fruity | 0.0 | b | 0.6 | a | *** |
| Nutty | 0.0 | | 0.0 | | n/a |
| Milky | 0.0 | | 0.0 | | n/a |
| Barnyard | 4.7 | a | 0.0 | b | *** |
| Animal | 0.0 | | 0.0 | | n/a |
| Dairy Fat | 0.0 | | 0.0 | | n/a |
| Cardboard/Woody | 1.1 | b | 2.5 | a | *** |
| Painty | 0.0 | | 0.0 | | n/a |
| Vitamin | 0.0 | b | 0.3 | a | ** |
| Chemical | 3.0 | b | 3.5 | a | *** |
| Eggy | 3.7 | a | 0.0 | b | *** |
| Silage | 0.0 | b | 1.8 | a | *** |
| Other Aromatic: Metallic | 0.0 | | 2.4 | (71%) | |
| Other Aromatic: Straw/Hay | 0.0 | | 2.0 | (14%) | |
| Other FF: Metallic | 0.0 | | 2.0 | (14%) | |
| Other FF: Dry Lips | 0.0 | | 2.0 | (14%) | |
| Basic Tastes & Feeling | | | | | |
| Factors | | | | | |
| Sweet | 6.4 | a | 6.4 | a | NS |
| Sour | 2.3 | a | 2.3 | a | NS |
| Salt | 1.1 | a | 1.1 | a | n/a |
| Bitter | 2.6 | a | 2.5 | a | NS |
| Astringent | 2.7 | a | 2.7 | a | NS |
| Burn | 0.7 | a | 0.7 | a | NS |
| Texture & Mouthfeel | | | | | |
| Initial Viscosity | 3.50 | a | 2.46 | b | *** |
| Particle Amount | 0.0 | | 0.0 | | n/a |
| Particle Size | 0.0 | | 0.0 | | n/a |
| 10 Viscosity | 3.61 | a | 2.61 | b | *** |
| Mixes With Saliva | 13.1 | b | 13.7 | a | *** |
| Chalky Mouthcoating | 1.4 | b | 1.6 | a | *** |
| Slick Mouthcoating | 0.3 | a | 0.0 | b | *** |
| Tacky Mouthcoating | 0.0 | | 0.0 | | n/a |
| Aftertaste | | | | | |
| Overall Aftertaste Impact | 3.6 | a | 3.5 | ab | * |
| SWA AT | 0.9 | a | 0.9 | a | NS |
| Soy/Legume AT | 0.4 | a | 0.3 | b | ** |
| Sweet AT | 2.6 | a | 2.5 | ab | * |
| Sour AT | 2.1 | a | 2.0 | b | *** |
| Bitter AT | 2.1 | a | 2.1 | a | NS |
| Astringent AT | 2.4 | b | 2.6 | a | *** |
| Milky AT | 0.0 | | 0.0 | | n/a |
| Vitamin AT | 0.0 | | 0.0 | | n/a |
| Chemical AT | 2.4 | b | 2.8 | a | *** |
| Eggy AT | 2.4 | a | 0.0 | b | *** |
| Barnyard AT | 2.3 | a | 0.0 | b | *** |
| Silage AT | 0.0 | b | 1.6 | a | *** |
| Cardboard/Woody AT | 0.0 | b | 0.9 | a | *** |
| Other AT: Artificial Fruity | 0.0 | | 2.5 | (14%) | |
| Other AT: Metallic | 0.0 | | 2.0 | (29%) | |

1Means in the same row followed by the same letter are not significantly different at 95% Confidence.
***—99% Confidence,
**—95% Confidence,
*—90% Confidence,
NS—Not Significant
The attributes above threshold are bold.
The attributes significant at 90% Confidence are italicized.
For other attributes, % score is the percentage of times the attribute was perceived, and the score is reported as an average value of the detectors.

### Example 20

### Preparation of a RTD-N Beverage Containing a Quantity of Soy Whey Protein

A RTD-N beverage was prepared using soy whey protein recovered from a soy processing stream as described in the present invention, according to typical industry processing techniques using the step-by-step process described below. Table 21 is the list of ingredients used to prepare the RTD-N composition and the amount used is expressed in concentration (%) and weight (g).

TABLE 21
RTD-N Formulation with Soy Whey Protein

| | SWP 30 g | | SWP 4 g | |
|---|---|---|---|---|
| Ingredient | % | g/kg | % | g/kg |
| Water | 82.550 | 6604.00 | 84.650 | 6772.00 |
| Cellulose gel | 0.300 | 24.00 | 0.300 | 24.00 |
| Potassium Citrate | 0.200 | 16.00 | 0.200 | 16.00 |
| Sodium Hexametaphosphate | 0.100 | 8.00 | 0.100 | 8.00 |
| Carrageenan | 0.020 | 1.60 | 0.020 | 1.60 |
| SWP | 11.400 | 912.00 | 1.600 | 128.00 |
| Sunflower Oil | 2.600 | 208.00 | 2.800 | 224.00 |
| Sodium Chloride | 0.280 | 22.40 | 0.280 | 22.40 |
| Sucralose | 0.010 | 0.80 | 0.010 | 0.80 |
| Corn Syrup Solids, 25DE | | | 7.500 | 600.00 |
| Sugar | 1.700 | 136.00 | 1.700 | 136.00 |
| Soy masking flavor | 0.150 | 12.00 | 0.150 | 12.00 |
| Vitamin Premix | 0.050 | 4.00 | 0.050 | 4.00 |
| Vanilla Flavor | 0.340 | 27.20 | 0.340 | 27.20 |
| Caramel Flavor | 0.300 | 24.00 | 0.300 | 24.00 |
| Total | 100.00 | 8000.00 | 100.00 | 8000.00 |

The RTD-N beverage was prepared by first heating the batch water to 37.8° C. Next, the carrageenan, cellulose gel, potassium citrate and sodium hexametaphosphate were mixed together and dispersed into the batch water. The ingredients were then mixed with high shear mixing. The soy protein was then dispersed into the mixture and mixed well to form a protein slurry. An antifoaming agent was added to the mixture if required.

The protein slurry was heated to a temperature of between 71° C. and 73.9° C. for 15 minutes until the protein was fully hydrated. The sunflower oil, sugar, salt, sucralose, vitamin premix, soy masking flavors and other flavors were then added and mixed well with the protein slurry. The pH was checked and adjusted to a pH of 7.0-7.2. The mixture was then pasteurized at a temperature of 131° C. for a holding time of 6 seconds. The mixture was then homogenized using a three piston, 2 stage homogenizer set with 500 psi pressure on the second stage and 2500 psi pressure on the first stage. The liquid was then collected in sterile bottles and cooled immediately in an ice bath.

The RTD-N beverage product that was made by the method described above had an increased amount of protein, while retaining the aroma and appearance of typical RTD-neutral (RTD-N) products currently on the market.

### Example 21

### Preparation of a Dry Blended Beverage (DBB) Base Containing a Quantity of Soy Whey Protein

A DBB was prepared using soy whey protein recovered from a soy processing stream as described in the present invention, according to typical industry processing techniques using the step-by-step process described below. Table 22 is the list of ingredients used to prepare the DBB composition and the amount used is expressed in concentration (%) and weight (g).

TABLE 22
DBB Formulation

| | |
|---|---|
| Control (2 g protein) | Premix |

| | % | gms/batch | % | Grams |
|---|---|---|---|---|
| Sugar | 48.845% | 8.597 | 56.74% | 567.44 |
| Fructose | 30.875% | 5.434 | 35.87% | 358.68 |
| Protein | 13.875% | | | |
| Monopotassium phosphate | 0.500% | 0.088 | 0.58% | 5.81 |
| Malic acid | 3.600% | 0.634 | 4.18% | 41.82 |
| Citric acid | 1.200% | 0.211 | 1.39% | 13.94 |
| Orange Flavor | 0.560% | 0.099 | 0.65% | 6.51 |
| Yellow 6 Color | 0.026% | | 0.00% | 0.00 |
| Yellow 5 Color | 0.019% | | 0.00% | 0.00 |
| Flow agent | 0.500% | 0.088 | 0.58% | 5.81 |
| | 100.000% | 15.150 | 100.00% | 1000.00 |

The DBB was prepared by dry blending the ingredients in a paddle mixer at low speed for 15 minutes. For reconstitution, 15.5 g of the premix was blended with the appropriate amount of protein to deliver 10 g of protein. The mix was added to 240 mls of water in waring blender and mixed at low speed for 1 minute. The pH of the mixture was checked and adjusted (with mixing) to a pH of 3.0 with 75:25 blend of Malic:Citric acid solution.

The DBB product that was made by the method described above was found to have an increased amount of protein, while retaining the aroma and appearance of typical DBB products currently on the market.

One skilled in the art would readily appreciate that the methods, compositions, and products described herein are representative of exemplary embodiments, and not intended as limitations on the scope of the invention. It will be readily apparent to one skilled in the art that varying substitutions and modifications may be made to the present disclosure disclosed herein without departing from the scope and spirit of the invention.

All patents and publications mentioned herein are herein incorporated by reference, including without limitation PCT Application No. PCT/US10/62591 as it relates to any and all teachings related to soy whey protein, to the same extent as if each individual publication was specifically and individually indicated as incorporated by reference.

The present disclosure illustratively described herein suitably may be practiced in the absence of any element or elements, limitation or limitations that are not specifically disclosed herein. Thus, for example, in each instance herein any of the terms “comprising,” “consisting essentially of,” and “consisting of” may be replaced with either of the other two terms. The terms and expressions which have been employed are used as terms of description and not of limitation, and there is no intention that in the use of such terms and expressions of excluding any equivalents of the features shown and described or portions thereof, but it is recognized that various modifications are possible within the scope of the present disclosure claimed. Thus, it should be understood that although the present disclosure has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. A beverage composition, the composition comprising:
(a) soy whey protein having a solubility of at least about 80% in an aqueous medium across a pH range of the aqueous medium of from 2 to 10 and a temperature of 25° C.; and
(b) at least one additional ingredient, wherein the at least one additional ingredient is selected from the group consisting of protein-containing materials, carbohydrates, dietary fiber, antioxidants, antimicrobial agents, stabilizers, emulsifiers, and combinations thereof;
wherein the soy whey protein is present in the composition in an amount ranging from 0.05% to 60% by weight.

2. The beverage composition of claim 1, wherein the composition further comprises an ingredient selected from the group consisting of a thickening agent, pH-adjusting agent, dairy product, preservative, flavoring agent, sweetening agent, coloring agent, other nutrients, and combinations thereof.

3. The beverage composition of claim 1, wherein the composition is used to prepare a beverage food product.

4. The beverage composition of claim 3, wherein the beverage product is selected from the group consisting of ready to drink (RTD) beverages, infant formulas, sports drinks, clinical nutrition drinks yogurt smoothies, dry blended beverages, juice smoothies, coffee creamers, and combinations thereof.

5. A method for making a beverage product, the method comprising the steps of:
(a) mixing a beverage composition comprising a soy whey protein recovered from a processing stream with at least one additional ingredient to produce a protein slurry, wherein the process of recovering the soy whey protein from the processing stream comprises performing the following steps in any order:
(i) pretreating the feed stream by passing the stream through at least one separation technique to form a retentate comprised of soluble components in the aqueous phase of the stream and a permeate comprised of insoluble large molecular weight proteins, wherein the insoluble large molecular weight proteins are selected from the group consisting of pre-treated soy whey, storage proteins, and combinations thereof;
(ii) passing the pre-treated soy whey through to at least one separation technique to form a retentate comprised of various components including but not limited to storage proteins, microorganisms, silicon, and combinations thereof, and a permeate comprised of purified pre-treated soy whey;
(iii) passing the purified pre-treated soy whey permeate of (ii) through at least one separation technique to form a retentate comprised of purified pre-treated soy whey and a permeate comprised of water, some minerals, monovalent cations, and combinations thereof;
(iv) passing the purified pre-treated soy whey retentate of (iii) through at least one separation technique to form a suspension of purified pre-treated soy whey and precipitated minerals;
(v) passing the suspension of purified pre-treated soy whey and precipitated minerals of (iv) through at least one separation technique to form a retentate comprised of de-mineralized pre-treated soy whey and a permeate comprised of insoluble materials with protein mineral complexes;
(vi) passing the de-mineralized purified pre-treated soy whey retentate of (v) through at least one separation technique to form a retentate comprised of soy whey protein, BBI, KTI, storage proteins, other proteins and combinations thereof and a permeate comprised of peptides, soy oligosaccharides, minerals, and combinations thereof;
(vii) passing the proteins of (vi) through at least one separation technique to form a retentate comprised of proteins selected from the group consisting of soy whey protein, BBI, KTI, storage proteins, other proteins, and combinations thereof and a permeate comprised of peptides, water, minerals, and soy oligosaccharides, wherein the soy oligosaccharides are selected from the group consisting of sucrose, raffinose, stachyose, verbascose, monosaccharides, and combinations thereof;
(viii) passing the proteins of (vii) through at least one separation technique to form a retentate comprising peptides, soy oligosaccharides, water, minerals and a permeate comprising water and minerals;
(ix) passing the retentate of (viii) through at least one separation technique to form a retentate comprising de-mineralized soy oligosaccharides and a permeate comprising minerals, water and combinations thereof;
(x) passing the de-mineralized soy oligosaccharides (ix) through at least one separation technique to form a retentate comprising color compounds and a permeate comprising soy oligosaccharides;
(xi) passing the soy oligosaccharides of (x) through at least one separation technique to form a retentate comprising sucrose, monosaccharides, and combinations thereof and a permeate comprising raffinose, stachyose, verbascose and combinations thereof;
(xii) passing the permeate of (xi) through at least one separation technique to form a retentate comprising water and a permeate comprising soy oligosaccharides;
(xiii) passing the retentate of (vii) through at least one separation technique to form a retentate comprising soy oligosaccharides, water, and minerals and a permeate comprising peptides and other proteins;
(xiv) passing the permeate of (xiii) through at least one separation technique to form a retentate comprising water and a permeate comprising peptides and other proteins, wherein the proteins are selected from the group consisting of lunasin, lectins, dehydrins, lipoxygenase, and combinations thereof;
(xv) passing the retentate of (xiv) through at least one separation technique to form a retentate comprising storage proteins and a permeate comprising soy whey protein, BBI, KTI, and other proteins, wherein the other proteins are selected from the group consisting of lunasin, lectins, dehydrins, lipoxygenase and combinations thereof;
(xvi) passing the retentate of (xv) through at least one separation technique to form a retentate comprising water and a permeate comprising soy whey protein, BBI, KTI and other proteins; and
(xvii) heating, flash cooling and drying the permeate of (xvi) to form soy whey protein; and
(b) heating the protein slurry to form a beverage product.

6. The method of claim 5, wherein the method further comprises pasteurizing the protein slurry to form a pasteurized beverage composition.

7. The method of claim 6, wherein the method further comprises homogenizing the pasteurized beverage composition to form a homogenized composition.

8. The method of claim 7, wherein the method further comprises cooling the homogenized composition to form a beverage product.

9. The method of claim 5, wherein the beverage product is selected from the group consisting of ready to drink (RTD) beverages, infant formulas, sports drinks, clinical nutrition drinks yogurt smoothies, dry blended beverages, juice smoothies, coffee creamers, and combinations thereof.

10. The method of claim 5, wherein the amount of soy whey protein in the composition is 0.05% to 60%.

11. The method of claim 5, wherein the at least one additional ingredient is selected from the group consisting of protein-containing materials, carbohydrates, dietary fiber, antioxidants, antimicrobial agents, stabilizers, emulsifiers, and combinations thereof.

12. The method of claim 6, wherein the composition further comprises an ingredient selected from the group consisting of a thickening agent, pH-adjusting agent, dairy product, preservative, flavoring agent, sweetening agent, coloring agent, other nutrients, and combinations thereof.
